(19) United States
(12) Patent Application Publication
(10) Pub. No.: US 2005/0242036 A1
(43) Pub. Date: Nov. 3, 2005

(54) Chemical and sludge free water treatment process

(76) Inventor: James Jeffrey Harris, Cameron Park, CA (US)

Correspondence Address: James Jeffrey Harris, 2592 Westridge Drive, Cameron Park, CA, 95682, US

(21) Appl. No.: 10/835,979

(22) Filed: Apr. 29, 2004

(51) Int. Cl. B01D 61/00

(52) U.S. Cl. 210/650; 210/767; 169/5

(57) ABSTRACT

Abstract: A process imparting the treatment of industrial water, especially thermal power plant water, providing multiple streams of water products at qualities superior to that achieved by chemical clarifier based processes without the burdens of chemical consumption and sludge generation. The process employs staged filtration means 10, 12 singly pressured from source 2 via a side-stream 8 of a cooling tower make-up water source to generate a medium grade filtrate 18 for employ as a plant service and fire protection water source, a medium grade reject 20 for use as a primary water source for make-up to a cooling tower and a high quality permeate stream 22 for employ as a water source 28 for a demineralization system and a water source 24 for a potable water system.

### BACKGROUND

1. Field of Invention

This invention relates to a water treatment process employing a multistage filtration device to replace or bypass clarifiers at thermal power plants.

2. Description of Prior Art

Industry has employed clarifiers for water treatment for many decades. These devices serve their plants by the treatment of raw or otherwise unsatisfactory water to generate clean, usable water for process or other purposes. Clarifiers employ a wide variety of chemicals to facilitate this purpose. Dosing with biocides, usually based on chlorine, provides the matter of best practice for control of biological activities. Coagulating chemicals, generally in the form of metal salts, facilitate agglomeration and settling of finely suspended solids in the water. Control of pH and procedures to optimize the agglomeration effects of the metal salts entail dispensation of caustic or acidic chemicals. The addition of cationic and/or anionic polymer flocculants is common to accelerate the agglomerating and settling rates of the solids. The coagulated and flocculated solids settle into the clarifier basin as sludge. This sludge periodically discharges from the clarifier basin into temporary storage ponds at the site. Trucks vacuum these ponds, as they fill, and transport this sludge to permanent commercial disposal sites. The treated clarifier effluent decants, by gravity, from the clarifier and usually passes through gravity media filters to remove residual solids carried over from the clarifier. The plant employs this filtrate for various processes.

The chemicals employed for successful operation of clarifiers are typically very reactive and hazardous. The metal salt coagulants are usually corrosive and many have dangerous and toxic properties. Careful handling of these hazardous chemicals is critical with special attention given to the adequate use of personal protective equipment, such as aprons, gloves and face shields. The hazards of many of these chemicals escalate if inadvertently mixed in an improper format. This is especially true with chlorinating chemicals. Inappropriate mixing of these chemicals with other common water treatment solutions will generate deadly chlorine gas. The liabilities associated with the handling and storage of such chemicals occasions appropriately designed secondary containment for environmental protection in all areas where any potential for spillage and leakage exists. All personnel working with, or in the immediate vicinity of, these chemicals and chemical storage areas must have access to personal protective equipment. Further, adequate training is crucial to assure safe handing and competency during emergency proceedings.

Biocides are essential for biological control in applications of the prior art. This requirement is especially important since the clarifiers of the prior art are generally open to the environment and sunshine; thereby providing a rich environment for algae and other microbial blooms. Accordingly, the prior art generally requires exceptional doses of biocides. The most commonly employed biocide is chlorine. The reader should note that references hereinafter to chlorine, rather than any other biocide, is strictly for purposes of discussion, not of specification. Chlorination chemicals, such as sodium hypochlorite, are expensive, highly oxidizing and damaging to pumps, metering equipment, valves and piping. Such chemicals are also difficult to handle and transport due to their propensity for bubble formation and vapor locking of the associated pumps, meters and valves. Consequently, the equipment necessary to handle, measure and transport these chemicals is specialized and expensive.

The biological control regimen of the prior art effects a residual chlorine concentration in the feed-water to the demineralization system. Demineralization is a crucial process in most thermal power plants as well as in other industries. Demineralization equipment is especially susceptible to damage by these chemicals. Accordingly, dispensation of de-chlorinating chemicals, such as sodium bisulfite into the demineralization system feed-water prior to contact with the demineralization equipment is critical. These chemicals are hazardous, corrosive and expensive. The delivery of these chemicals into the demineralization plant feed-water is critical to prevent severe damage to the demineralization equipment.

From an equipment perspective, most of the chemicals used in the prior art are difficult to manage. Sodium hydroxide, a commonly used chemical to elevate pH, becomes an extremely viscous fluid as the temperature drops, rendering it nearly impossible to properly pump and dispense. Heat tracing and tank heating or total system thermal enclosure are imperatives for operations in any clime other than tropical. Polymer flocculants are also viscous and increasingly difficult to dispense as the temperature drops. Similarly, heat tracing and tank heating or total system thermal enclosure are imperatives for operations in any clime other than tropical. Such heating, tracing or enclosure requirements present system placement concerns as well as escalated expenses and maintenance. Acids used for the reduction of pH and most metal salt coagulant solutions are very corrosive and require expensive corrosion resistant pumps, valves, meters and piping.

The clarifier based prior art of water treatment employs a delicate balance of chemistry, flow and chemical feed rates. Small variations in feed-water constituents and operating conditions can result in an operational upset and complete failure of acceptable quality water production. Changes in feed-water pH, total dissolved solids, total suspended solids, organic constituents or dissolved gas occurrences can produce such upsets. Feed-water as well as ambient temperature changes, both on a seasonal and daily basis, as well as solar heating effects can also engender upsets. It is an accepted fact of the prior art that upsets do occur when the causative factors are not even apparent. At some installations, upsets occur in a frequent and nearly random fashion. Since the function of the prior art is to provide acceptable quality process water to the plant, upsets have substantial negative effects. It is common for the operational abeyance of the entire plant, until stable water production operations resume. Such unreliability traits of the prior art places a substantial burden upon plant operations and associated economics.

Clarifier operations of the prior art are open to atmospheric pressure with gravitational settling of the solids and sludge. Plant process water is usually pressured. A side-stream of pressured cooling tower make-up water generally provides the raw process water for the plant. In the prior art, this raw process water feeds through a rate or level control valve into an open clarifier. Treated effluent gravitationally decants from the clarifier through a gravity media filter system and into an open sump. Pumps extract and pressure the filtrate from this sump and direct it toward plant process use. These pumps and associated controls are expensive and impart an expensive energy load to the plant.

The water treatment effects of the clarifiers of the prior art arise as a consequence of chemical attraction between the suspended solids in the water and the chemicals added thereto. Under the proper conditions, the added chemicals attract and agglomerate the suspended solids into larger bodies, which settle in the form of a sludge, into the clarifier basin. Sufficient chemical attraction between the clarifier chemicals and the suspended solids in the water are necessary to facilitate successful agglomeration. Clarifiers were initially developed and employed for the relatively simple application of clarification of municipal water. The primary suspended solids in these applications respond well to the chemical attraction generated by the coagulating and flocculating chemical of the prior art. The use of such clarifiers within the confines of the industrial processes of the prior art, evolved out of experience gained from municipal water applications. The increasing demands of industry for process water of higher and higher quality however, has pushed the prior art processes employing clarifiers into operating regimes beyond their capabilities. Accordingly, the quality of water generated by the prior art, though excellent by municipal standards, is often inferior for industrial process use. Consequently, those industrial plant operations employing water generated by the clarifier processes of the prior art often suffer frequent cleanings and equipment replacement. These adverse affects are particularly severe where the clarifier provides treated water for reverse osmosis or demineralization system processes. The capability of the prior art to adequately prepare water for these applications is often marginal. Accordingly, the expense, labor and downtime associated with fouled equipment cleaning and/or replacement purveys a large economic burden.

A representative and focused application of the invention relates to thermal power plants. Most of these plants exploit surface water for process operations. In a common configurations associated with the prior art, a plant will receive raw feed-water at two main inlet points. Each of theses points receive a feed stream of raw water from a common pressured header or line. The largest stream provides untreated cooling tower make-up water. The typically high make-up flow rates into cooling towers, generally negates the possibility of economic treatment of this stream. The smaller stream, after treatment, is directed toward providing plant fire protection water, plant service water, feed-water to the plant's potable water treatment system and feed-water to the plant's demineralization system

Typical of the prior art; the plant's smaller inlet stream is directed through a clarifier for preliminary treatment. Effluent from the clarifier flows gravitationally through a mixed media, gravity filter and into a filtered water sump. Treated water from this sump is pumped to a storage tank from which it is employed as a feed-water source for the plant demineralization system, plant fire protection water system, plant service water system and often for the plant potable water treatment system. Clarifier sludge periodically discharges to a pond for temporary storage. Transport and commercial storage of the sludge follow periodic draining and cleaning of the pond. In the prior art, the clarifier provides the primary means for suspended solids removal for the plant fire protection water, the plant service water and the feed-water to the plant potable water and the plant demineralization systems. From the industrial viewpoint, the clarifier clearly fulfills a primary and accepted role in the prior art. Accordingly, within the confines of the prior art, the many expenses, hazards, risks, reliability issues and labor associated with clarifier operation have been accepted as normal and expected operating practices and burdens.

The present invention provides a simple and cost effective means to bypass or eliminate the clarifier based treatment processes of the prior art and its associated expenses, hazards, risks, reliability issues and labor with a unique and novel process configuration employing a multi-staged filtration system operating solely from the make-up water pressure exerted into the invention. The process invention extracts pressured raw water from the make-up water feed line and passes it through a closed, staged filtration system comprised of a mechanical filtration section, followed by a membrane filtration section. A side-stream of the mechanical filtrate is directed for plant service water and fire protection water use. The preponderance of the mechanical filtrate however, being so directed toward the membrane filtration section. The membrane filter operates in a single pass, high velocity cross-flow configuration with a high reject to permeate ratio to facilitate optimal cross-flow cleansing. The membrane filtrate provides a sterile, much higher quality feed-water to the plant potable water systems and the plant demineralization systems than is available from the prior art. The high volume of membrane cross-flow reject water is directed to the cooling tower and serves as a mechanically filtered make-up water of a substantially superior quality than the raw make-up water common to the prior art.

The invention provides a process with many advantages not demonstrated by the prior art, as well as eliminating the many disadvantages presented by the prior art. The invention also provides the further benefits of generating a higher quality water product than is available from the prior art as well as producing a discharge stream of filtered water for use as a high quality make-up water source to the cooling tower.

Filtration and membrane technologies are discussed in literature and employed by industry for treating cooling tower waters. In most of these cases, mechanical filtration and, to a lesser extent, membrane filtration, bestows treatment on the circulating water of the cooling towers. The reader is referenced to U.S. Pat. Nos. 4,981,594, 5,013,415, 5,145,585, 5,552,058 wherein mechanical filtration, membrane filtration and other means of harvesting suspended solids from the circulating water of cooling towers to facilitate reduced solids build up and associated plugging problems have been addressed. Reverse osmosis processes, distillation processes and similar techniques been also been employed for the harvesting of dissolved solids so as to reduce fouling and scaling as well as to reduce the volume of blow-down necessary for efficient operation of the cooling tower. The reader is referenced to U.S. Pat. Nos. 2,893,926, 3,476,653, 6,616,851 B1, 3,412,558. The prior art also demonstrates an example, reference U.S. Pat. No. 4,347,704 wherein a reverse osmosis process was employed on the make-up water to generate a low suspended and dissolved solids permeate as the cooling tower make-up with the objective of reducing the blow-down and related make-up requirements of the cooling tower.

There is no prior teaching of the invented process, wherein is provided a means for deposing the troublesome clarifier, associated equipment and related processes while engendering the production of higher quality feed-water for the plant potable water system, the plant demineralization system and the cooling tower make-up system. The invention being further refined in the provision of these services while incorporating an overall reduction in pumps, equipment, chemicals, waste and energy requirements.

### OBJECTS AND ADVANTAGES

The reader who is knowledgeable in the art, will clearly recognize from FIG. 1, the substantial benefit of simplicity afforded by the invention while further providing reduced capital and operating expenses, reduced environmental liabilities and generating better quality water products for use by a thermal power plant than those typical of the prior art.

The invention conveys a means to present plant process water products of very high quality with the additional benefit of eliminating the many disadvantages of the clarifier based processes of the prior art. The physical dimensions and configuration of the process invention provides for easy bypass and replacement of existing applications of the prior art as well as simple installation at new plants. The invention is supplied pressured feed-water directly from the make-up water line going to the cooling tower. The invention provides three product streams. The first is a mechanically filtered water stream provided primarily for plant service and fire protection water. The second stream is a membrane filtered water product of very high quality provided primarily as a feed-water for the plant demineralization system and as a potential feed-water to the plant potable water system. The third product stream is a mechanically filtered membrane reject stream provided for use as a high quality make-up water to the plant cooling tower.

The advantages of the invention over the prior art are profuse and include, but are not limited, to the following; a reduction of operating costs, a much smaller footprint, a substantial reduction of operating labor, an elimination of environmental liabilities, an elimination of hazardous chemicals and their associated specialized equipment and handling issues, an elimination of the risk of chlorine or other reactive biocide carryover into the demineralization system, an elimination of the need and risks for improved reliability, a much improved capability to handle feed-water upsets or “off spec” conditions, the elimination of many pumps, valves and associated controls, a saving of electrical power as well as providing a higher quality make-up water for the cooling tower, hence reducing chemical usage in the cooling tower and reducing fouling and plugging problems in heat exchangers contacted by circulating water from the cooling tower.

In the process of the invention, the application of mechanical and single pass cross-flow membrane filters, in series, generate the high quality water product streams. Unlike the prior art, in which the water chemistry is crucial, the invention does not require the diligent water chemistry monitoring and chemical dosing so crucial for successful operation of the prior art. Accordingly, in contrast to the prior art, the employment of qualified personnel skilled in the science of water chemistry, and their corresponding expense is not required. Further, the invention does not require pH control, thereby eliminating the expenses associated with the use of acids, such as sulfuric and caustics, such as sodium hydroxide. In contrast to the prior art, the invention does not require the processes of coagulation or flocculation. The invention thereby affords the treatment of water without the expense burdens associated with the consumption of metal salt coagulants or polymer flocculants.

The invention employs a straight through, real time process. In contrast, the clarifier processes of the prior art require substantial reaction/residence time as well as large cross sectional areas to induce quiescence and facilitate settling. Accordingly, the prior art requires large volumes of containment. Such containment levies a large footprint. This is expensive and can seriously impede plant site configuration, operation and faculty for growth. The area constraints of plant sites are often so severe that undersized examples of the prior art can only be employed, thereby hindering performance. In contrast, the invention employs a very small footprint, typically about 10% of the size of the prior art. This advantage dramatically ameliorates plant spatial concerns as well as providing the option for high quality treatment at locales in which space would not otherwise permit installation. Further, the compact size advantage of the invention affords ready process rate increases without the difficulties imposed by the size constraints limitations of the prior art.

The invented process employs mechanical and membrane filtration processes. The prior art employs water chemistry to imbue treatment via the agglomeration and settling of solids. As with all chemical processes, the type and dosage of chemicals are specific to the chemistry of the water. Changes in the feed-water chemistry can dramatically affect the performance of the chemically driven processes of the prior art. Accordingly, constant monitoring and the appropriate adjustment by qualified operating personnel are necessary to maintain operation of the prior art. Additionally, the clarifier processes of the prior art are well known to react poorly to rapid changes in ambient conditions. A change of weather conditions, both daily and seasonally often detrimentally affects their performance. Personnel must be available to monitor and adjust for such unbalances. Even with the utmost of care, the prior art is prone to upsets triggered by the slightest, and often times unknown, varying of conditions. Over the course of an upset, water processing operations cease and often the clarifier must be drained, cleaned and started afresh. Such activities provoke substantial labor expense as well as encumbering the plant with costly downtime. In contrast to the prior art, the invention does not operate under the vulnerabilities associated with maintenance of fine chemical balances. This advantage affords the invention the ability to perform unperturbed, even during massive changes in feed-water chemistry. Thus, in contrast to the prior art, the invention requires only minimal oversight and labor, thereby affording a substantial reduction in operating costs while reliably conveying a much higher quality water product.

A major disadvantage of the prior art is the mandatory use of hazardous chemicals to prepare and treat the raw water for agglomeration and settling of the finely suspended solids as sludge into the basin of the clarifier. The environmental liabilities associated with these chemicals, their transport, storage and use as well as the storage and disposal of the generated sludge generate substantial environmental liabilities for the plant. Trucks, tanks and bins convey the chemicals to the site. These conveyances must be unloaded with the utmost of care to prevent spillage, splashing or similar incidents. The offloading sites are concrete or asphalt lined and specifically designed to capture chemical spillage. These sites are equipped with personnel protection equipment as well as eye-wash stations and body showers. Training is essential for those plant personnel responsible for unloading and handling these hazardous materials. At the site, these chemicals must be stored in secondary containment cells to afford protection against environmental contamination resulting from spillage or leakage. Further, these cells must be individually isolated to assuage the mixing of incompatible chemicals. All of these delivery and storage operatives, site work and equipment represent a substantial expense of capital and labor to the plant. Further, even with reasonable containment, employee training and the appropriate equipment, the potent chemicals stored at the site present a substantial personnel and environmental liability. The invention provides the definite advantage over the prior art of eliminating these chemicals and their associated expenses and liabilities.

The prior art requires the employment of a biocide for biological control. The environmentally open clarifiers of the prior art are efficient incubators for biological growth. Accordingly, dosing of chlorinating chemicals into the clarifiers is essential to provide the necessary biological control. The dosing of excess chlorine into the clarifier is common to assure a residual chlorine concentration sufficient to maintain biological control. Residual chlorine carryover from the clarifier affords sterile maintenance of the plant service water, firewater and potable water systems. Unfortunately, severe damage to the plant demineralization system will result from even very small residual levels of chlorine present in its feed-water. Accordingly, a critical practice of the prior art is the de-chlorination of this feed-water prior to delivery to the demineralization system. Dosing of de-chlorinating chemicals, such as sodium bisulfite, into the feed-water to the demineralization system protects against damage from residual chlorine. Successful dosing of these de-chlorinating chemicals is crucial for the maintenance of successful demineralization operations. Mechanical failure or operator error affecting inadequate de-chlorinating chemical dosing will present major damage to the demineralization system as well as potentially forcing an outage of the entire plant. The required repairs and plant downtime associated with a demineralization system failure are very expensive. The de-chlorinating chemicals are corrosive, hazardous and expensive, thereby purveying additional disadvantages to the prior art.

The invention employs chlorination only of the mechanically filtered water product directed for plant service and fire protection. The feed-water to the demineralization system and, where appropriate, the potable water system, is permeate from membrane filtration. This water is sterile, thereby affording the advantage of not requiring chlorination. This advantage of the invention eliminates the expense and liabilities associated with the de-chlorination of the demineralization system feed-water, a procedure which is critical in the prior art.

A further liability inherent to the prior art is the storage and disposal of the generated sludge. This sludge is a mixture of the collected solids as well as the chemicals employed by the clarifier. Generally, a pond temporarily stores the clarifier sludge until transported offsite for disposal. Care to prevent spillage or leakage of the hazardous sludge from the pond is critical. Further, in environments with migratory birds and other fauna, efforts to prevent contact between the contents of the sludge pond and wildlife are compulsory. Emptying of the sludge ponds and transport of the sludge to an appropriate disposal site occurs as needed.

Clarifier sludge is an expensive liability of the prior art. Spillage or leakage of sludge at the site will require regulatory notification and competent remediation. Wildlife injuries and fatalities resulting from contact with the sludge can result in stiff regulatory fines. The disposal fees for clarifier sludge often are very high, thereby generating a large economic burden upon the host site. Further, in consideration of the cradle to grave liabilities associated with hazardous waste, the disposal of the sludge represents a long-term liability to the host. The invention provides an important advantage over the prior art because it does not generate sludge or any other chemical laced waste products.

The prior art employs substantial quantities of hazardous, somewhat exotic chemicals. These chemicals are corrosive and difficult to handle. The prior art requires chemical control of pH to facilitate proper operation. Acidic chemical solutions, such as sulfuric acid, decrease the pH and caustic chemical solutions, such as sodium hydroxide, increase the pH. The metal salt coagulants are generally very acidic. All of these chemicals are hazardous and extremely corrosive. The equipment required for pumping, metering, controlling, storing and transporting these chemicals must be capable of withstanding strong chemical attack. Accordingly, this equipment must be specialized and fabricated of exotic and expensive materials. The invention does not require these harsh chemicals thereby affording the advantage over the prior art of not requiring specialized equipment manufactured of expensive and exotic materials.

The sodium hydroxide and the polymer (cationic and/or anionic) flocculants implemented by the prior art are very sensitive to low temperatures and become increasingly difficult to pump as the ambient temperatures decline. Heating these chemicals as well as heat tracing the conveyance tubes or providing a heated enclosure for the chemicals and conveyance tubes is necessary for successful year around operation of the prior art. The invention provides an advantage by not requiring the use of such chemicals, thereby eliminating the expense and maintenance issues necessary to maintain the temperatures required by the prior art.

The function of the clarifier of the prior art and a primary function of the invention is to provide quality water to service the plant. This product water provides for fire suppression, feed-water for potable treatment, plant service water and high quality feed-water for further demineralization treatment. In thermal power plants, the ultrapure water product from the demineralization system provides boiler feed-water, emissions control water, combustion air evaporative cooling water and other specialized needs. This water is crucial for plant operation. If the demineralization system cannot operate then plant operations generally cease. The clarifiers of the prior art employ chemicals to facilitate the removal of suspended solids via chemical means. A delicate balance of chemical feed dosages defined by the constituents of the feed-water is essential for the successful clarifier operations of the prior art. Changes in the feed-water constituents, entrained gas in the feed-water or changes in temperature all can trigger upsets in the clarifiers of the prior art. Such upsets render the water quality to the plant as unusable until stable and satisfactory operations of the clarifier can be reestablished. This can require several days during which there is no process water available for the plant and accordingly, plant operations cease. Cessation and restart of plant operations is very expensive, labor intensive, detrimental to equipment performance and reliability as well as representing the ultimate loss of revenue to the plant. The sensitivity of the prior art to upsets resulting from uncontrollable outside influences and the serious effects such upsets produce in the plant operations, render the unreliability of the prior art as a serious disadvantage. Such uncontrollable outside influences does not affect the performance of the invention and accordingly, the invention affords the advantage of reliable performance, eliminating the financial, labor and equipment burdens associated with the cessation of plant operations.

The typical configuration of the prior art employs feed-water from a pressured water line, wherein this line also usually provides the make-up water to the cooling tower. Within the confines of the prior art, the clarifier receives this feed-water in an open configuration. The clarified effluent then generally feeds by gravity through a mixed bed filter system and into a filtered water sump. The water in this sump is usually employed for both back-flushing the mixed bed gravity filter and also to provide plant service water, fire protection water and feed-water for the plant demineralization system and often also the plant potable water system. This filtered water sump is generally serviced by two systems of pumps, one system for back-flushing the gravity filters and the other for lifting and transporting the filtered water into a storage tank. A back-flush waste holding sump receives back-flush wastewater from the gravity filters. A back-flush wastewater pump system delivers the waste from this sump into the plant wastewater system. The plant wastewater system delivers this waste for elimination via discharge. The storage tank holds water for fire suppression purposes through a firewater pressurization and feed system. A plant service water pump system delivers pressured service water from this tank to the plant. The tank supplies pressured feed-water to the demineralization system through a demineralization feed-water pump system and a polishing cartridge filtration system. This tank often also supplies feed-water to the plant potable water system.

The complexity of the prior art requires many pumps, valves, controls and piping. Further, the plant site requires the construction of substantially large sumps, wherein both the filtered water sump and the back-flush waste sump must each be large enough to contain the back-flush volume. This volume is generally upwards of ten thousand gallons. The expense and maintenance issues with so many pumps, controls and valves are a serious disadvantage to the prior art. Further, the site construction work necessary to support the large clarifier body, the gravity filter body and the filtered water and back-flush wastewater sumps is very expensive. In contrast to these substantial disadvantages of the prior art, the invention operates entirely as a closed system, pressured only by the water line feeding make-up water to the cooling tower. Back-flush water from the invention goes directly, without pumping, to the plant wastewater system, filtered membrane reject goes directly, without pumping, to the cooling tower for make-up water use. Pressured, mechanically filtered water goes directly, without pumping, to the storage tank and membrane filtered, chlorine free, high quality water goes directly, without pumping, to the demineralization system and where applicable, the potable water treatment system. The invention provides demineralization system feed-water of such high quality that the cartridge filters never need replacing and in fact can be bypassed if the plant operators so desire. The advantages provided by the invention are; an elimination of the filtered water pumps, valves and associated controls, an elimination of the gravity filter back-flush pumps, valves and associated controls, an elimination of the back-flush wastewater pumps, valves and associated controls, an elimination of the demineralization system feed pumps, valves and associated controls, an elimination of the filtered water sump, level indicators, transmitters and associated controls, an elimination of the back-flush wastewater sump, level indicators, transmitters and associated controls. The invention further provides the advantage of eliminating expenses associated with cartridge filter replacement as well as eliminating the high energy expense associated with operation of the filtered water pumps, the gravity filter back-flush pumps, the back-flush wastewater pumps and the demineralization system feed pumps. The invention has the further advantages of not requiring the high construction capital associated with installation of the clarifier support basin or pad, the gravity filter pad and the filtered water sump and back-flush wastewater sump.

The prior art employs a small fraction of the total water usage at the host site. For instance, at a thermal power plant the majority of the water consumption is by the cooling tower. A typical facility will utilize about 85% of the total water consumed in the cooling tower, about 12% through the clarifier system and the small remaining amount for various other uses. The flow rate to the cooling tower is so high that the economic benefits of adequately sized filtration or other type of make-up water treatment are usually not justified. This often results in the buildup of solids in the cooling tower and circulating water contacted heat exchangers. This buildup must be periodically removed which requires ceasing of operations and cleanout. This is a labor intensive operation and imposes expensive downtime on the plant. The high labor expense and the ultimate revenue losses resulting from cessation of plant operations during cleaning is a substantial burden on plant economics. The invention provides an opportune benefit to the cooling tower operations. The invention employs a much higher fraction of water than the prior art; typically 30-40%. The invention exploits this larger volume to facilitate high velocity, single-pass cross-flow cleansing of the membranes. Within other applications of membrane filtration processes, single-pass operations are wasteful because there is typically no use for the associated high volume of membrane reject wastewater. The mechanical filtration prior to the membrane filtration and the single pass configuration, affords a membrane reject water of high quality. This water is ideal for use as make-up water to the cooling tower. It is of a much superior quality than the raw make-up water typical of the prior art. Accordingly, a major advantage of the invention is the application of this water, as a primary source, for make-up water to the plant cooling tower system. The untreated make-up water is used only as a secondary make-up water source as so needed to fulfill volumetric shortfall to the cooling tower system. The reject water from the invention is substantially better in quality than the untreated make-up water of the prior art, thereby the invention purveys an overall improvement of cooling tower water quality. This purveys reduced fouling and plugging tendencies to any circulating water contacted appliances, such as heat exchangers, as well as reducing the amount and cost of treatment chemicals for the cooling tower and circulating water. Accordingly, the invention provides the advantage of supplying cooling tower make-up water of a substantially improved quality, thereby affording reduced cleaning expenses, chemical expenses as well as loss of revenue associated with plant closure during cleaning activities.

### DRAWING FIGURES

FIG. 1 is a process diagram illustrative of the invention as installed at a typical thermal power plant. FIG. 1 also presents a dashed superposed process diagram of a typical installation of the prior art to provide the knowledgeable reader with an illustration of the simplicity and advantages of the invention as contrasted against the complexities and disadvantages of the prior art.

FIG. 2 is a process diagram illustrative of the preferred embodiment of the invention applied at a typical thermal power plant. In this figure, the preferred embodiment of the process invention receives a pressured raw water stream and provides; a chlorinated mechanical filtrate for plant service water, a chlorinated mechanical filtrate for plant fire protection water, an un-chlorinated, mechanically filtered membrane reject water for primary cooling tower make-up water, an un-chlorinated raw water for secondary cooling tower make-up water, an un-chlorinated membrane permeate for demineralization feed-water, and an un-chlorinated membrane permeate for potable water system feed-water.

FIG. 3 is a process diagram illustrative of an embodiment of the invention applied at a typical thermal power plant. In this figure, the embodiment of the process invention receives a pressured, good quality, but un-chlorinated, raw water stream and provides; a chlorinated raw water for plant service water, a chlorinated raw water for plant fire protection system water, an un-chlorinated but good quality membrane reject water for primary cooling tower make-up water, an un-chlorinated but good quality raw water for secondary cooling tower make-up water, an un-chlorinated membrane permeate for potable water system feed-water, and an un-chlorinated membrane permeate for demineralization feed-water.

FIG. 4 is a process diagram illustrative of an embodiment of the invention applied at a typical thermal power plant. In this figure, the embodiment of the process invention receives a pressured, chlorinated and good quality raw water stream and provides; a chlorinated and good quality raw water for plant service water and for plant fire protection system water, a chlorinated membrane reject water for primary cooling tower make-up water; chlorinated and good quality raw water for secondary cooling tower make-up water, a chlorinated membrane permeate for potable water system feed-water, and a de-chlorinated membrane permeate for demineralization system feed-water.

FIG. 5 is a process diagram illustrative of an embodiment of the invention applied at a typical thermal power plant. In this figure, the embodiment of the process invention receives a pressured good quality but un-chlorinated raw water stream and provides; a chlorinated and good quality raw water for plant service water and for plant fire protection system water, an un-chlorinated but good quality membrane reject water for primary cooling tower make-up water, an un-chlorinated but good quality raw water for secondary cooling tower make-up water, an un-chlorinated membrane permeate for demineralization feed-water, and an un-chlorinated membrane permeate for potable water system feed-water. The embodiment reflected in this figure differs slightly mechanically from that of FIG. 3 wherein side-stream 19 is extracted from raw water 6 rather than invention feed-water 8.

FIG. 6 is a process diagram illustrative of an embodiment of the invention applied at a typical thermal power plant. In this figure, the embodiment of the process invention receives a pressured, chlorinated and good quality raw water stream and provides; a chlorinated and good quality raw water for plant service water and for plant fire protection system water, a chlorinated and good quality membrane reject water for primary cooling tower make-up water; a chlorinated and good quality raw water for secondary cooling tower make-up water, a chlorinated membrane permeate for potable water system feed-water, and a de-chlorinated membrane permeate for demineralization system feed-water. The embodiment reflected in this figure differs slightly mechanically from that of FIG. 4, wherein side-stream 19 is extracted from raw water 6 rather than invention feed-water 8.

FIG. 7 is a process diagram illustrative of an embodiment of the invention applied at a typical thermal power plant. In this figure, the embodiment of the process invention receives a pressured raw water stream and provides; a chlorinated mechanical filtrate for plant service water and for plant fire protection system water, a chlorinated and mechanically filtered membrane reject water for primary cooling tower make-up water; an un-chlorinated raw water for secondary cooling tower make-up water, a chlorinated membrane permeate for potable water system feed-water, and a de-chlorinated membrane permeate for demineralization system feed-water.

FIG. 8 is a process diagram illustrative of an embodiment of the invention applied at a typical thermal power plant. In this figure, the embodiment of the process invention receives a pressured raw water stream and provides; a chlorinated membrane permeate for plant service water and for plant fire protection system water, an un-chlorinated but mechanically filtered membrane reject water for primary cooling tower make-up water, an un-chlorinated raw water for secondary cooling tower make-up water, an un-chlorinated membrane permeate for potable water system feed-water, and an un-chlorinated membrane permeate for demineralization system feed-water.

FIG. 9 is a process diagram illustrative of an embodiment of the invention applied at a typical thermal power plant. In this figure, the embodiment of the process invention receives a pressured raw water stream and provides; an un-chlorinated membrane permeate for plant service water and for plant fire protection system water, an un-chlorinated, mechanically filtered membrane reject water for primary cooling tower make-up water; a raw water for secondary cooling tower make-up water, an un-chlorinated membrane permeate for potable water system feed-water, and an un-chlorinated membrane permeate for demineralization system feed-water.

FIG. 10 is a process diagram illustrative of an embodiment of the invention applied at a typical thermal power plant. In this figure, the embodiment of the process invention receives a pressured raw water stream and provides; an un-chlorinated membrane permeate for plant service water, plant fire protection system water and potable water system feed-water, an un-chlorinated, mechanically filtered membrane reject water for primary cooling tower make-up water; a raw water for secondary cooling tower make-up water, and an un-chlorinated membrane permeate for demineralization system feed-water.

FIG. 11 is a process diagram illustrative of an embodiment of the invention applied at a typical thermal power plant. In this figure, the embodiment of the process invention receives a pressured raw water stream and provides; a chlorinated membrane permeate for plant service water, plant fire protection system water and potable water system feed-water, an un-chlorinated, mechanically filtered membrane reject water for primary cooling tower make-up water; a raw water for secondary cooling tower make-up water, and an un-chlorinated membrane permeate for demineralization system feed-water.

FIG. 12 is a process diagram illustrative of an embodiment of the invention applied at a typical thermal power plant. In this figure, the embodiment of the process invention receives a pressured raw water stream and provides; an un-chlorinated membrane permeate for plant service water and plant fire protection system water, a chlorinated membrane permeate for potable water system feed-water, an un-chlorinated, mechanically filtered membrane reject water for primary cooling tower make-up water; a raw water for secondary cooling tower make-up water, and an un-chlorinated membrane permeate for demineralization system feed-water.

FIG. 13 is a process diagram illustrative of an embodiment of the invention applied at a typical thermal power plant. In this figure, the embodiment of the process invention receives a pressured raw water stream and provides; an un-chlorinated membrane permeate for plant service water and plant fire protection system water, an un-chlorinated, pressured membrane permeate for potable water system feed-water, an un-chlorinated, mechanically filtered membrane reject water for primary cooling tower make-up water; a raw water for secondary cooling tower make-up water, and an un-chlorinated membrane permeate for demineralization system feed-water.

FIG. 14 is a process diagram illustrative of an embodiment of the invention applied at a typical thermal power plant. In this figure, the embodiment of the process invention receives a pressured raw water stream and provides; a chlorinated membrane permeate for plant service water and plant fire protection system water, a chlorinated, membrane permeate for pressured potable water system feed-water, an un-chlorinated, mechanically filtered membrane reject water for primary cooling tower make-up water; a raw water for secondary cooling tower make-up water, and an un-chlorinated membrane permeate for demineralization system feed-water.

FIG. 15 is a process diagram illustrative of an embodiment of the invention applied at a typical thermal power plant. In this figure, the embodiment of the process invention receives a pressured raw water stream and provides; an un-chlorinated membrane permeate for plant service water and plant fire protection system water, a chlorinated membrane permeate for pressured potable water system feed-water, an un-chlorinated, mechanically filtered membrane reject water for primary cooling tower make-up water; a raw water for secondary cooling tower make-up water, and an un-chlorinated membrane permeate for demineralization system feed-water.

FIG. 16 is a process diagram illustrative of an embodiment of the invention applied at a typical thermal power plant. In this figure, the embodiment of the process invention receives a pressured raw water stream and provides; a chlorinated mechanical filtrate for plant fire protection system water, a chlorinated membrane permeate for plant service water, an un-chlorinated, mechanically filtered membrane reject water for primary cooling tower make-up water; a raw water for secondary cooling tower make-up water, an un-chlorinated membrane permeate for potable water system feed-water, and an un-chlorinated membrane permeate for demineralization system feed-water.

FIG. 17 is a process diagram illustrative of an embodiment of the invention applied at a typical thermal power plant. In this figure, the embodiment of the process invention receives a pressured raw water stream and provides; a chlorinated mechanical filtrate for plant fire protection system water, a chlorinated membrane permeate for plant service water, a chlorinated, mechanically filtered membrane reject water for primary cooling tower make-up water; a raw water for secondary cooling tower make-up water, a chlorinated membrane permeate for potable water system feed-water, and a de-chlorinated membrane permeate for demineralization system feed-water.

FIG. 18 is a process diagram illustrative of an embodiment of the invention applied at a typical thermal power plant. In this figure, the embodiment of the process invention receives a pressured raw water stream and provides; a chlorinated mechanical filtrate for plant fire protection system water, a chlorinated membrane permeate for plant service water, a chlorinated, mechanically filtered membrane reject water for primary cooling tower make-up water; a chlorinated raw water for secondary cooling tower make-up water, a chlorinated membrane permeate for potable water system feed-water, and a de-chlorinated membrane permeate for demineralization system feed-water.

FIG. 19 is a process diagram illustrative of an embodiment of the invention applied at a typical thermal power plant. In this figure, the embodiment of the process invention receives a pressured, chlorinated but poor quality raw water stream and provides; a chlorinated mechanical filtrate for plant fire protection system water, a chlorinated membrane permeate for plant service water, a chlorinated, mechanically filtered membrane reject water for primary cooling tower make-up water; a chlorinated raw water for secondary cooling tower make-up water, a chlorinated membrane permeate for potable water system feed-water and a de-chlorinated membrane permeate for demineralization system feed-water.

FIG. 20 is a process diagram illustrative of an embodiment of the invention applied at a typical thermal power plant. In this figure, the embodiment of the process invention receives a pressured, chlorinated, good quality raw water stream and provides; a chlorinated good quality raw water for fire protection system water, a chlorinated, good quality membrane reject water for prime cooling tower make-up water; a chlorinated good quality raw water for secondary cooling tower make-up water, a chlorinated membrane permeate for plant service water, a chlorinated membrane permeate for potable water system feed-water, and a de-chlorinated membrane permeate for demineralization system feed-water.

FIG. 21 is a process diagram illustrative of an embodiment of the invention applied at a typical thermal power plant. In this figure, the embodiment of the process invention receives a pressured, chlorinated, good quality raw water stream and provides; a chlorinated, good quality raw water for fire protection system water, a chlorinated, good quality membrane reject water for prime cooling tower make-up water; chlorinated, good quality raw water for secondary cooling tower make-up water, a chlorinated membrane permeate for plant service water, a chlorinated membrane permeate for potable water system feed-water, and a de-chlorinated membrane permeate for demineralization system feed-water. The process delineated in FIG. 21 differs mechanically only slightly from that of FIG. 20. The embodiment reflected in this figure differs slightly mechanically from that of FIG. 20 wherein side-stream 19 is extracted from raw water 6 rather than invention feed-water 8.

FIG. 22 is a process diagram illustrative of an embodiment of the invention applied at a typical thermal power plant. In this figure, the embodiment of the process invention receives an insufficiently pressured raw water stream and provides; a chlorinated mechanical filtrate for plant service water, a chlorinated mechanical filtrate for plant fire protection water, an un-chlorinated membrane reject water for primary cooling tower make-up water, an un-chlorinated raw water for secondary cooling tower make-up water, an un-chlorinated membrane permeate for potable water system feed-water, and an un-chlorinated membrane permeate for demineralization system feed-water.

FIG. 23 is a process diagram, similar to the preferred embodiment of the invention installed at a typical thermal power plant as was illustrated on FIG. 2, but with the exclusion of the potable water treatment system. This embodiment is useful in those applications in which potable water is either not needed or supplied in another, unrelated fashion.

FIG. 24 is a process diagram, similar to the preferred embodiment of the invention installed at a typical thermal power plant as was illustrated on FIG. 2, but with the exclusion of the fire protection water system. This embodiment is useful in those applications in which the fire protection water is either not needed or supplied in another, unrelated fashion.

FIG. 25 is a process diagram, similar to the preferred embodiment of the invention installed at a typical thermal power plant as was illustrated on FIG. 2, but with the exclusion of the plant service water system. This embodiment is useful in those applications in which the service water system is either not needed or supplied in another, unrelated fashion.

FIG. 26 is a process diagram illustrative of an embodiment of the invention applied at a typical thermal power plant. In this figure, the embodiment of the process invention receives a pressured raw water stream and provides; a chlorinated mechanical filtrate for plant service water, a chlorinated mechanical filtrate for plant fire protection water, an un-chlorinated, mechanically filtered membrane reject water for primary cooling tower make-up water, an un-chlorinated mechanical filtrate for secondary cooling tower make-up water, an un-chlorinated membrane permeate for potable water system feed-water, and an un-chlorinated membrane permeate for demineralization system feed-water.

FIG. 27 is a process diagram illustrative of an embodiment of the invention applied at a typical thermal power plant. In this figure, the embodiment of the process invention receives a pressured raw water stream and provides; a chlorinated mechanical filtrate for plant service water, a chlorinated mechanical filtrate for plant fire protection water, an un-chlorinated, mechanically filtered membrane reject water for primary cooling tower make-up water, an un-chlorinated mechanical filtrate for secondary cooling tower make-up water, an un-chlorinated raw water for tertiary cooling tower make-up water, an un-chlorinated membrane permeate for potable water system feed-water, and an un-chlorinated membrane permeate for demineralization system feed-water.

FIG. 28 is a process diagram illustrative of an embodiment of the invention applied at an industrial plant. In this figure, the embodiment of the process invention receives a pressured raw water stream. In this figure, the embodiment of the process invention receives a pressured raw water stream and provides; a chlorinated mechanical filtrate for the industrial plant service water, a chlorinated mechanical filtrate for the industrial plant fire protection water, an un-chlorinated, mechanically filtered membrane reject water for primary cooling tower make-up water, an un-chlorinated raw water for secondary cooling tower make-up water, an un-chlorinated membrane permeate for feed-water to the demineralization system of the industrial plant, and an un-chlorinated membrane permeate for feed-water to the potable water system of the industrial plant.

### REFERENCE NUMERALS IN THE DRAWINGS

2 Source water for the power plant
4 Raw water feed pumps
5 Raw water booster pump system
6 Pressured raw water feed to the plant
7 Booster pump pressured raw water
8 Extraction stream from the raw water feed to the invention
9 Tertiary cooling tower makeup water
10 Mechanical filter
12 Membrane filter
14 Back-flush waste from the mechanical filter
16 Reject from the membrane filter
17 Filtrate from the mechanical filter
18 Mechanical filtrate side-stream
19 Raw water side-stream
20 Primary cooling tower make-up water
21 Secondary cooling tower make-up water
22 Membrane permeate stream
23 Mechanical filtrate for secondary cooling tower makeup
24 Feed-water to the plant potable water system
26 Potable water system
28 Feed-water to the plant demineralization system
29 De-chlorinated feed-water to the plant demineralization system
30 Chlorinating chemical dispensation
31 De-chlorinating chemical dispensation
32 Membrane permeate side-stream
34 Chlorinating chemical storage
35 Chlorinating chemical dispensation
36 Chlorinating chemical feed pumps
37 Chlorinating chemical feed pumps
38 Plant demineralization system
40 Demineralized water to the power plant
42 Demineralization system reject water
44 Cooling tower blow down
46 Plant wastewater stream
48 Plant wastewater discharge
50 Powerhouse
51 Industrial plant
52 Circulating water contacted heat exchanger
54 Heat transfer system between the plant and the circulating water contacted heat exchanger
56 Circulating water
58 Circulating water pumps
60 Cooling tower
62 Cooling tower chemicals storage
64 Cooling tower chemical treatment dosing pumps
65 Plant service water storage
66 Plant service water and fire protection water storage
67 Fire protection water storage
68 Plant fire protection system
69 Plant service water, fire protection water and potable water system storage
70 Plant service water pumps
71 Fire protection system feed-water
72 Plant service water
74 Clarifier feed-water of the prior art
75 Chlorinating chemical dispensation to the clarifier of the prior art
76 Clarifier of the prior art
78 Acid storage of the prior art
80 Acid dosing pumps of the prior art
82 Metal salts coagulant storage of the prior art
84 Metals salts coagulant dosing pumps of the prior art
86 Heated caustic storage of the prior art
88 Caustic dosing pumps of the prior art
90 Heated cationic polymer flocculent storage of the prior art
92 Cationic polymer flocculent dosing pumps of the prior art
94 Heated anionic polymer flocculent storage of the prior art
96 Anionic polymer flocculent dosing pumps of the prior art
98 Clarifier effluent of the prior art
100 Mixed bed gravity filter of the prior art
102 Clarifier sludge discharge of the prior art
104 Clarifier sludge pond of the prior art
106 Sludge pond cleanout system of the prior art
108 Sludge transport and ultimate disposal of the prior art
110 Mixed bed filter back-flush wastewater of the prior art
112 Mixed bed filter back-flush wastewater sump of the prior art
114 Back-flush wastewater of the prior art
116 Back-flush wastewater transfer pumps of the prior art
118 Back-flush wastewater disposal location of the prior art
121 Mixed bed filtrate of the prior art
122 Filtrate sump of the prior art
124 Back-flush filtrate water of the prior art
126 Back-flush pumps of the prior art
128 Pressured back-flushing filtrate of the prior art
130 Filtrate of the prior art
132 Filtrate water pumps of the prior art
134 Filtrate dispensation of the prior art
136 Cartridge filter system feed-water of the prior art
138 Demineralization feed-water polishing cartridge filters of the prior art
140 Polished, chlorinated demineralization system feed-water of the prior art
142 De-chlorination chemical storage
144 De-chlorination chemical dosing pumps
146 De-chlorinated, cartridge filter polished feed-water to the demineralization system of the prior art
148 Potable water system feed-water of the prior art and certain embodiments of the invention
150 Potable water treatment system of the prior art and certain embodiments of the invention

### BRIEF SUMMARY OF THE INVENTION

This patent describes a process imparting the service of treating water to a quality greater than that achieved by the chemical clarifier based processes of the prior art. The invention provides this service without the requirements for chemicals, complex pumps and controls and without the generation of sludge. This patent describes the process wherein a series combination of mechanical and membrane filtration processes, hydraulically pressured only from the feed-water line, generates a permeate water product of appropriate quality for potable system and demineralization system feed, a filtered water product appropriate for service and firewater use and a reject water product of higher quality than the pressured feed employment as make-up water for a cooling tower.

The process can be configured in a bypass format about an existing clarifier based process or can be configured as a standalone system in lieu of the chemical clarifier based processes of the prior art. In either configuration the process receives pressured water, generally from the make-up line to the cooling tower filters this water through a back-flushable mechanical filtration system. A slip-stream of this mechanically filtered water is chlorinated and employed for plant service and fire protection water. The preponderance of the mechanically filtered water is directed past a membrane filtration surface in a high velocity, single pass, cross-flow, fashion. Permeate water is generated as a sterile, high quality product for potable water and demineralization system feed. The mechanically filtered, high volume membrane reject is then directed as a product stream for use as a high quality cooling tower make-up water source. This product stream can be used alone for make-up or blended with the normal make-up water as the cooling tower consumption so requires. Back-flush water from the mechanical filtration system is directed from the invention to the blow down line from the cooling tower or other wastewater receiving sites at the plant.

The invention operates in a closed mode with all operating pressures imposed by the make-up or feed stream line. Back-flush pressures for the mechanical filters and the membrane filters are generated either by the internal pressures exerted by the feed line, by compressed air, or by a small booster pump system. In contrast to the complexities of the prior art the pumps, valves, controls and other associated equipment are not needed, thereby eliminating their associated capital and operating expenses.

The invention requires no chemical feed other than chlorine dosing of the mechanically filtered water as is consistent with good water management practices for the plant service and fire protection water needs. The majority of the collected solids are extracted by the mechanical filtration device. These solids are back-flushed intermittently to a disposal site, such as a cooling tower blow down lines. This waste contains no chemicals and only purveys concentrated levels of solid materials which naturally occur in the make-up water. There is no sludge or other chemically laced waste generated; thereby eliminating any associated environmental liabilities and disposal expenses.

Further features and advantages of the invention will be apparent to those knowledgeable in the art by reference to the illustrations and associated elucidations supporting twenty six embodiments of the art as follows.

Figure Descriptions

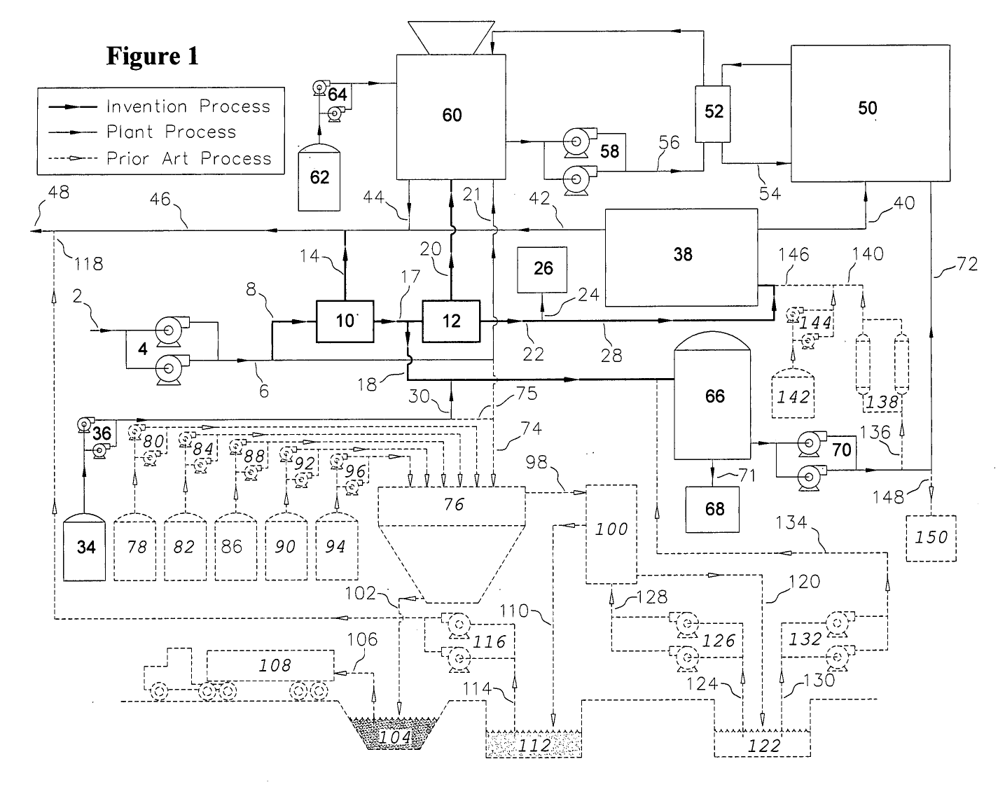

Description: FIG. 1

Direct to obtaining the effect of the invention a preferred embodiment, processing in parallel with a typical embodiment of the prior art, is illustrated as a process diagram in FIG. 1. This figure illustrates the contrast of the simplicity, superior attributes and advantages of the invention to the complexity and inherent disadvantages of the prior art. This figure presents a process diagram of the invention and a typical process diagram of the prior art as applied to a thermal power plant water cycle.

The line legend on FIG. 1 delineates the process flow and relevant system components of the invention with solid heavy lines with broken arrows, the thermal power plant process flow and relevant system components in solid thin lines and the process flow and relevant components of the prior art in dashed thin lines. The reader will note that the process invention, as delineated in solid heavy lines with broken arrows occasions the impressive elimination of all those process lines and components of the prior art corresponding to the dashed thin lines. The reader should note; power plants typically configure pumps in a duplex format so as to facilitate reliability. This practice is presented in this figure. In deference to reducing reiteration, the reference in this document to a pump or pumping system should be assumed by the reader as indicative of a duplex configuration, unless otherwise stated.

The figure presents a generalized water cycle of a thermal power plant. The power plant is cooled by a cooling tower 60. A circulating cooling water stream 56 is pressured and driven by a circulating water pump 58. The circulating cooling water stream 56 provides cooling to a heated gas or fluid 54 originating from a power house 50. The cooling is facilitated by a circulating water contacted heat exchanger 52. The water chemistry of the circulating water 56 from the cooling tower 60 is maintained in three fashions; first by a consortium of chemicals 62 dispensed via a dosage controlled chemical pumping system 64, second, by discharge of cooling tower 60 water by means of a blow-down stream 44 to waste and third, by a fresh feed-water make-up 20 and 21. A demineralization system 38 provides demineralized water 40 to the power house 50 for various applications. A demineralization system reject wastewater stream 42 is combined with the cooling tower blow-down 44 and conveyed as a plant wastewater stream 46 for elimination at a plant discharge site 48.

There are five main dispensations of water at the power plant. The first is a high quality feed-water 28 for the plant demineralization system 38. The second is a chlorinated good quality plant service water 72 for wash down and general utility use. The third is the make-up water 20 and 21 for the cooling tower 60. The fourth is a chlorinated, good quality feed-water 71 for a power plant fire protection system 68. The fifth is a sterile, good quality feed-water 24 for a plant potable water system 26.

The invention relates to the water cycle process of the plant. In summary of the water cycle process of the prior art, a raw feed-water to the plant is drawn in from a source at 2. This raw water stream is pressured at a pump 4. The raw water is conveyed in a pressured feed line 6 to the cooling tower 60 as the make-up water supply 21 and as a feed-water 74 to a clarifier 76. A chlorinating chemical, such as sodium hypochlorite 34 is dispensed, via a dosage controlled pump 36, into a conveyance line 75 which feeds into the clarifier feed-water 74. The water is treated in the clarifier 76 with chemicals, examples of such chemicals being, a caustic, such as sodium hydroxide 78 to increase the pH, which is dispensed via a dosage controlled chemical pump 80. A metal salt solution such as ferric sulfate 82 is dispensed, via a dosage controlled chemical pump 84, as a coagulant. A cationic polymer 86 is dispensed, via a dosage controlled chemical pump 88, as a flocculent. An anionic polymer 90 is also often dispensed, via a dosage controlled chemical pump 92, as an additional flocculent. An acidic solution, such as sulfuric acid, 94 is often dispensed, via a dosage controlled pump 96 at the effluent decanting point, or into an effluent line 98 to buffer the effluent pH to the requisite levels of the plant.

Effluent is discharged from the clarifier by gravity and is conveyed via an effluent line 98 to a gravity fed, mixed bed filter 100. A filtrate 120 from the gravity fed, mixed bed filter is conveyed to a filtered water sump 122.

Filtered water from the filtered water sump 122 provides two services. A filtered water stream 124 is extracted from the filtered water sump 122 by a back-flush pump 126 and is conveyed as a pressured back-flushing fluid 128 to the gravity filter 100. A back-flush wastewater 110 is then conveyed by gravity into a back-flush waste sump 112. A back-flush wastewater stream 114 is periodically extracted by a wastewater sump pump 116 and conveyed to a discharge point 118.

A stream of filtered water 130 is also extracted from the filtered water sump 122 by a filtered water pump 132. A stream of this pressured, filtered water 134 is then conveyed to a plant service water and fire water storage tank 66. This water carries residual chlorine so as to maintain biological control in the storage tank 66 and as a good maintenance practice for a plant fire water system 68 and for a plant service water stream 72. Water from tank 66 is pressured and conveyed through a plant service water pump system 70 and directed for plant service water 72 serving the plant 50. The plant fire protection water system is also provided water 71 from tank 66.

A side-stream of pressured plant service water 136 is conveyed through a cartridge filtration system 138 for further filtration polishing. A polished and chlorinated filtrate stream 140 is then treated by a de-chlorination chemical, such as sodium bisulfite 142, which is dispensed, via a dosage controlled chemical pump 144, into the filtrate stream 140. A polished, chlorine free, filtrate is then available as a demineralization system feed-water 146 which is then conveyed to a plant demineralization system 38. A side-stream 148 of pressured plant service water 72 is conveyed to a plant potable water system 150

Sludge generated in the clarifier 76 is discharged periodically as a sludge stream 102 which is conveyed by gravity drainage into a sludge pond 104. A suction line 106 is then periodically employed to empty the contents of the sludge pond 104 into a truck 108 for sludge transport and ultimate disposal elsewhere.

In stark contrast to the complexity, quantity of equipment, chemical usage, space requirements, pumping energy loads and sludge generation problems of the prior art, the reader is directed toward the heavy solid lines with broken arrows of FIG. 1. These lines represent the process and components of the invention. In this, the preferred embodiment of the invention, raw water is extracted from the source 2 and pressured in the raw water feed pump 4 in an identical fashion to the prior art. The pressured raw water stream 6 is conveyed as a secondary make-up water 21 to the plant cooling tower 60. The invention eliminates the need for the clarifier 76 and all associated systems 74 through 146.

Direct to the invention, a pressured side-stream 8 is extracted from the pressured raw water stream 6 and is directed to a mechanical filtration system 10. Suspended solids are mechanically extracted from the water and a good quality filtrate 17 is conveyed in two directions; the preponderance of the filtrate 17 is directed into a membrane filtration system 12, while the remainder of the filtrate 17 is discharged as a side-stream 18. Solids collected by the mechanical filtration system 10, are discharged as a waste stream 14 to the plant waste stream 46 for disposal at the plant discharge site 48. A chlorinating chemical 34, such as sodium hypochlorite, is dispensed via a dosage controlled chemical pump 36, and a conveyance 30 into the filtrate side-stream 18. This chlorinated filtrate is then delivered to the storage tank 66 for the plant fire protection system feed-water 71 and plant service water 72. Water from this tank is pressured through the plant service water pump system 70 and conveyed as plant service water 72 serving the plant 50. The plant fire protection system is provided feed-water 71 from tank 66.

The membrane filtration system 12 receives the filtrate stream 17 at a high rate of flow. The filtrate stream 17 is conducted across membrane surfaces of the membrane filtration system 12 in a high velocity, cross-flow mode to secure cleansing of the membrane filtration system 12. The filtrate 17 is applied in a single pass manner, affording it as a good quality, mechanically filtered reject water 16 profiting the power plant as a good quality, primary make-up water 20 to the cooling tower 60. The cooling tower 60 is delivered a lower quality, secondary make-up water 21 which is provided from the raw water stream 6 as is needed to supplement the good quality primary make-up water 20.

A high quality permeate stream 22 exits the membrane filtration system 12 as a very high quality, sterile, chlorine free product. This permeate stream 22 provides service as the feed-water 24 to the potable water system 26 and as the demineralization feed-water 28 to the demineralization system 38 at the plant.

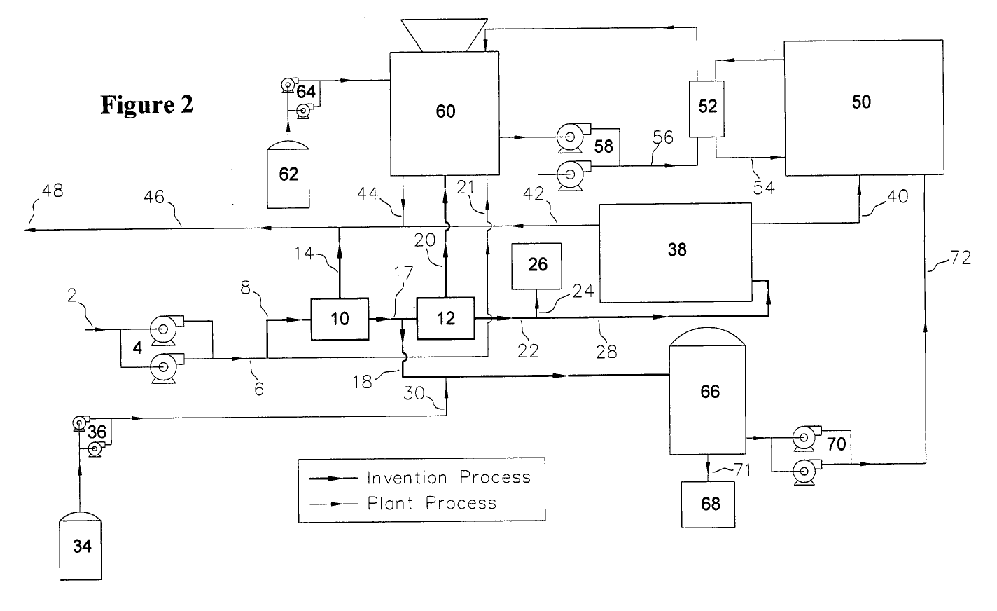

Description: FIG. 2

Direct to obtaining the effect of the invention, FIG. 2 illustrates the preferred embodiment of the invention at a typical thermal power plant. This preferred embodiment of the invention receives a pressured raw water stream and provides; chlorinated mechanical filtrate for plant service water, chlorinated mechanical filtrate for plant fire protection water, un-chlorinated membrane reject water for primary cooling tower make-up water, un-chlorinated raw water for secondary cooling tower make-up water and un-chlorinated membrane permeate as both demineralization feed-water and potable water system feed-water.

The line legend on FIG. 2 delineates the process flow and relevant system components of the invention with solid heavy lines with broken arrows and the thermal power plant process flow and relevant system components in solid thin lines. The reader should note; power plants typically configure pumps in a duplex format so as to facilitate reliability. This practice is presented in this figure. In deference to reducing reiteration, the reference in this document to a pump or pumping system should be assumed by the reader as indicative of a duplex configuration, unless otherwise stated.

The figure presents a generalized water cycle of a thermal power plant. The power plant is cooled by a cooling tower 60. A circulating cooling water stream 56 is pressured and driven by a circulating water pump 58. The circulating cooling water stream 56 provides cooling to a heated gas or fluid 54 originating from a power house 50. The cooling is facilitated by a circulating water contacted heat exchanger 52. The water chemistry of the circulating water 56 from the cooling tower 60 is maintained in three fashions; first by a consortium of chemicals 62 dispensed via a dosage controlled chemical pumping system 64, second, by discharge of cooling tower 60 water by means of a blow-down stream 44 to waste and third, by a fresh feed-water make-up 20 and 21. A demineralization system 38 provides demineralized water 40 to the power house 50 for various applications. A demineralization system reject wastewater stream 42 is combined with the cooling tower blow-down 44 and conveyed as a plant wastewater stream 46 for elimination at a plant discharge site 48.

There are five main dispensations of water at the power plant. The first is a high quality feed-water 28 for the plant demineralization system 38. The second is a chlorinated, good quality plant service water 72 for wash down and general utility use. The third is the make-up water 20 and 21 for the cooling tower 60. The fourth is a chlorinated, good quality feed-water 71 for a power plant fire protection system 68. The fifth is a high quality feed-water 24 for a plant potable water system 26.

In this, the preferred embodiment, a single storage tank 66 provides storage for two of the five dispensations of water at the plant; the plant service water 72 and the fire protection system feed-water 71.

The invention relates to the water cycle process of the plant. The reader is directed toward the heavy solid lines with broken arrows of FIG. 2. These lines represent the process and components of the invention. In this, the preferred embodiment of the invention, raw water is supplied to the invention from a source 2 after being pressured in a raw water feed pump 4. A pressured raw water stream 6 is conveyed as a secondary make-up water 21 to the plant cooling tower 60. A pressured side-stream 8 is extracted from the pressured raw water stream 6 and supplies the invention. Side-stream 8 conveys water to a mechanical filtration system 10. Suspended solids are mechanically extracted from the water and a good quality filtrate 17 is conveyed in two directions; the preponderance of the filtrate 17 is directed into a membrane filtration system 12, while the remainder of the filtrate 17 is discharged as a side-stream 18. Solids collected by the mechanical filtration system 10, are discharged as a waste stream 14 to the plant waste discharge stream 46 for disposal at the plant discharge site 48. A chlorinating chemical 34, such as sodium hypochlorite, is dispensed via a dosage controlled chemical pump 36, and delivered 30 into the filtrate side-stream 18. The resulting chlorinated filtrate stream is conveyed to the storage tank 66 for eventual use as the plant fire protection water system feed-water 71 and the plant service water 72. Water from this tank is pressured through a plant service water pump system 70 and conveyed as the plant service water 72 serving the plant 50. The plant fire protection system 68 is provided feed-water 71 from the tank 66.

The membrane filtration system 12 receives the filtrate stream 17 at a high rate of flow. The filtrate stream 17 is conducted across membrane surfaces of the membrane filtration system 12 in a high velocity, cross-flow mode to secure cleansing of the membrane filtration system 12. The filtrate 17 is applied in a single pass manner, affording it as a good quality, mechanically filtered reject water 16 profiting the power plant as a good quality, primary make-up water 20 to the cooling tower 60. The cooling tower 60 is delivered a lower quality, secondary make-up water 21 which is provided from the raw water stream 6 as is needed to supplement the good quality primary make-up water 20.

A permeate stream 22 exits the membrane filtration system 12 as a very high quality, sterile, chlorine free product. This permeate stream 22 supplies both the feed-water 24 to the potable water system 26 and the demineralization feed-water 28 to the demineralization system 38 at the plant.

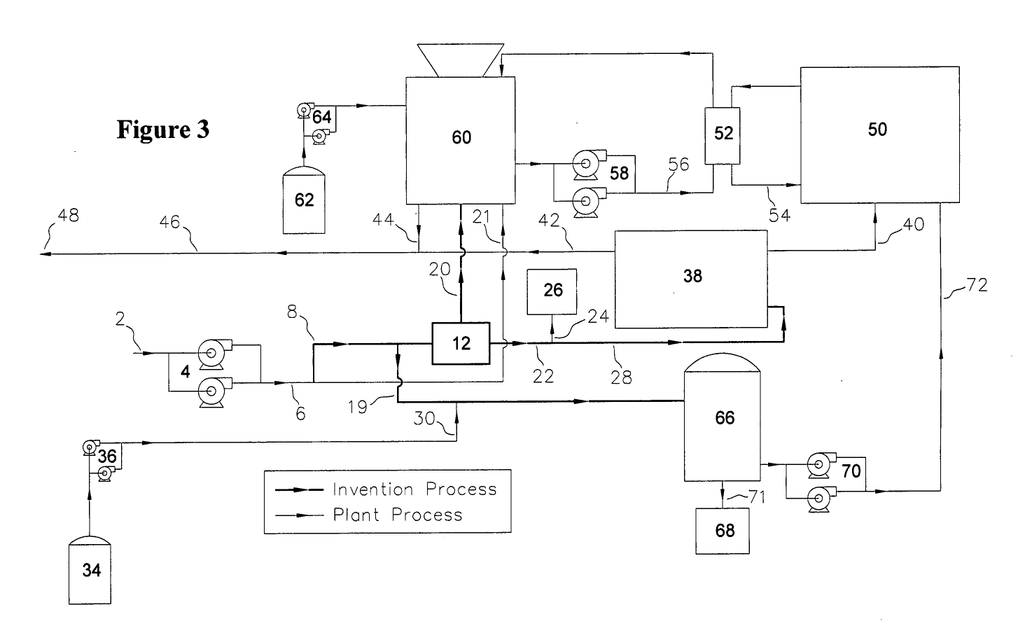

Description: FIG. 3

Direct to obtaining the effect of the invention, FIG. 3 illustrates an embodiment of the invention at a typical thermal power plant. This embodiment of the invention receives a pressured good quality but un-chlorinated raw water stream and provides; chlorinated raw water for plant service water and for plant fire protection system water, un-chlorinated membrane reject water for primary cooling tower make-up water, un-chlorinated raw water for secondary cooling tower make-up water and un-chlorinated membrane permeate for both demineralization feed-water and potable water system feed-water.

The line legend on FIG. 3 delineates the process flow and relevant system components of the invention with solid heavy lines with broken arrows and the thermal power plant process flow and relevant system components in solid thin lines. The reader should note; power plants typically configure pumps in a duplex format so as to facilitate reliability. This practice is presented in this figure. In deference to reducing reiteration, the reference in this document to a pump or pumping system should be assumed by the reader as indicative of a duplex configuration, unless otherwise stated.

The figure presents a generalized water cycle of a thermal power plant. The power plant is cooled by a cooling tower 60. A circulating cooling water stream 56 is pressured and driven by a circulating water pump 58. The circulating cooling water stream 56 provides cooling to a heated gas or fluid 54 originating from a power house 50. The cooling is facilitated by a circulating water contacted heat exchanger 52. The water chemistry of the circulating water 56 from the cooling tower 60 is maintained in three fashions; first by a consortium of chemicals 62 dispensed via a dosage controlled chemical pumping system 64, second, by discharge of cooling tower 60 water by means of a blow-down stream 44 to waste and third, by a fresh feed-water make-up 20 and 21. A demineralization system 38 provides demineralized water 40 to the power house 50 for various applications. A demineralization system reject wastewater stream 42 is combined with the cooling tower blow-down 44 and conveyed as a plant wastewater stream 46 for elimination at a plant discharge site 48.

There are five main dispensations of water at the power plant. The first is a high quality feed-water 28 for the plant demineralization system 38. The second is a chlorinated, good quality, raw plant service water 72 for wash down and general utility use. The third is the make-up water 20 and 21 for the cooling tower 60. The fourth is a chlorinated, good quality, raw feed-water 71 for a power plant fire protection system 68. The fifth is a high quality feed-water 24 for a plant potable water system 26.

In this embodiment a single storage tank 66 provides storage for two of the five dispensations of water at the plant; the plant service water 72 and the fire protection system feed-water 71.

The invention relates to the water cycle process of the plant. The reader is directed toward the heavy solid lines with broken arrows of FIG. 3. These lines represent the process and components of the invention. In this embodiment of the invention, good quality but unchlorinated water is provided at a source 2 and is pressured in a water feed pump 4. A pressured water stream 6 is conveyed as a secondary make-up water 21 to the plant cooling tower 60. A pressured side-stream 8 is extracted from the pressured water stream 6 and is directed to the invention, entering a membrane filtration system 12. Water is conveyed as a side-stream 19 from the pressured side-stream 8 to the plant service water and fire protection water storage tank 66. Plant specifications require that this water be chlorinated. Accordingly, a chlorinating chemical 34, such as sodium hypochlorite, is dispensed via a dosage controlled chemical pump 36, and a conveyance 30 into the side-stream 19. The resulting chlorinated water stream is then delivered to the plant fire protection water and plant service water storage tank 66. Water from this tank is pressured through a plant service water pump system 70 and conveyed as the plant service water 72 serving the plant 50. The plant fire protection water system 68 is provided water 71 from tank 66.

The membrane filtration system 12 receives the feed-stream 8 at a high rate of flow. The feed-stream 8 is conducted across membrane surfaces of the membrane filtration system 12 in a high velocity, cross-flow mode to secure cleansing of the membrane filtration system 12. The feed-stream 8 is applied in a single pass manner, affording it as a good quality reject water 16 profiting the power plant as a good quality, primary make-up water 20 to the cooling tower 60. The cooling tower 60 is also delivered the good quality, secondary make-up water 21 which is provided from the water stream 6 as is needed to supplement the primary make-up water 20.

A high quality permeate stream 22 exits the membrane filtration system 12 as a very high quality, sterile, chlorine free product. This permeate stream 22 provides service as the feed-water 24 to the potable water system 26 and as the demineralization feed-water 28 to the demineralization system 38 at the plant.

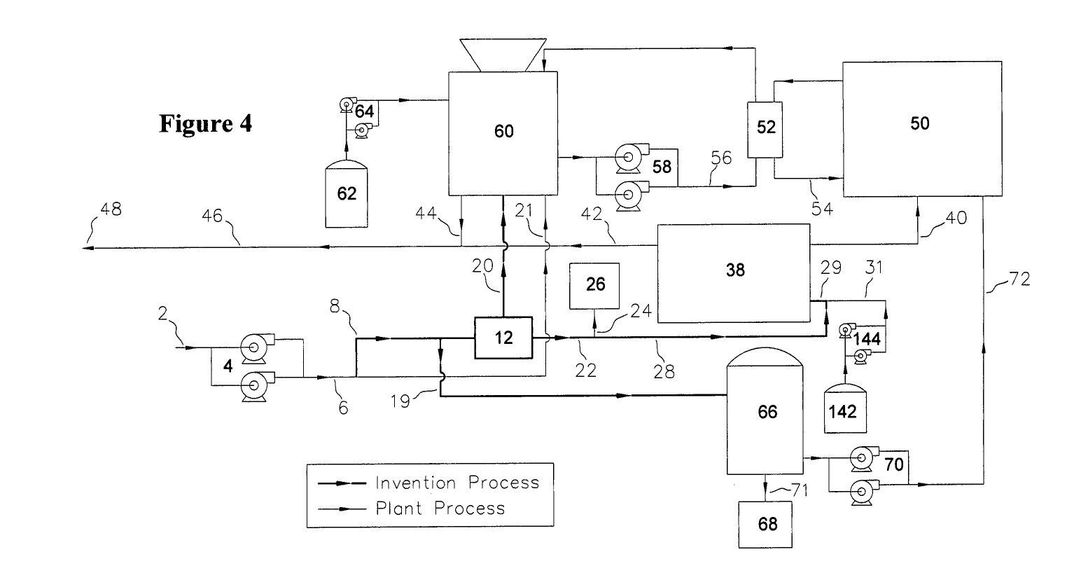

Description: FIG. 4

Direct to obtaining the effect of the invention, FIG. 4 illustrates an embodiment of the invention at a typical thermal power plant. This embodiment of the invention receives a pressured, chlorinated, good quality raw water stream and provides; chlorinated, good quality raw water for plant service water and for plant fire protection system water, chlorinated, good quality membrane reject water for primary cooling tower make-up water; chlorinated, good quality raw water for secondary cooling tower make-up water, chlorinated membrane permeate for potable water system feed-water and de-chlorinated membrane permeate for demineralization system feed-water.

The line legend on FIG. 4 delineates the process flow and relevant system components of the invention with solid heavy lines with broken arrows and the thermal power plant process flow and relevant system components in solid thin lines. The reader should note; power plants typically configure pumps in a duplex format so as to facilitate reliability. This practice is presented in this figure. In deference to reducing reiteration, the reference in this document to a pump or pumping system should be assumed by the reader as indicative of a duplex configuration, unless otherwise stated.

The figure presents a generalized water cycle of a thermal power plant. The power plant is cooled by a cooling tower 60. A circulating cooling water stream 56 is pressured and driven by a circulating water pump 58. The circulating cooling water stream 56 provides cooling to a heated gas or fluid 54 originating from a power house 50. The cooling is facilitated by a circulating water contacted heat exchanger 52. The water chemistry of the circulating water 56 from the cooling tower 60 is maintained in three fashions; first by a consortium of chemicals 62 dispensed via a dosage controlled chemical pumping system 64, second, by discharge of cooling tower 60 water by means of a blow-down stream 44 to waste and third, by a fresh feed-water make-up 20 and 21. A demineralization system 38 provides demineralized water 40 to the power house 50 for various applications. A demineralization system reject wastewater stream 42 is combined with the cooling tower blow-down 44 and conveyed as a plant wastewater stream 46 for elimination at a plant discharge site 48.

There are five main dispensations of water at the power plant. The first is a chlorinated, high quality feed-water 28 for de-chlorination and feed 29 to the plant demineralization system 38. The second is a chlorinated, good quality, raw plant service feed-water 72 for wash down and general utility use. The third is chlorinated make-up water 20 and 21 for the cooling tower 60. The fourth is a chlorinated, good quality, raw feed-water 71 for a power plant fire protection water system 68. The fifth is a chlorinated, high quality feed-water 24 for a plant potable water system 26.

In this embodiment a single storage tank 66 provides storage for two of the five dispensations of water at the plant; the plant service water 72 and the fire protection system feed-water 71.

The invention relates to the water cycle process of the plant. The reader is directed toward the heavy solid lines with broken arrows of FIG. 4. These lines represent the process and components of the invention. In this embodiment of the invention, good quality, chlorinated water is provided at a source 2 and is pressured in a raw water feed pump 4. A pressured water stream 6 is conveyed as a secondary make-up water 21 to the plant cooling tower 60. A pressured side-stream 8 is extracted from the pressured water stream 6 and is directed to a membrane filtration system 12. Water is conveyed as a side-stream 19 from the pressured side-stream 8 to the plant service water and plant fire protection water tank 66. Water from this tank is pressured through a plant service water pump system 70 and is conveyed as the plant service water 72 serving the plant 50. Tank 66 also provides the feed-water 71 to the plant fire protection water system 68.

A membrane filtration system 12 receives the side-stream 8 at a high rate of flow. The side-stream 8 is conducted across membrane surfaces of the membrane filtration system 12 in a high velocity, cross-flow mode to secure cleansing of the membrane filtration system 12. The side-stream 8 is applied in a single pass manner, affording it as a good quality reject water 16 profiting the power plant as a chlorinated, good quality, primary make-up water 20 to the cooling tower 60. The cooling tower 60 is also delivered the chlorinated, good quality secondary make-up water 21 which is provided from the raw water stream 6 as is needed to supplement the primary make-up water 20.

A high quality permeate stream 22 exits the membrane filtration system 12 as a very high quality, chlorinated water product. Permeate stream 22 provides service as the feed-water 24 to the potable water system 26. The membrane filtration system 12 does not remove chlorine. Accordingly, the demineralization feed stream 28, which remains after the potable water system feed-water 24 extraction, must be treated to remove residual chlorine. A de-chlorinating chemical, such as sodium bisulfite 142, is dispensed, by means of a chemical dosing pump system 144 into the demineralization system feed-water 28 to eliminate residual chlorine in this water before use as the de-chlorinated, high quality feed-water 29 to the demineralization system 38 at the plant.

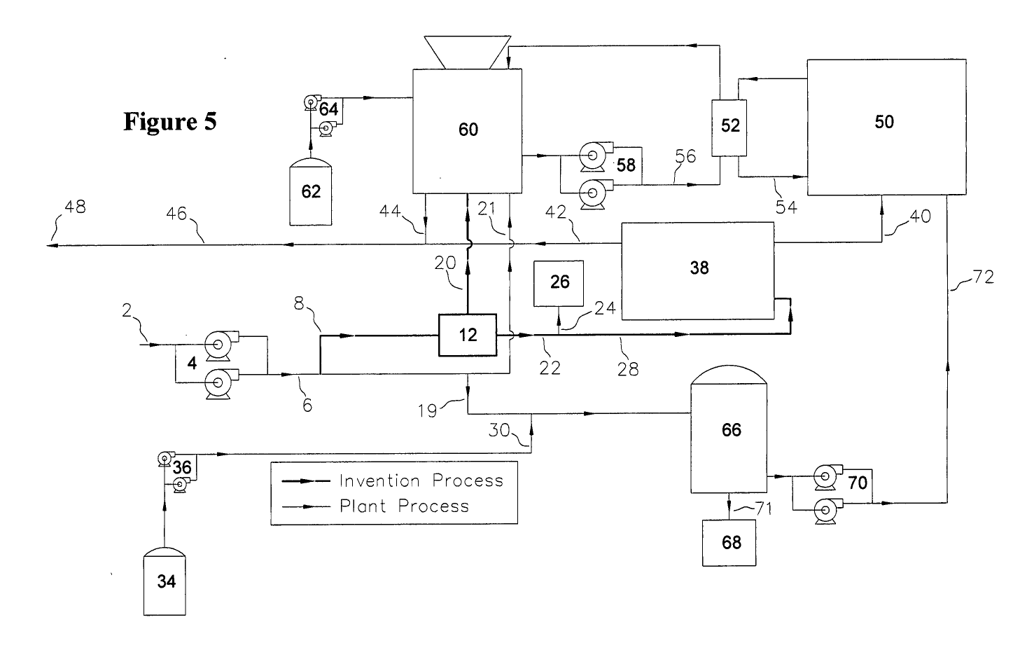

Description: FIG. 5

Direct to obtaining the effect of the invention, FIG. 5 illustrates an embodiment of the invention at a typical thermal power plant. This embodiment of the invention receives a pressured good quality but un-chlorinated raw water stream and provides; chlorinated raw water for plant service water and for plant fire protection system water, un-chlorinated membrane reject water for primary cooling tower make-up water, un-chlorinated raw water for secondary cooling tower make-up water and un-chlorinated membrane permeate for both demineralization feed-water and potable water system feed-water.

The line legend on FIG. 5 delineates the process flow and relevant system components of the invention with solid heavy lines with broken arrows and the thermal power plant process flow and relevant system components in solid thin lines. The reader should note; power plants typically configure pumps in a duplex format so as to facilitate reliability. This practice is presented in this figure. In deference to reducing reiteration, the reference in this document to a pump or pumping system should be assumed by the reader as indicative of a duplex configuration, unless otherwise stated.

The figure presents a generalized water cycle of a thermal power plant. The power plant is cooled by a cooling tower 60. A circulating cooling water stream 56 is pressured and driven by a circulating water pump 58. The circulating cooling water stream 56 provides cooling to a heated gas or fluid 54 originating from a power house 50. The cooling is facilitated by a circulating water contacted heat exchanger 52. The water chemistry of the circulating water 56 from the cooling tower 60 is maintained in three fashions; first by a consortium of chemicals 62 dispensed via a dosage controlled chemical pumping system 64, second, by discharge of cooling tower 60 water by means of a blow-down stream 44 to waste and third, by a fresh feed-water make-up 20 and 21. A demineralization system 38 provides demineralized water 40 to the power house 50 for various applications. A demineralization system reject wastewater stream 42 is combined with the cooling tower blow-down 44 and conveyed as a plant wastewater stream 46 for elimination at a plant discharge site 48.

There are five main dispensations of water at the power plant. The first is a high quality feed-water 28 for the plant demineralization system 38. The second is a chlorinated, good quality, raw plant service water 72 for wash down and general utility use. The third is the make-up water 20 and 21 for the cooling tower 60. The fourth is a chlorinated, good quality, raw feed-water 71 for a power plant fire protection system 68. The fifth is a high quality feed-water 24 for a plant potable water system 26.

In this embodiment a single storage tank 66 provides storage for two of the five dispensations of water at the plant; the plant service water 72 and the fire protection system feed-water 71.

The invention relates to the water cycle process of the plant. The reader is directed toward the heavy solid lines with broken arrows of FIG. 5. These lines represent the process and components of the invention. In this embodiment of the invention, good quality water is provided at a source 2 and is pressured in a water feed pump 4. A pressured water stream 6 is conveyed as a secondary make-up water 21 to the plant cooling tower 60. A pressured side-stream 8 is extracted from the pressured water stream 6 and is directed to the invention, entering a membrane filtration system 12. Water is conveyed as a side-stream 19 from the pressured water stream 6 for feed-water supply to the plant service water and fire protection water storage tank 66. Plant specifications require that this water be chlorinated. Accordingly, a chlorinating chemical 34, such as sodium hypochlorite, is dispensed via a dosage controlled chemical pump 36, and a conveyance 30 into the side-stream 19. This chlorinated water stream is then delivered to the plant fire water and plant service water storage tank 66. Water from this tank is pressured through a plant service water pump system 70 and conveyed as the plant service water 72 serving the plant 50. The plant fire protection system 68 is provided feed-water 71 from tank 66.

The membrane filtration system 12 receives the pressured side-stream water 8 at a high rate of flow. The side-stream 8 is conducted across membrane surfaces of the membrane filtration system 12 in a high velocity, cross-flow mode to secure cleansing of the membrane filtration system 12. This side-stream 8 is applied in a single pass manner, affording it as a high quality reject water 16 profiting the power plant as a good quality, primary make-up water 20 to the cooling tower 60. The cooling tower 60 is also delivered the good quality, secondary make-up water 21 which is provided from the water stream 6 as is needed to supplement the primary make-up water 20.

A high quality permeate stream 22 exits the membrane filtration system 12 as a very high quality, sterile, chlorine free product. Permeate stream 22 provides service as the feed-water 24 to the potable water system 26 and as the demineralization feed-water 28 to the demineralization system 38 at the plant.

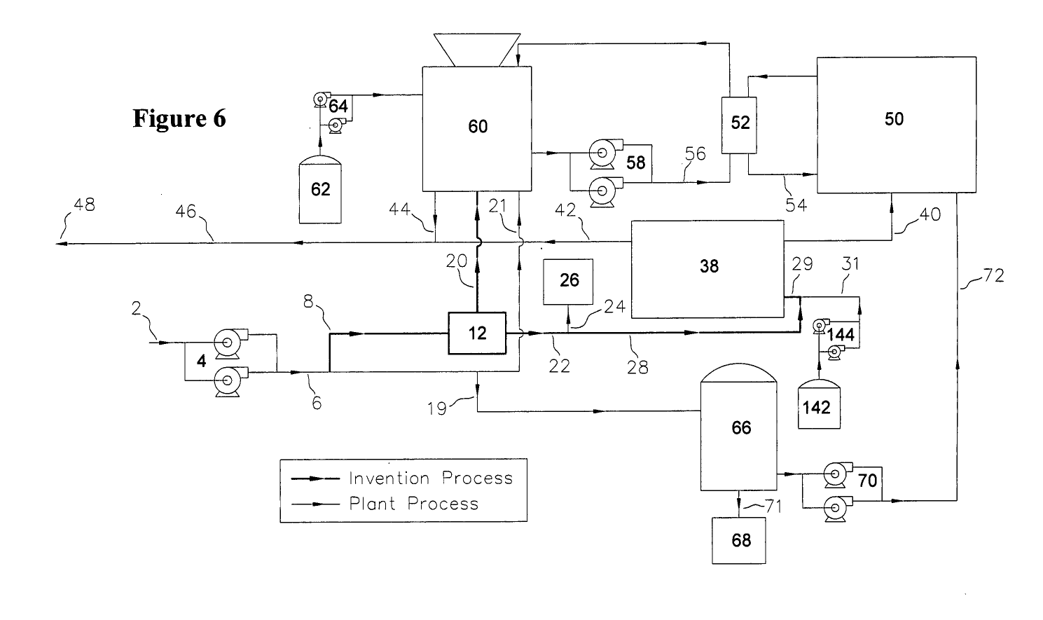

Description: FIG. 6

Direct to obtaining the effect of the invention, FIG. 6 illustrates an embodiment of the invention at a typical thermal power plant. This embodiment of the invention receives a pressured, chlorinated, good quality raw water stream and provides; chlorinated, good quality raw water for plant service water and for plant fire protection system water, chlorinated, good quality membrane reject water for primary cooling tower make-up water; chlorinated, good quality raw water for secondary cooling tower make-up water, chlorinated membrane permeate for potable water system feed-water and de-chlorinated membrane permeate for demineralization system feed-water.

The line legend on FIG. 6 delineates the process flow and relevant system components of the invention with solid heavy lines with broken arrows and the thermal power plant process flow and relevant system components in solid thin lines. The reader should note; power plants typically configure pumps in a duplex format so as to facilitate reliability. This practice is presented in this figure. In deference to reducing reiteration, the reference in this document to a pump or pumping system should be assumed by the reader as indicative of a duplex configuration, unless otherwise stated.

The figure presents a generalized water cycle of a thermal power plant. The power plant is cooled by a cooling tower 60. A circulating cooling water stream 56 is pressured and driven by a circulating water pump 58. The circulating cooling water stream 56 provides cooling to a heated gas or fluid 54 originating from a power house 50. The cooling is facilitated by a circulating water contacted heat exchanger 52. The water chemistry of the circulating water 56 from the cooling tower 60 is maintained in three fashions; first by a consortium of chemicals 62 dispensed via a dosage controlled chemical pumping system 64, second, by discharge of cooling tower 60 water by means of a blow-down stream 44 to waste and third, by a fresh feed-water make-up 20 and 21. A demineralization system 38 provides demineralized water 40 to the power house 50 for various applications. A demineralization system reject wastewater stream 42 is combined with the cooling tower blow-down 44 and conveyed as a plant wastewater stream 46 for elimination at a plant discharge site 48.

There are five main dispensations of water at the power plant. The first is a chlorinated, high quality feed-water 28 for de-chlorination and feed 29 to the plant demineralization system 38. The second is a chlorinated, good quality, raw plant service feed-water 72 for wash down and general utility use. The third is chlorinated make-up water 20 and 21 for the cooling tower 60. The fourth is a chlorinated, good quality, raw feed-water 71 for a power plant fire protection water system 68. The fifth is a chlorinated, high quality feed-water 24 for a plant potable water system 26.

In this embodiment a single storage tank 66 provides storage for two of the five dispensations of water at the plant; the plant service water 72 and the fire protection system feed-water 71.

The invention relates to the water cycle process of the plant. The reader is directed toward the heavy solid lines with broken arrows of FIG. 6. These lines represent the process and components of the invention. In this embodiment of the invention, good quality, chlorinated water is provided at a source 2 and is pressured in a raw water feed pump 4. A pressured water stream 6 is conveyed as a secondary make-up water 21 to the plant cooling tower 60. A pressured side-stream 8 is extracted from the pressured water stream 6 and is directed to a membrane filtration system 12. Water is conveyed as a side-stream 19 from the pressured water stream 6 to the plant service water and plant fire protection water tank 66. Water from this tank is pressured through a plant service water pump system 70 and conveyed as the plant service water 72 serving the plant 50. Tank 66 also provides the feed-water 71 to the plant fire protection water system 68.

The membrane filtration system 12 receives the side-stream 8 at a high rate of flow. The side-stream 8 is conducted across membrane surfaces of the membrane filtration system 12 in a high velocity, cross-flow mode to secure cleansing of the membrane filtration system 12. The side-stream 8 is applied in a single pass manner, affording it as a good quality reject water 16 profiting the power plant as a chlorinated, good quality, primary make-up water 20 to the cooling tower 60. The cooling tower 60 is also delivered the chlorinated, good quality secondary make-up water 21 which is provided from the raw water stream 6 as is needed to supplement the primary make-up water 20.

A high quality permeate stream 22 exits the membrane filtration system 12 as a very high quality, chlorinated water product. Permeate stream 22 provides service as the feed-water 24 to the potable water system 26. The membrane filtration system 12 does not remove chlorine. Accordingly, the demineralization feed stream 28, which remains after the potable water system feed-water 24 extraction, must be treated to remove residual chlorine. A de-chlorinating chemical, such as sodium bisulfite 142, is dispensed by means of a chemical dosing pump system 144 into the demineralization system feed-water 28 to eliminate residual chlorine in this water before use as the de-chlorinated, high quality feed-water 29 to the demineralization system 38 at the plant.

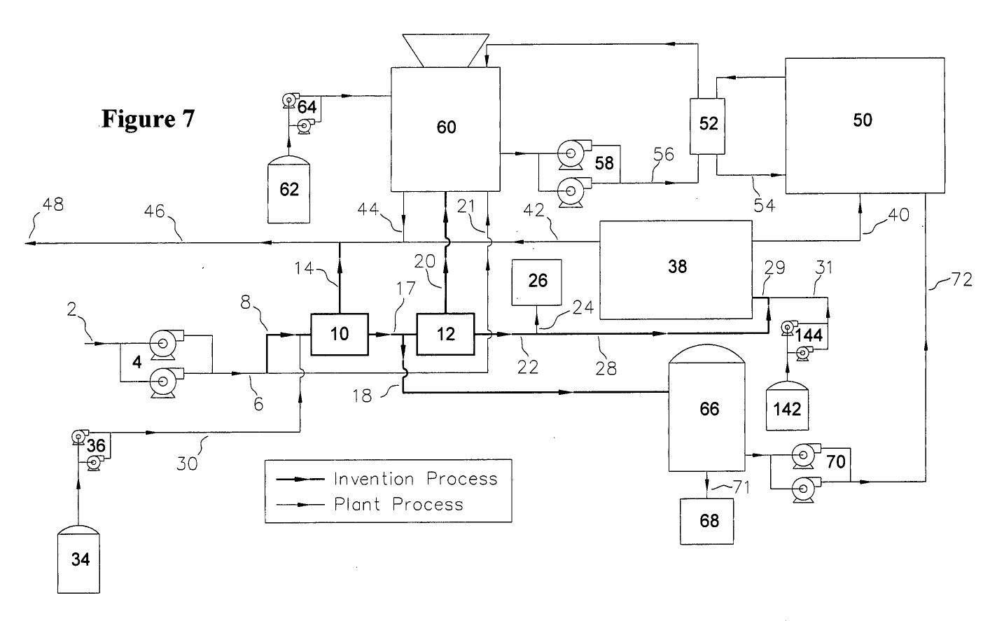

Description: FIG. 7

Direct to obtaining the effect of the invention, FIG. 7 illustrates an embodiment of the invention at a typical thermal power plant. This embodiment of the invention receives a pressured raw water stream and provides; chlorinated mechanical filtrate for plant service water and for plant fire protection system water, chlorinated membrane reject water for primary cooling tower make-up water; un-chlorinated raw water for secondary cooling tower make-up water, chlorinated membrane permeate for potable water system feed-water and de-chlorinated membrane permeate for demineralization system feed-water.

The line legend on FIG. 7 delineates the process flow and relevant system components of the invention with solid heavy lines with broken arrows and the thermal power plant process flow and relevant system components in solid thin lines. The reader should note; power plants typically configure pumps in a duplex format so as to facilitate reliability. This practice is presented in this figure. In deference to reducing reiteration, the reference in this document to a pump or pumping system should be assumed by the reader as indicative of a duplex configuration, unless otherwise stated.

The figure presents a generalized water cycle of a thermal power plant. The power plant is cooled by a cooling tower 60. A circulating cooling water stream 56 is pressured and driven by a circulating water pump 58. The circulating cooling water stream 56 provides cooling to a heated gas or fluid 54 originating from a power house 50. The cooling is facilitated by a circulating water contacted heat exchanger 52. The water chemistry of the circulating water 56 from the cooling tower 60 is maintained in three fashions; first by a consortium of chemicals 62 dispensed via a dosage controlled chemical pumping system 64, second, by discharge of cooling tower 60 water by means of a blow-down stream 44 to waste and third, by a fresh feed-water make-up 20 and 21. A demineralization system 38 provides demineralized water 40 to the power house 50 for various applications. A demineralization system reject wastewater stream 42 is combined with the cooling tower blow-down 44 and conveyed with a plant wastewater stream 46 for elimination at a plant discharge site 48.

There are five main dispensations of water at the power plant. The first is a chlorinated, high quality feed-water 28 for de-chlorination and feed 29 to the plant demineralization system 38. The second is a chlorinated, good quality plant service water 72 for wash down and general utility use. The third is partially chlorinated make-up water 20 and 21 for the cooling tower 60. The fourth is a chlorinated, good quality feed-water 71 for a power plant fire protection system 68. The fifth is a chlorinated, high quality feed-water 24 for a plant potable water system 26.

In this embodiment a single storage tank 66 provides storage for two of the five dispensations of water at the plant; the plant service water 72 and the fire protection system feed-water 71.

The invention relates to the water cycle process of the plant. The reader is directed toward the heavy solid lines with broken arrows of FIG. 7. These lines represent the process and components of the invention. In this embodiment of the invention, raw water is supplied to the invention from a source 2 after being pressured in a raw water feed pump 4. A pressured raw water stream 6 is conveyed as a secondary make-up water 21 to the plant cooling tower 60. A pressured side-stream 8 is extracted from the pressured raw water stream 6 and supplies the invention. Prior to entering the mechanical filtration system 10 of the invention a chlorinating chemical 34 is dispensed into stream 8 by means of a chemical dosing pump system 36 and a conveyance 30. Side stream 8 conveys this chlorinated water to the mechanical filtration system 10. Suspended solids are mechanically extracted from the water and a chlorinated, good quality filtrate 17 is conveyed in two directions; the preponderance of the filtrate 17 is directed into a membrane filtration system 12, while the remainder of the filtrate 17 is discharged as a side-stream 18. Solids collected by the mechanical filtration system 10, are discharged as a waste stream 14 to the plant wastewater stream 46 for disposal at the plant discharge site 48. The side-stream 18 supplies chlorinated good quality, mechanical filtrate to the plant service water and fire protection water storage tank 66. Water from this tank is pressured through a plant service water pump system 70 and conveyed as plant service water 72 serving the plant 50. The plant fire protection system 68 is provided feed-water 71 from tank 66.

The membrane filtration system 12 receives the filtrate stream 17 at a high rate of flow. The filtrate stream 17 is conducted across membrane surfaces of the membrane filtration system 12 in a high velocity, cross-flow mode to secure cleansing of the membrane filtration system 12. The filtrate 17 is applied in a single pass manner, affording it as a high quality reject water 16 profiting the power plant as a good quality, mechanically filtered, primary make-up water 20 to the cooling tower 60. The cooling tower 60 is also delivered the secondary make-up water 21 which is provided from the raw water stream 6 as is needed to supplement the primary make-up water 20.

A high quality permeate stream 22 exits the membrane filtration system 12 as a very high quality, chlorinated water product. This permeate stream 22 provides service as the feed-water 24 to the potable water system 26. The membrane filtration system does not remove chlorine. Accordingly, the demineralization feed stream 28, which remains after the potable water system feed-water 24 extraction, must be treated to remove residual chlorine. A de-chlorinating chemical, such as sodium bisulfite 142, is dispensed, by means of a chemical dosing pump system 144 into the demineralization system feed-water 28 to eliminate residual chlorine in this water before use as the de-chlorinated, high quality feed-water 29 to the demineralization system 38 at the plant.

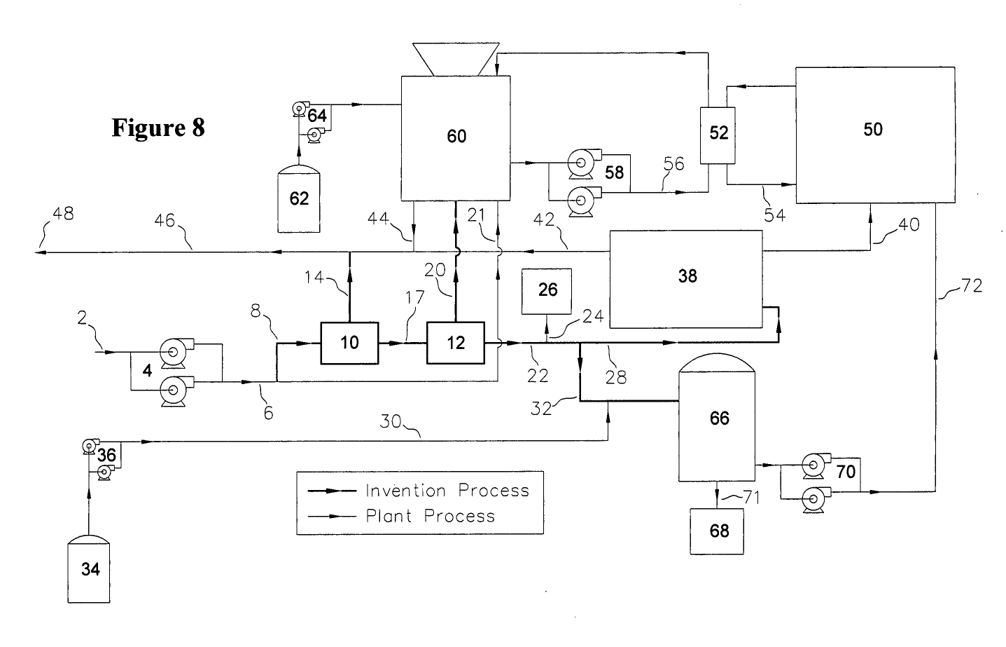

Description: FIG. 8

Direct to obtaining the effect of the invention, FIG. 8 illustrates an embodiment of the invention at a typical thermal power plant. This embodiment of the invention receives a pressured raw water stream and provides; chlorinated membrane permeate for plant service water and for plant fire protection system water, un-chlorinated membrane reject water for primary cooling tower make-up water; un-chlorinated raw water for secondary cooling tower make-up water, un-chlorinated membrane permeate for potable water system feed-water and demineralization system feed-water.

The line legend on FIG. 8 delineates the process flow and relevant system components of the invention with solid heavy lines with broken arrows and the thermal power plant process flow and relevant system components in solid thin lines. The reader should note; power plants typically configure pumps in a duplex format so as to facilitate reliability. This practice is presented in this figure. In deference to reducing reiteration, the reference in this document to a pump or pumping system should be assumed by the reader as indicative of a duplex configuration, unless otherwise stated.

The figure presents a generalized water cycle of a thermal power plant. The power plant is cooled by a cooling tower 60. A circulating cooling water stream 56 is pressured and driven by a circulating water pump 58. The circulating cooling water stream 56 provides cooling to a heated gas or fluid 54 originating from a power house 50. The cooling is facilitated by a circulating water contacted heat exchanger 52. The water chemistry of the circulating water 56 from the cooling tower 60 is maintained in three fashions; first by a consortium of chemicals 62 dispensed via a dosage controlled chemical pumping system 64, second, by discharge of cooling tower 60 water by means of a blow-down stream 44 to waste and third, by a fresh feed-water make-up 20 and 21. A demineralization system 38 provides demineralized water 40 to the power house 50 for various applications. A demineralization system reject wastewater stream 42 is combined with the cooling tower blow-down 44 and conveyed as a plant wastewater stream 46 for elimination at a plant discharge site 48.

There are five main dispensations of water at the power plant. The first is a high quality feed-water 28 for the plant demineralization system 38. The second is a chlorinated, high quality plant service water 72 for wash down and general utility use. The third is the make-up water 20 and 21 for the cooling tower 60. The fourth is a chlorinated, high quality, feed-water 71 for a power plant fire protection system 68. The fifth is a high quality feed-water 24 for a plant potable water system 26.

In this embodiment a single storage tank 66 provides two of the five dispensations of water at the plant; the plant service water 72 and the fire protection system feed-water 71.

The invention relates to the water cycle process of the plant. The reader is directed toward the heavy solid lines with broken arrows of FIG. 8. These lines represent the process and components of the invention. In this embodiment of the invention, raw water is supplied to the invention from a source 2 after being pressured in a raw water feed pump 4. A pressured raw water stream 6 is conveyed as a secondary make-up water 21 to the plant cooling tower 60. A pressured side-stream 8 is extracted from the pressured raw water stream 6 and supplies the invention. Side-stream 8 conveys water to a mechanical filtration system 10. Suspended solids are mechanically extracted from this water and a good quality filtrate 17 is directed into a membrane filtration system 12. Solids collected by the mechanical filtration system 10 are discharged as a waste stream 14 to the plant wastewater stream 46 for disposal at the plant discharge site 48.

The membrane filtration system 12 receives the filtrate stream 17 at a high rate of flow. The filtrate stream 17 is conducted across membrane surfaces of the membrane filtration system 12 in a high velocity, cross-flow mode to secure cleansing of the membrane filtration system 12. The filtrate 17 is applied in a single pass manner, affording it as a high quality reject water 16 profiting the power plant as a good quality, mechanically filtered primary make-up water 20 to the cooling tower 60. The cooling tower 60 is also delivered a secondary make-up water 21 which is provided from the raw water stream 6 as is needed to supplement the primary make-up water 20.

A high quality permeate stream 22 exits the membrane filtration system 12 as a very high quality, sterile, chlorine free product. Permeate stream 22 provides service as the feed-water 24 to the potable water system 26, feed-water, after chlorination, to the plant service water and fire protection water storage tank 66 and as the feed-water 28 to the demineralization system 38 at the plant.

The plant service water system 72 and the plant fire protection water system 68, are provided by a permeate side-stream 32 from the permeate stream 28. A chlorinating chemical 34, is dispensed via a chemical dispensing pump system 36 and a conveyance 30 into the side-stream 32 thereby providing chlorinated feed-water to the plant service water and plant fire protection water storage tank 66. Water from this tank is pressured through a plant service water pump system 70 and conveyed as the plant service water 72 serving the plant 50. The plant fire protection system 68 is provided the feed-water 71 from the tank 66.

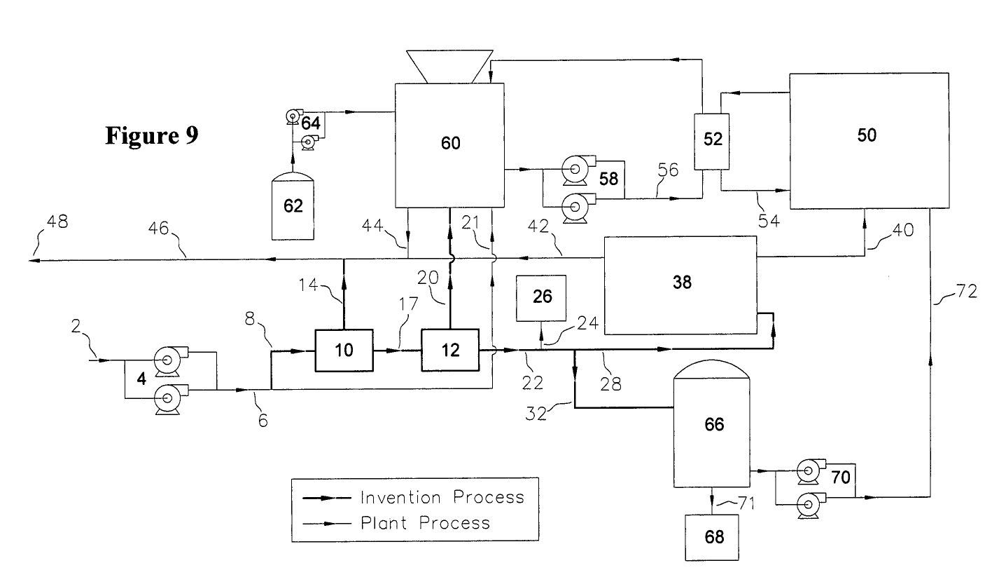

Description: FIG. 9

Direct to obtaining the effect of the invention, FIG. 9 illustrates an embodiment of the invention at a typical thermal power plant. This embodiment of the invention receives a pressured raw water stream and provides; un-chlorinated membrane permeate for plant service water and for plant fire protection system water, un-chlorinated membrane reject water for primary cooling tower make-up water; raw water for secondary cooling tower make-up water, un-chlorinated membrane permeate for potable water system feed-water and un-chlorinated membrane permeate for demineralization system feed-water.

The line legend on FIG. 9 delineates the process flow and relevant system components of the invention with solid heavy lines with broken arrows and the thermal power plant process flow and relevant system components in solid thin lines. The reader should note; power plants typically configure pumps in a duplex format so as to facilitate reliability. This practice is presented in this figure. In deference to reducing reiteration, the reference in this document to a pump or pumping system should be assumed by the reader as indicative of a duplex configuration, unless otherwise stated.

The figure presents a generalized water cycle of a thermal power plant. The power plant is cooled by a cooling tower 60. A circulating cooling water stream 56 is pressured and driven by a circulating water pump 58. The circulating cooling water stream 56 provides cooling to a heated gas or fluid 54 originating from a power house 50. The cooling is facilitated by a circulating water contacted heat exchanger 52. The water chemistry of the circulating water 56 from the cooling tower 60 is maintained in three fashions; first by a consortium of chemicals 62 dispensed via a dosage controlled chemical pumping system 64, second, by discharge of cooling tower 60 water by means of a blow-down stream 44 to waste and third, by a fresh feed-water make-up 20 and 21. A demineralization system 38 provides demineralized water 40 to the power house 50 for various applications. A demineralization system reject wastewater stream 42 is combined with the cooling tower blow-down 44 and conveyed as a plant wastewater stream 46 for elimination at a plant discharge site 48.

There are five main dispensations of water at the power plant. The first is a high quality feed-water 28 for the plant demineralization system 38. The second is a high quality plant service water 72 for wash down and general utility use. The third is the make-up water 20 and 21 for the cooling tower 60. The fourth is a high quality feed-water 71 for a power plant fire protection system 68. The fifth is a high quality feed-water 24 for a plant potable water system 26.

In this embodiment a single storage tank 66 provides two of the five dispensations of water at the plant; the plant service water 72 and the fire protection system feed-water 71.

The invention relates to the water cycle process of the plant. The reader is directed toward the heavy solid lines with broken arrows of FIG. 9. These lines represent the process and components of the invention. In this embodiment of the invention, raw water is supplied to the invention from a source 2 after being pressured in a raw water feed pump 4. A pressured raw water stream 6 is conveyed as a secondary make-up water 21 to the plant cooling tower 60. A pressured side-stream 8 is extracted from the pressured raw water stream 6 and supplies the invention. Side stream 8 conveys water to a mechanical filtration system 10. Suspended solids are mechanically extracted from this water and a good quality filtrate 17 is directed into a membrane filtration system 12. Solids collected by the mechanical filtration system 10, are discharged as a waste stream 14 to the plant waste water stream 46 for disposal at the plant discharge site 48.

The membrane filtration system 12 receives the filtrate stream 17 at a high rate of flow. The filtrate stream 17 is conducted across membrane surfaces of the membrane filtration system 12 in a high velocity, cross-flow mode to secure cleansing of the membrane filtration system 12. The filtrate 17 is applied in a single pass manner, affording it as a high quality reject water 16 profiting the power plant as a good quality primary make-up water 20 to the cooling tower 60. The cooling tower 60 is also delivered the secondary make-up water 21 which is provided from the water stream 6 as is needed to supplement the primary make-up water 20.

A high quality permeate stream 22 exits the membrane filtration system 12 as a very high quality, sterile, chlorine free product. Permeate stream 22 provides service as the feed-water 28 to the demineralization system 38 at the plant, and via a side-stream 32, provides feed-water to the plant service water and fire protection water storage tank 66. Water from this tank is pressured and through a plant service water pump system 70 and conveyed as the plant service water 72 serving the plant 50. This tank also provides the feed-water 71 to the fire protection system 68 serving the plant.

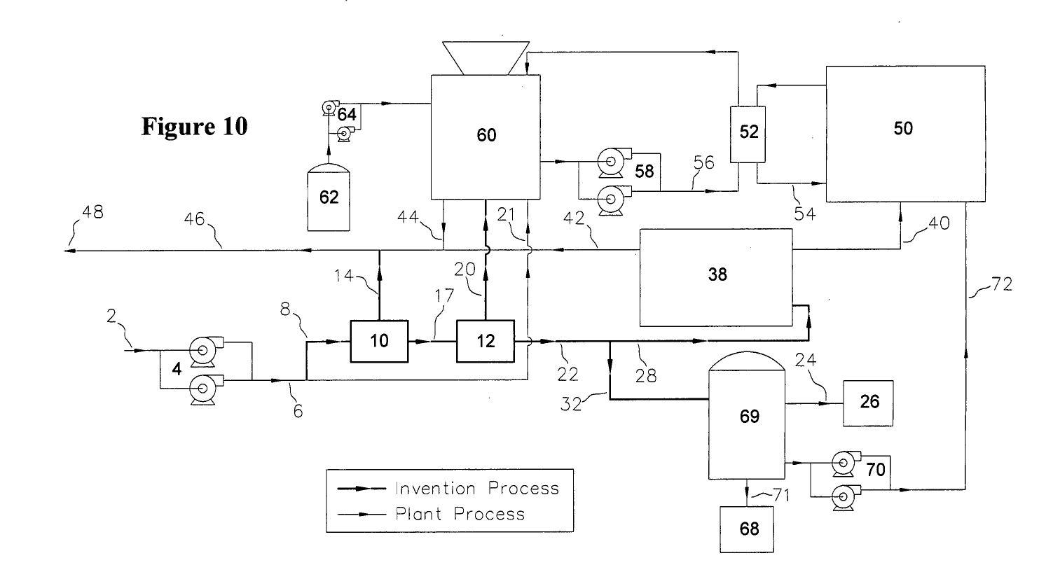

Description: FIG. 10

Direct to obtaining the effect of the invention, FIG. 10 illustrates an embodiment of the invention at a typical thermal power plant. This embodiment of the invention receives a pressured raw water stream and provides; un-chlorinated membrane permeate for plant service water, plant fire protection system water and potable water system feed-water, un-chlorinated membrane reject water for primary cooling tower make-up water; raw water for secondary cooling tower make-up water, un-chlorinated membrane permeate for demineralization system feed-water.

FIG. 10 presents a process diagram of the invention and a typical process diagram of a thermal power plant water cycle. The line legend on FIG. 10 delineates the process flow and relevant system components of the invention with solid heavy lines with broken arrows and the thermal power plant process flow and relevant system components in solid thin lines. The reader should note; power plants typically configure pumps in a duplex format so as to facilitate reliability. This practice is presented in this figure. In deference to reducing reiteration, the reference in this document to a pump or pumping system should be assumed by the reader as indicative of a duplex configuration, unless otherwise stated.

The figure presents a generalized water cycle of a thermal power plant. The power plant is cooled by a cooling tower 60. A circulating cooling water stream 56 is pressured and driven by a circulating water pump 58. The circulating cooling water stream 56 provides cooling to a heated gas or fluid 54 originating from a power house 50. The cooling is facilitated by a circulating water contacted heat exchanger 52. The water chemistry of the circulating water 56 from the cooling tower 60 is maintained in three fashions; first by a consortium of chemicals 62 dispensed via a dosage controlled chemical pumping system 64, second, by discharge of cooling tower 60 water by means of a blow-down stream 44 to waste and third, by a fresh feed-water make-up 20 and 21. A demineralization system 38 provides demineralized water 40 to the power house 50 for various applications. A demineralization system reject wastewater stream 42 is combined with the cooling tower blow-down 44 and conveyed as a plant wastewater stream 46 for elimination at a plant discharge site 48.

There are five main dispensations of water at the power plant. The first is a high quality feed-water 28 for the plant demineralization system 38. The second is a high quality plant service water 72 for wash down and general utility use. The third is the make-up water 20 and 21 for the cooling tower 60. The fourth is a high quality feed-water 71 for a power plant fire protection system 68. The fifth is a high quality feed-water 24 for a plant potable water system 26.

In this embodiment a single storage tank 69 provides three of the five dispensations of water at the plant; the plant service water 72, the fire protection system feed-water 71 and the potable water system feed-water 24.

The invention relates to the water cycle process of the plant. The reader is directed toward the heavy solid lines with broken arrows of FIG. 10. These lines represent the process and components of the invention. In this embodiment of the invention, raw water is supplied to the invention from a source 2 after being pressured in a raw water feed pump 4. A pressured raw water stream 6 is conveyed as a secondary make-up water 21 to the plant cooling tower 60. A pressured side-stream 8 is extracted from the pressured raw water stream 6 and supplies the invention. Side-stream 8 conveys water to a mechanical filtration system 10. Suspended solids are mechanically extracted from this water and a good quality filtrate 17 is directed into a membrane filtration system 12. Solids collected by the mechanical filtration system 10 are discharged as a waste stream 14 to the plant wastewater stream 46 for disposal at the plant discharge site 48.

The membrane filtration system 12 receives the filtrate stream 17 at a high rate of flow. The filtrate stream 17 is conducted across membrane surfaces of the membrane filtration system 12 in a high velocity, cross-flow mode to secure cleansing of the membrane filtration system 12. The filtrate 17 is applied in a single pass manner, affording it as a good quality reject water 16 profiting the power plant as a good quality primary make-up water 20 to the cooling tower 60. The cooling tower 60 is also delivered the secondary make-up water 21 which is provided from the water stream 6 as is needed to supplement the primary make-up water 20.

A high quality permeate stream 22 exits the membrane filtration system 12 as a very high quality, sterile, chlorine free product. Permeate stream 22 provides the feed-stream 28 to the demineralization system 38 at the plant. A side-stream 32 is extracted from the permeate stream 22. Side-stream 32 provides a chlorine free, high quality membrane permeate as feed-water to the plant service water, fire protection water and potable water system storage tank 69 at the plant. The plant service water 72 from tank 69 is pressured by the plant service water pump system 70 to service the power plant 50. The fire protection system feed-water 71 is directed from the storage tank 69 to the fire protection system 68. The potable water system feed-water 24 exits the storage tank 69 for use by the potable water system 26.

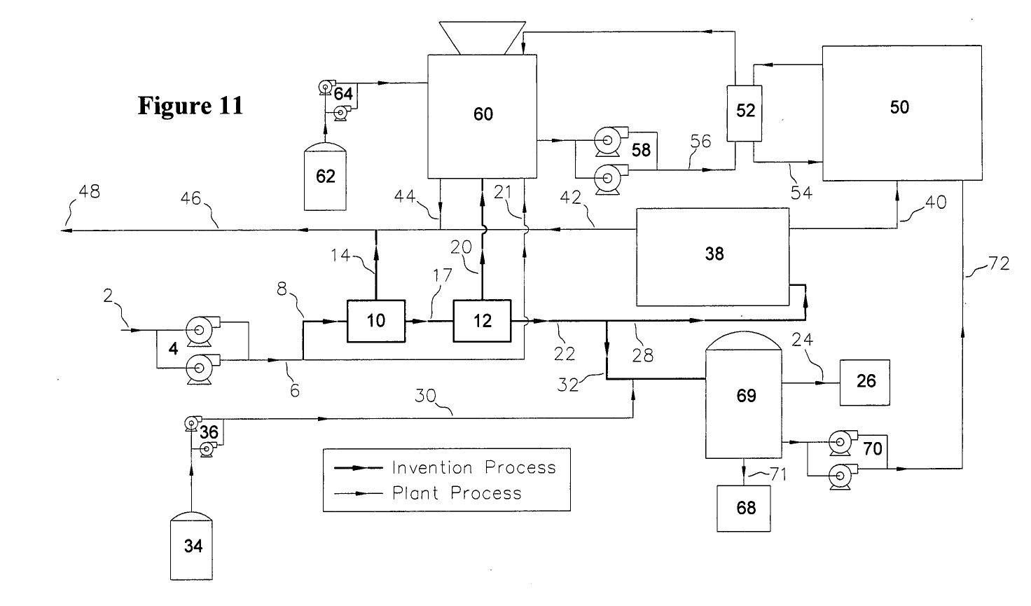

Description: FIG. 11

Direct to obtaining the effect of the invention, FIG. 11 illustrates an embodiment of the invention at a typical thermal power plant. This embodiment of the invention receives a pressured raw water stream and provides; chlorinated membrane permeate for plant service water, plant fire protection system water and potable water system feed-water, un-chlorinated membrane reject water for primary cooling tower make-up water; raw water for secondary cooling tower make-up water, un-chlorinated membrane permeate for demineralization system feed-water.

FIG. 11 presents a process diagram of the invention and a typical process diagram of a thermal power plant water cycle. The line legend on FIG. 11 delineates the process flow and relevant system components of the invention with solid heavy lines with broken arrows and the thermal power plant process flow and relevant system components in solid thin lines. The reader should note; power plants typically configure pumps in a duplex format so as to facilitate reliability. This practice is presented in this figure. In deference to reducing reiteration, the reference in this document to a pump or pumping system should be assumed by the reader as indicative of a duplex configuration, unless otherwise stated.

The figure presents a generalized water cycle of a thermal power plant. The power plant is cooled by a cooling tower 60. A circulating cooling water stream 56 is pressured and driven by a circulating water pump 58. The circulating cooling water stream 56 provides cooling to a heated gas or fluid 54 originating from a power house 50. The cooling is facilitated by a circulating water contacted heat exchanger 52. The water chemistry of the circulating water 56 from the cooling tower 60 is maintained in three fashions; first by a consortium of chemicals 62 dispensed via a dosage controlled chemical pumping system 64, second, by discharge of cooling tower 60 water by means of a blow-down stream 44 to waste and third, by a fresh feed-water make-up 20 and 21. A demineralization system 38 provides demineralized water 40 to the power house 50 for various applications. A demineralization system reject wastewater stream 42 is combined with the cooling tower blow-down 44 and conveyed as a plant wastewater stream 46 for elimination at a plant discharge site 48.

There are five main dispensations of water at the power plant. The first is a high quality feed-water 28 for the plant demineralization system 38. The second is a chlorinated, high quality plant service water 72 for wash down and general utility use. The third is the make-up water 20 and 21 for the cooling tower 60. The fourth is a chlorinated, high quality feed-water 71 for a power plant fire protection system 68. The fifth is a chlorinated, high quality feed-water 24 for a plant potable water system 26.

In this embodiment a single storage tank 69 provides three of the five dispensations of water at the plant; the plant service water 72, the fire protection system feed-water 71 and the potable water system feed-water 24.

The invention relates to the water cycle process of the plant. The reader is directed toward the heavy solid lines with broken arrows of FIG. 11. These lines represent the process and components of the invention. In this embodiment of the invention, raw water is supplied to the invention from a source 2 after being pressured in a raw water feed pump 4. A pressured raw water stream 6 is conveyed as a secondary make-up water 21 to the plant cooling tower 60. A pressured side-stream 8 is extracted from the pressured raw water stream 6 and supplies the invention. Side-stream 8 conveys water to a mechanical filtration system 10. Suspended solids are mechanically extracted from this water and a good quality filtrate 17 is directed into a membrane filtration system 12. Solids collected by the mechanical filtration system 10, are discharged as a waste stream 14 to the plant wastewater stream 46 for disposal at a plant discharge site 48.

The membrane filtration system 12 receives the filtrate stream 17 at a high rate of flow. The filtrate stream 17 is conducted across membrane surfaces of the membrane filtration system 12 in a high velocity, cross-flow mode to secure cleansing of the membrane filtration system 12. The filtrate 17 is applied in a single pass manner, affording it as a good quality reject water 16 profiting the power plant as a good quality primary make-up water 20 to the cooling tower 60. The cooling tower 60 also is delivered the secondary make-up water 21 which is provided from the water stream 6 as is needed to supplement the primary make-up water 20.

A high quality permeate stream 22 exits the membrane filtration system 12 as a very high quality, sterile, chlorine free product. Permeate stream 22 provides the feed-stream 28 to the demineralization system 38 at the plant. A side-stream 32 is extracted from the permeate stream 22. Side-stream 32 is chlorine free, high quality membrane permeate. A chlorinating chemical 34 is dispensed via a dosing chemical pump system 36 and a conveyance 30 into the permeate stream 32. This chlorinated high quality permeate is conveyed as feed-water to the plant service water, fire protection water and potable water system storage tank 69 at the plant. Chlorinated, high quality water from this tank is pressured by a plant service water pump system 70 to provide the plant service water 72 for the power plant 50. Chlorinated fire protection system feed-water 71 is conveyed from the storage tank 69 to the plant fire protection system 68. The potable water system feed-water 24 exits the storage tank 69 for use by the potable water system 26.

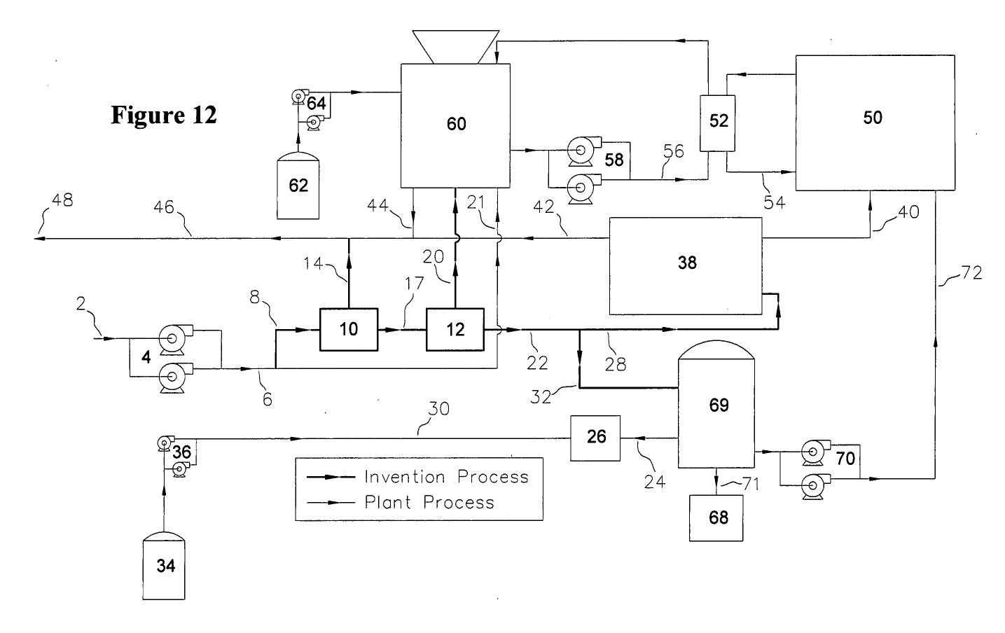

Description: FIG. 12

Direct to obtaining the effect of the invention, FIG. 12 illustrates an embodiment of the invention at a typical thermal power plant. This embodiment of the invention receives a pressured raw water stream and provides; un-chlorinated membrane permeate for plant service water and plant fire protection system water, chlorinated membrane permeate for potable water system feed-water, un-chlorinated membrane reject water for primary cooling tower make-up water; raw water for secondary cooling tower make-up water, un-chlorinated membrane permeate for demineralization system feed-water.

FIG. 12 presents a process diagram of the invention and a typical process diagram of a thermal power plant water cycle. The line legend on FIG. 12 delineates the process flow and relevant system components of the invention with solid heavy lines with broken arrows and the thermal power plant process flow and relevant system components in solid thin lines. The reader should note; power plants typically configure pumps in a duplex format so as to facilitate reliability. This practice is presented in this figure. In deference to reducing reiteration, the reference in this document to a pump or pumping system should be assumed by the reader as indicative of a duplex configuration, unless otherwise stated.

The figure presents a generalized water cycle of a thermal power plant. The power plant is cooled by a cooling tower 60. A circulating cooling water stream 56 is pressured and driven by a circulating water pump 58. The circulating cooling water stream 56 provides cooling to a heated gas or fluid 54 originating from a power house 50. The cooling is facilitated by a circulating water contacted heat exchanger 52. The water chemistry of the circulating water 56 from the cooling tower 60 is maintained in three fashions; first by a consortium of chemicals 62 dispensed via a dosage controlled chemical pumping system 64, second, by discharge of cooling tower 60 water by means of a blow-down stream 44 to waste and third, by a fresh feed-water make-up 20 and 21. A demineralization system 38 provides demineralized water 40 to the power house 50 for various applications. A demineralization system reject wastewater stream 42 is combined with the cooling tower blow-down 44 and conveyed as a plant wastewater stream 46 for elimination at a plant discharge site 48.

There are five main dispensations of water at the power plant. The first is a high quality feed-water 28 for the plant demineralization system 38. The second is a high quality plant service water 72 for wash down and general utility use. The third is the make-up water 20 and 21 for the cooling tower 60. The fourth is a high quality feed-water 71 for a power plant fire protection system 68. The fifth is a chlorinated, high quality feed-water 24 for a plant potable water system 26.

In this embodiment a single storage tank 69 provides three of the five dispensations of water at the plant; the plant service water 72, the fire protection system feed-water 71 and the potable water system feed-water 24.

The invention relates to the water cycle process of the plant. The reader is directed toward the heavy solid lines with broken arrows of FIG. 12. These lines represent the process and components of the invention. In this embodiment of the invention, raw water is supplied to the invention from a source 2 after being pressured in a raw water feed pump 4. A pressured raw water stream 6 is conveyed as a secondary make-up water 21 to the plant cooling tower 60. A pressured side-stream 8 is extracted from the pressured raw water stream 6 and supplies the invention. Side-stream 8 conveys water to a mechanical filtration system 10. Suspended solids are mechanically extracted from this water and a good quality filtrate 17 is directed into a membrane filtration system 12. Solids collected by the mechanical filtration system 10, are discharged as a waste stream 14 to the plant wastewater stream 46 for disposal at a plant discharge site 48.

The membrane filtration system 12 receives the filtrate stream 17 at a high rate of flow. The filtrate stream 17 is conducted across membrane surfaces of the membrane filtration system 12 in a high velocity, cross-flow mode to secure cleansing of the membrane filtration system 12. The filtrate 17 is applied in a single pass manner, affording it as a good quality reject water 16 profiting the power plant as a good quality primary make-up water 20 to the cooling tower 60. The cooling tower 60 is also delivered the secondary make-up water 21 which is provided from the water stream 6 as is needed to supplement the primary make-up water 20.

A high quality permeate stream 22 exits the membrane filtration system 12 as a very high quality, sterile, chlorine free product. Permeate stream 22 provides the feed-stream 28 to the demineralization system 38 at the plant. A side-stream 32 is extracted from the permeate stream 22. Side-stream 32 provides a chlorine free, high quality membrane permeate as feed-water to the plant service water, fire protection water and potable water system feed-water storage tank 69 at the plant. The plant service water 72 is pressured by a plant service water pump system 70 to service the power plant 50. Fire protection system fee-water 71 is directed from the storage tank 69 to the fire protection system 68. The potable water system feed-water stream 24 exits the storage tank 69 for use by the potable water system 26. Pursuant to plant specifications a chlorinating chemical 34 is dispensed via a dosing chemical pump system 36 and a conveyance 30 into the potable water treatment system 26.

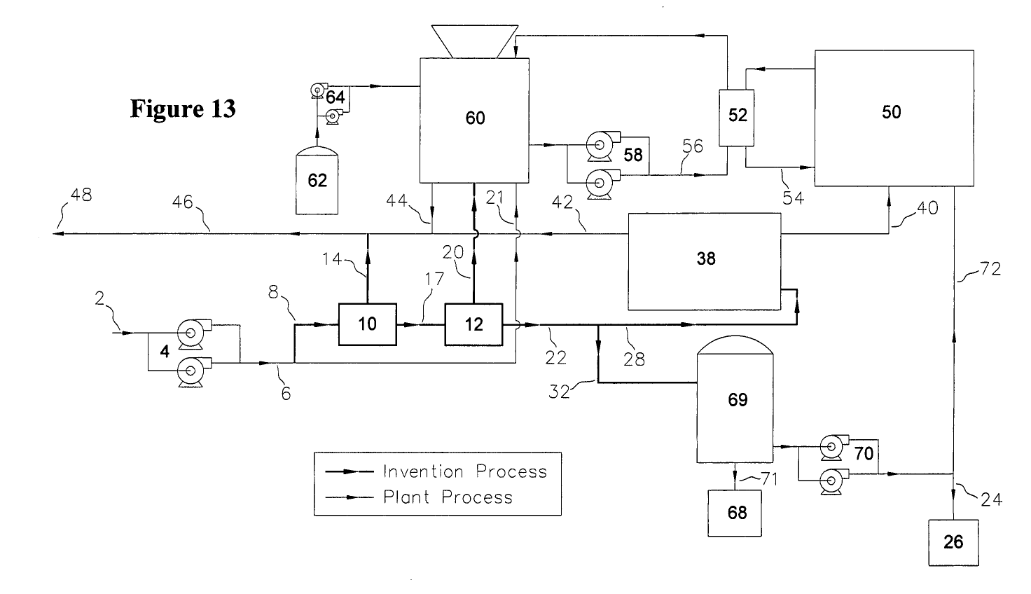

Description: FIG. 13

Direct to obtaining the effect of the invention, FIG. 13 illustrates an embodiment of the invention at a typical thermal power plant. This embodiment of the invention receives a pressured raw water stream and provides; un-chlorinated membrane permeate for plant service water and plant fire protection system water, un-chlorinated, pressured membrane permeate for potable water system feed-water, un-chlorinated membrane reject water for primary cooling tower make-up water; raw water for secondary cooling tower make-up water, un-chlorinated membrane permeate for demineralization system feed-water.

FIG. 13 presents a process diagram of the invention and a typical process diagram of a thermal power plant water cycle. The line legend on FIG. 13 delineates the process flow and relevant system components of the invention with solid heavy lines with broken arrows and the thermal power plant process flow and relevant system components in solid thin lines. The reader should note; power plants typically configure pumps in a duplex format so as to facilitate reliability. This practice is presented in this figure. In deference to reducing reiteration, the reference in this document to a pump or pumping system should be assumed by the reader as indicative of a duplex configuration, unless otherwise stated.

The figure presents a generalized water cycle of a thermal power plant. The power plant is cooled by a cooling tower 60. A circulating cooling water stream 56 is pressured and driven by a circulating water pump 58. The circulating cooling water stream 56 provides cooling to a heated gas or fluid 54 originating from a power house 50. The cooling is facilitated by a circulating water contacted heat exchanger 52. The water chemistry of the circulating water 56 from the cooling tower 60 is maintained in three fashions; first by a consortium of chemicals 62 dispensed via a dosage controlled chemical pumping system 64, second, by discharge of cooling tower 60 water by means of a blow-down stream 44 to waste and third, by a fresh feed-water make-up 20 and 21. A demineralization system 38 provides demineralized water 40 to the power house 50 for various applications. A demineralization system reject wastewater stream 42 is combined with the cooling tower blow-down 44 and conveyed as a plant wastewater stream 46 for elimination at a plant discharge site 48.

There are five main dispensations of water at the power plant. The first is a high quality feed-water 28 for the plant demineralization system 38. The second is a high quality plant service water 72 for wash down and general utility use. The third is the make-up water 20 and 21 for the cooling tower 60. The fourth is a high quality feed-water 71 for a power plant fire protection system 68. The fifth is a high quality, pressured feed-water 24 for a plant potable water system 26.

In this embodiment a single storage tank 69 provides two direct and one indirect dispensations of the five dispensations of water at the plant. The storage tank 69 provides the direct dispensation of the plant service water 72 and the fire protection system feed-water 71. The potable water feed-water stream 24 is indirectly dispensed from the storage tank 69 inasmuch as it is a side-stream from the plant service water stream 72 which is itself dispensed by the storage tank 69.

The invention relates to the water cycle process of the plant. The reader is directed toward the heavy solid lines with broken arrows of FIG. 13. These lines represent the process and components of the invention. In this embodiment of the invention, raw water is supplied to the invention from a source 2 after being pressured in a raw water feed pump 4. A pressured raw water stream 6 is conveyed as a secondary make-up water 21 to the plant cooling tower 60. A pressured side-stream 8 is extracted from the pressured raw water stream 6 and supplies the invention. Side stream 8 conveys water to a mechanical filtration system 10. Suspended solids are mechanically extracted from this water and a good quality filtrate 17 is directed into a membrane filtration system 12. Solids collected by the mechanical filtration system 10 are discharged as a waste stream 14 to the plant wastewater stream 46 for disposal at the plant discharge site 48.

The membrane filtration system 12 receives the filtrate stream 17 at a high rate of flow. The filtrate stream 17 is conducted across membrane surfaces of the membrane filtration system 12 in a high velocity, cross-flow mode to secure cleansing of the membrane filtration system 12. The filtrate 17 is applied in a single pass manner, affording it as a good quality reject water 16 profiting the power plant as a good quality primary make-up water 20 to the cooling tower 60. The cooling tower 60 is also delivered the secondary make-up water 21 which is provided from the water stream 6 as is needed to supplement the primary make-up water 20.

A high quality permeate stream 22 exits the membrane filtration system 12 as a very high quality, sterile, chlorine free product. Permeate stream 22 provides the feed-stream 28 to the demineralization system 38 at the plant. A side-stream 32 is extracted from the permeate stream 22. Side-stream 32 provides a chlorine free, high quality membrane permeate as feed-water to the plant service water, fire protection water and potable water system storage tank 69 at the plant. Plant service water 72 is pressured by a plant service water pump system 70 to service the power plant 50. A side-stream of pressured plant service water is extracted as the potable water system feed-water 24 and directed to the potable water treatment system 26 of the plant. Fire protection system feed-water 71 is directed from the storage tank 69 to the fire protection system 68.

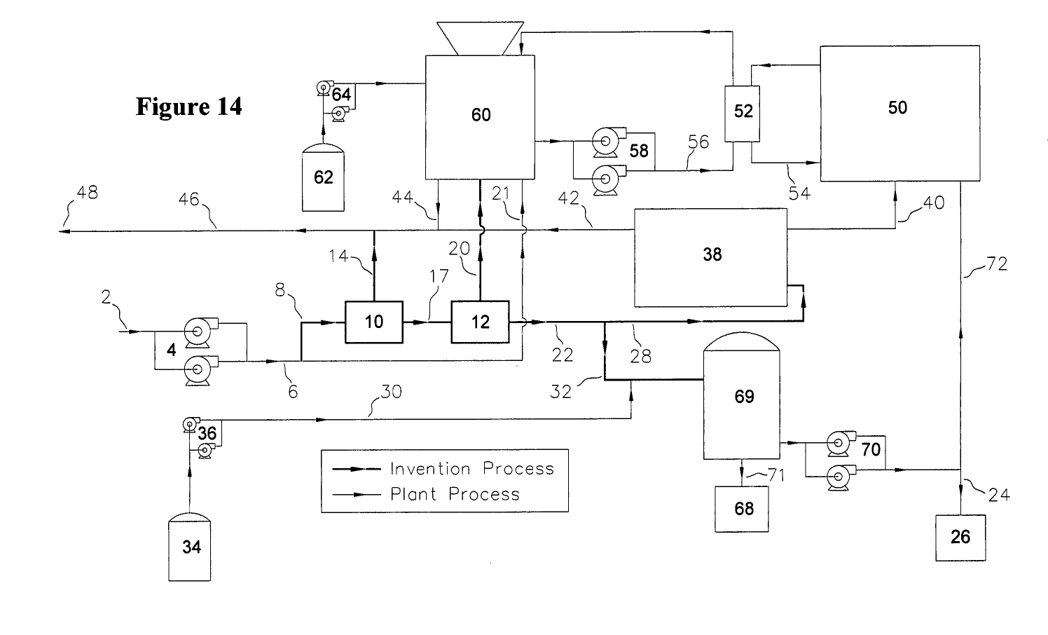

Description: FIG. 14

Direct to obtaining the effect of the invention, FIG. 14 illustrates an embodiment of the invention at a typical thermal power plant. This embodiment of the invention receives a pressured raw water stream and provides; chlorinated membrane permeate for plant service water and plant fire protection system water, chlorinated, pressured membrane permeate for potable water system feed-water, un-chlorinated membrane reject water for primary cooling tower make-up water; raw water for secondary cooling tower make-up water, un-chlorinated membrane permeate for demineralization system feed-water.

FIG. 14 presents a process diagram of the invention and a typical process diagram of a thermal power plant water cycle. The line legend on FIG. 14 delineates the process flow and relevant system components of the invention with solid heavy lines with broken arrows and the thermal power plant process flow and relevant system components in solid thin lines. The reader should note; power plants typically configure pumps in a duplex format so as to facilitate reliability. This practice is presented in this figure. In deference to reducing reiteration, the reference in this document to a pump or pumping system should be assumed by the reader as indicative of a duplex configuration, unless otherwise stated.

The figure presents a generalized water cycle of a thermal power plant. The power plant is cooled by a cooling tower 60. A circulating cooling water stream 56 is pressured and driven by a circulating water pump 58. The circulating cooling water stream 56 provides cooling to a heated gas or fluid 54 originating from a power house 50. The cooling is facilitated by a circulating water contacted heat exchanger 52. The water chemistry of the circulating water 56 from the cooling tower 60 is maintained in three fashions; first by a consortium of chemicals 62 dispensed via a dosage controlled chemical pumping system 64, second, by discharge of cooling tower 60 water by means of a blow-down stream 44 to waste and third, by a fresh feed-water make-up 20 and 21. A demineralization system 38 provides demineralized water 40 to the power house 50 for various applications. A demineralization system reject wastewater stream 42 is combined with the cooling tower blow-down 44 and conveyed as a plant wastewater stream 46 for elimination at a plant discharge site 48.

There are five main dispensations of water at the power plant. The first is a high quality feed-water 28 for the plant demineralization system 38. The second is a chlorinated, high quality plant service water 72 for wash down and general utility use. The third is the make-up water 20 and 21 for the cooling tower 60. The fourth is a chlorinated, high quality feed-water 71 for a power plant fire protection system 68. The fifth is a chlorinated, high quality, pressured feed-water stream 24 for a plant potable water system 26.

In this embodiment a single storage tank 69 provides two direct and one indirect dispensations of the five dispensations of water at the plant. The storage tank 69 provides the direct dispensation of the plant service water 72 and the fire protection system feed-water 71. The potable water feed-water stream 24 is indirectly dispensed from the storage tank 69 inasmuch as it is a side-stream from the plant service water stream 72 which is itself dispensed by the storage tank 69.

The invention relates to the water cycle process of the plant. The reader is directed toward the heavy solid lines with broken arrows of FIG. 14. These lines represent the process and components of the invention. In this embodiment of the invention, raw water is supplied to the invention from a source 2 after being pressured in a raw water feed pump 4. A pressured raw water stream 6 is conveyed as a secondary make-up water 21 to the plant cooling tower 60. A pressured side-stream 8 is extracted from the pressured raw water stream 6 and supplies the invention. Side stream 8 conveys water to a mechanical filtration system 10. Suspended solids are mechanically extracted from this water and a good quality filtrate 17 is directed into a membrane filtration system 12. Solids collected by the mechanical filtration system 10 are discharged as a waste stream 14 to the plant wastewater stream 46 for disposal at the plant discharge site 48.

The membrane filtration system 12 receives the filtrate stream 17 at a high rate of flow. The filtrate stream 17 is conducted across membrane surfaces of the membrane filtration system 12 in a high velocity, cross-flow mode to secure cleansing of the membrane filtration system 12. The filtrate 17 is applied in a single pass manner, affording it as a good quality reject water 16 profiting the power plant as a good quality primary make-up water 20 to the cooling tower 60. The cooling tower 60 is also delivered the secondary make-up water 21 which is provided from the raw water stream 6 as is needed to supplement the primary make-up water 20.

A high quality permeate stream 22 exits the membrane filtration system 12 as a very high quality, sterile, chlorine free product. This permeate stream 22 provides the feed-stream 28 to the demineralization system 38 at the plant. A side-stream 32 is extracted from the permeate stream 22. Side-stream 32 is a chlorine free, high quality membrane permeate. A chlorinating chemical 34 is dispensed via a dosing chemical pump system 36 and a conveyance 30 into the permeate stream 32. The resulting chlorinated high quality permeate is directed as feed to the plant service water, fire protection water and potable water system feed-water storage tank 69 at the plant. Chlorinated plant service water 72 is pressured by a plant service water pump system 70 to service the power plant 50. The feed-water 24 for the potable water system 68 extracts water as a side-stream from the pressured plant service water. Chlorinated fire protection system feed-water 71 is directed from the storage tank 69 to the plant fire protection system 68.

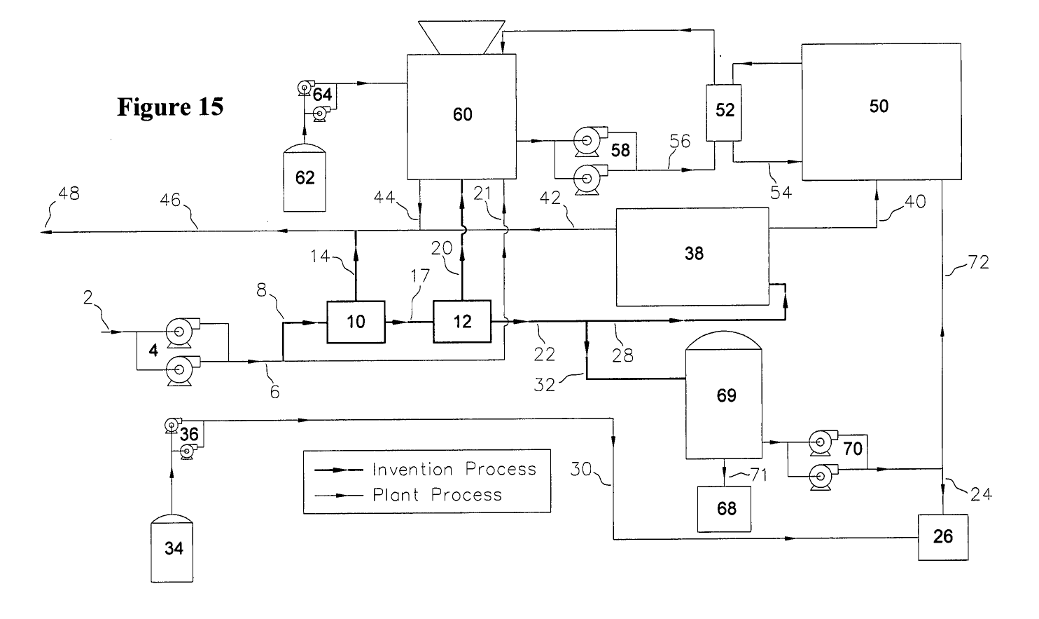

Description: FIG. 15

Direct to obtaining the effect of the invention, FIG. 15 illustrates an embodiment of the invention at a typical thermal power plant. This embodiment of the invention receives a pressured raw water stream and provides; un-chlorinated membrane permeate for plant service water and plant fire protection system water, chlorinated, pressured membrane permeate for potable water system feed-water, un-chlorinated membrane reject water for primary cooling tower make-up water; raw water for secondary cooling tower make-up water, un-chlorinated membrane permeate for demineralization system feed-water.

FIG. 15 presents a process diagram of the invention and a typical process diagram of a thermal power plant water cycle. The line legend on FIG. 15 delineates the process flow and relevant system components of the invention with solid heavy lines with broken arrows and the thermal power plant process flow and relevant system components in solid thin lines. The reader should note; power plants typically configure pumps in a duplex format so as to facilitate reliability. This practice is presented in this figure. In deference to reducing reiteration, the reference in this document to a pump or pumping system should be assumed by the reader as indicative of a duplex configuration, unless otherwise stated.

The figure presents a generalized water cycle of a thermal power plant. The power plant is cooled by a cooling tower 60. A circulating cooling water stream 56 is pressured and driven by a circulating water pump 58. The circulating cooling water stream 56 provides cooling to a heated gas or fluid 54 originating from a power house 50. The cooling is facilitated by a circulating water contacted heat exchanger 52. The water chemistry of the circulating water 56 from the cooling tower 60 is maintained in three fashions; first by a consortium of chemicals 62 dispensed via a dosage controlled chemical pumping system 64, second, by discharge of cooling tower 60 water by means of a blow-down stream 44 to waste and third, by a fresh feed-water make-up 20 and 21. A demineralization system 38 provides demineralized water 40 to the power house 50 for various applications. A demineralization system reject wastewater stream 42 is combined with the cooling tower blow-down 44 and conveyed as a plant wastewater stream 46 for elimination at a plant discharge site 48.

There are five main dispensations of water at the power plant. The first is a high quality feed-water 28 for the plant demineralization system 38. The second is a high quality plant service water 72 for wash down and general utility use. The third is the make-up water 20 and 21 for the cooling tower 60. The fourth is a high quality feed-water 71 for a power plant fire protection system 68. The fifth is a chlorinated, high quality, pressured feed-water 24 for a plant potable water system 26.

In this embodiment a single storage tank 69 provides two direct and one indirect dispensations of water at the plant. The storage tank 69 provides the direct dispensation of the plant service water 72 and the fire protection system feed-water 71. The potable water feed-water stream 24 is indirectly dispensed from the storage tank 69 inasmuch as it is a side-stream from the plant service water stream 72 which is itself dispensed by the storage tank 69.

The invention relates to the water cycle process of the plant. The reader is directed toward the heavy solid lines with broken arrows of FIG. 15. These lines represent the process and components of the invention. In this embodiment of the invention, raw water is supplied to the invention from a source 2 after being pressured in a raw water feed pump 4. A pressured raw water stream 6 is conveyed as a secondary make-up water 21 to the plant cooling tower 60. A pressured side-stream 8 is extracted from the pressured raw water stream 6 and supplies the invention. Water stream 8 conveys water to a mechanical filtration system 10. Suspended solids are mechanically extracted from this water and a good quality filtrate 17 is directed into a membrane filtration system 12. Solids collected by the mechanical filtration system 10, are discharged as a waste stream 14 to the plant wastewater discharge stream 46 for disposal at the plant discharge site 48.

The membrane filtration system 12 receives the filtrate stream 17 at a high rate of flow. The filtrate stream 17 is conducted across membrane surfaces of the membrane filtration system 12 in a high velocity, cross-flow mode to secure cleansing of the membrane filtration system 12. The filtrate 17 is applied in a single pass manner, affording it as a good quality reject water 16 profiting the power plant as a good quality primary make-up water 20 to the cooling tower 60. The cooling tower 60 is also delivered a secondary make-up water 21 which is provided from the raw water stream 6 as is needed to supplement the primary make-up water 20.

A high quality permeate stream 22 exits the membrane filtration system 12 as a very high quality, sterile, chlorine free product. Permeate stream 22 provides the feed-stream 28 to the demineralization system 38 at the plant. A side-stream 32 is extracted from the permeate stream 22. Side-stream 32 provides a chlorine free, high quality membrane permeate as feed to the plant service water, fire protection water and potable water system storage tank 69 at the plant. The plant service water 72 is pressured by a plant service water pump system 70 to feed the power plant 50. The fire protection system feed-water 71 is directed from the storage tank 69 to the fire protection system 68. A side-stream of pressured plant service water is extracted from the pressured plant service water as the feed-water 24 to feed the potable water treatment system 26 of the plant. A chlorinating chemical 34 is dispensed via a chemical dosing pump system 36 and a conveyance 30 to the potable water treating system 26 to facilitate the required chlorination.

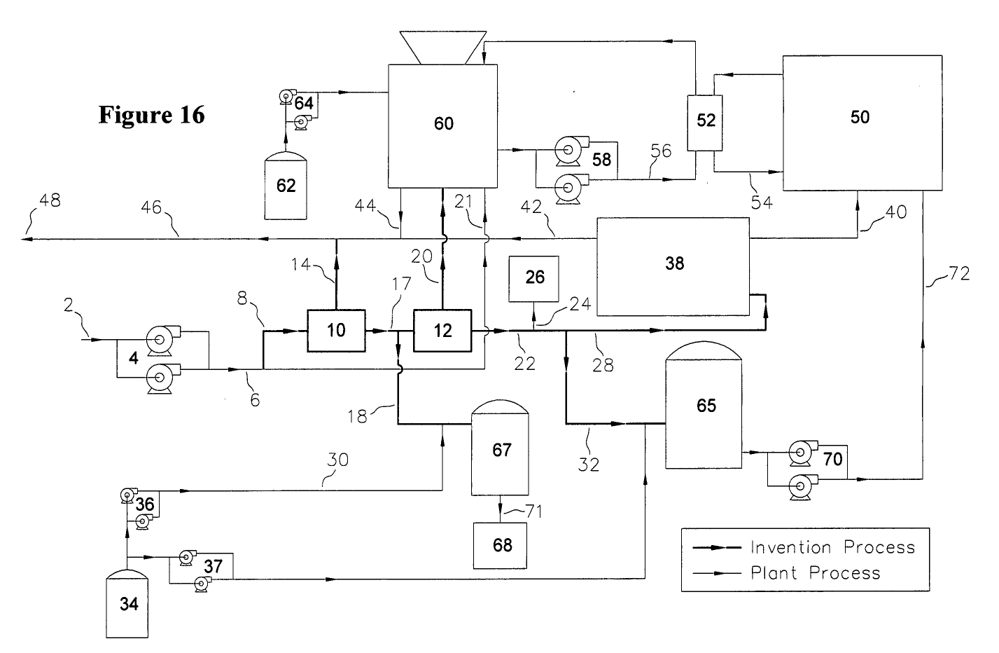

Description: FIG. 16

Direct to obtaining the effect of the invention, FIG. 16 illustrates an embodiment of the invention at a typical thermal power plant. This embodiment of the invention receives a pressured raw water stream and provides; chlorinated mechanical filtrate for plant fire protection system water, chlorinated membrane permeate for plant service water, un-chlorinated membrane reject water for primary cooling tower make-up water; raw water for secondary cooling tower make-up water, un-chlorinated membrane permeate for potable water system feed-water and demineralization system feed-water.

FIG. 16 presents a process diagram of the invention and a typical process diagram of a thermal power plant water cycle. The line legend on FIG. 16 delineates the process flow and relevant system components of the invention with solid heavy lines with broken arrows and the thermal power plant process flow and relevant system components in solid thin lines. The reader should note; power plants typically configure pumps in a duplex format so as to facilitate reliability. This practice is presented in this figure. In deference to reducing reiteration, the reference in this document to a pump or pumping system should be assumed by the reader as indicative of a duplex configuration, unless otherwise stated.

The figure presents a generalized water cycle of a thermal power plant. The power plant is cooled by a cooling tower 60. A circulating cooling water stream 56 is pressured and driven by a circulating water pump 58. The circulating cooling water stream 56 provides cooling to a heated gas or fluid 54 originating from a power house 50. The cooling is facilitated by a circulating water contacted heat exchanger 52. The water chemistry of the circulating water 56 from the cooling tower 60 is maintained in three fashions; first by a consortium of chemicals 62 dispensed via a dosage controlled chemical pumping system 64, second, by discharge of cooling tower 60 water by means of a blow-down stream 44 to waste and third, by a fresh feed-water make-up 20 and 21. A demineralization system 38 provides demineralized water 40 to the power house 50 for various applications. A demineralization system reject wastewater stream 42 is combined with the cooling tower blow-down 44 and conveyed as a plant wastewater stream 46 for elimination at a plant discharge site 48.

There are five main dispensations of water at the power plant. The first is a high quality feed-water stream 28 for the plant demineralization system 38. The second is a chlorinated, high quality plant service water 72 for wash down and general utility use. The third is the make-up water 20 and 21 for the cooling tower 60. The fourth is a chlorinated, good quality feed-water 71 for a power plant fire protection system 68. The fifth is a high quality feed-water 24 for a plant potable water system 26.

The invention relates to the water cycle process of the plant. The reader is directed toward the heavy solid lines with broken arrows of FIG. 16. These lines represent the process and components of the invention. In this embodiment of the invention, raw water is supplied to the invention from a source 2 after being pressured in a raw water feed pump 4. A pressured raw water stream 6 is conveyed as the secondary make-up water 21 to the plant cooling tower 60. A pressured side-stream 8 is extracted from the pressured raw water stream 6 and supplies the invention. Side-stream 8 conveys water to a mechanical filtration system 10. Suspended solids are mechanically extracted from this water and a good quality filtrate 17 is directed into a membrane filtration system 12. Solids collected by the mechanical filtration system 10, are discharged as a waste stream 14 to the plant wastewater stream 46 for disposal at the plant discharge site 48. A side-stream 18 is extracted from the mechanical filtrate 17. A chlorinating chemical 34 is dispensed by means of a chemical dosing pump system 36 and a conveyance 30 into the mechanical filtrate stream 18. The resulting chlorinated, mechanical filtrate stream provides feed-water to a fire protection water storage tank 67. Water from this tank provides the feed-water 71 to the fire protection system 68 of the plant.

The membrane filtration system 12 receives the filtrate stream 17 at a high rate of flow. The filtrate stream 17 is conducted across membrane surfaces of the membrane filtration system 12 in a high velocity, cross-flow mode to secure cleansing of the membrane filtration system 12. The filtrate 17 is applied in a single pass manner, affording it as a good quality reject water 16 profiting the power plant as a good quality primary make-up water 20 to the cooling tower 60. The cooling tower 60 is also delivered the secondary make-up water 21 which is provided from the raw water stream 6 as is needed to supplement the primary make-up water 20. A permeate stream 22 exits the membrane filtration system 12 as a very high quality, sterile, chlorine free product. Permeate stream 22 provides service as the feed-water 24 to the potable water system 26 and as the feed-water 28 to the demineralization system 38 at the plant. A side-stream 32 is extracted from the permeate stream 22. A chlorinating chemical 34 is dispensed into the permeate side-stream 32 by means of a dosing chemical pump system 37 and a conveyance 35. The resulting chlorinated permeate stream provides feed to a plant service water storage tank 65. Chlorinated permeate from this tank is pressured by a plant service water pump 70 to provide the plant service water 72 to the plant 50.

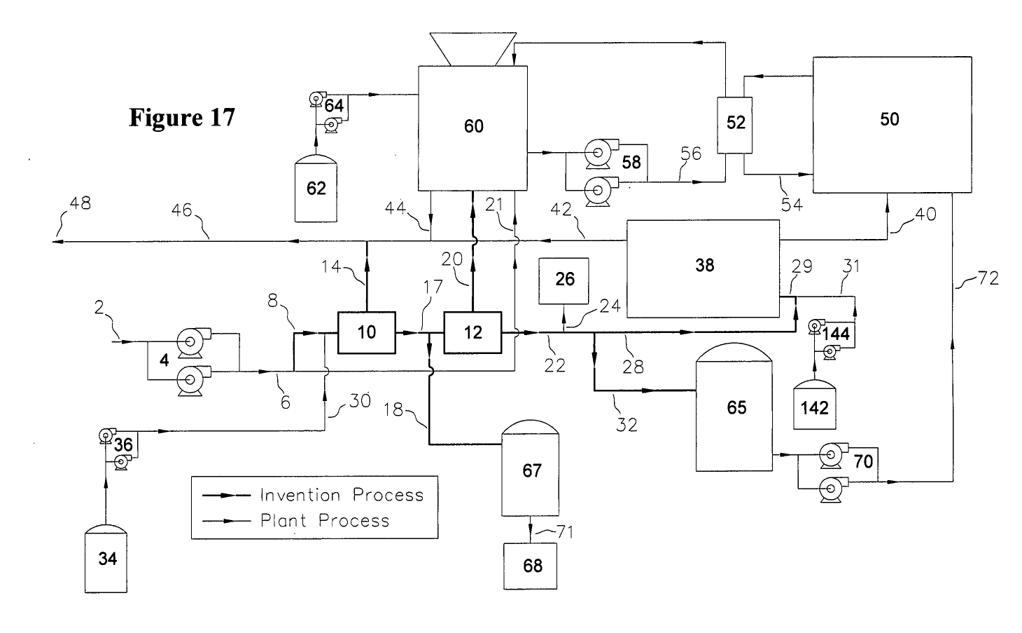

Description: FIG. 17

Direct to obtaining the effect of the invention, FIG. 17 illustrates an embodiment of the invention at a typical thermal power plant. This embodiment of the invention receives a pressured raw water stream and provides; chlorinated mechanical filtrate for plant fire protection system water, chlorinated membrane permeate for plant service water, chlorinated membrane reject water for primary cooling tower make-up water; raw water for secondary cooling tower make-up water, chlorinated membrane permeate for potable water system feed-water and de-chlorinated membrane permeate for demineralization system feed-water.

FIG. 17 presents a process diagram of the invention and a typical process diagram of a thermal power plant water cycle. The line legend on FIG. 17 delineates the process flow and relevant system components of the invention with solid heavy lines with broken arrows and the thermal power plant process flow and relevant system components in solid thin lines. The reader should note; power plants typically configure pumps in a duplex format so as to facilitate reliability. This practice is presented in this figure. In deference to reducing reiteration, the reference in this document to a pump or pumping system should be assumed by the reader as indicative of a duplex configuration, unless otherwise stated.

The figure presents a generalized water cycle of a thermal power plant. The power plant is cooled by a cooling tower 60. A circulating cooling water stream 56 is pressured and driven by a circulating water pump 58. The circulating cooling water stream 56 provides cooling to a heated gas or fluid 54 originating from a power house 50. The cooling is facilitated by a circulating water contacted heat exchanger 52. The water chemistry of the circulating water 56 from the cooling tower 60 is maintained in three fashions; first by a consortium of chemicals 62 dispensed via a dosage controlled chemical pumping system 64, second, by discharge of cooling tower 60 water by means of a blow-down stream 44 to waste and third, by a fresh feed-water make-up 20 and 21. A demineralization system 38 provides demineralized water 40 to the power house 50 for various applications. A demineralization system reject wastewater stream 42 is combined with the cooling tower blow-down 44 and conveyed as a plant wastewater stream 46 for elimination at a plant discharge site 48.

There are five main dispensations of water at the power plant. The first is a chlorinated, high quality feed-water 28 for de-chlorination and feed 29 to the plant demineralization system 38. The second is a chlorinated, high quality plant service water 72 for wash down and general utility use. The third is partially chlorinated make-up water 20 and 21 for the cooling tower 60. The fourth is a chlorinated, good quality feed-water 71 for a power plant fire protection system 68. The fifth is a chlorinated, high quality feed-water 24 for a plant potable water system 26.

The invention relates to the water cycle process of the plant. The reader is directed toward the heavy solid lines with broken arrows of FIG. 17. These lines represent the process and components of the invention. In this embodiment of the invention, raw water is supplied to the invention from a source 2 after being pressured in a raw water feed pump 4. A pressured raw water stream 6 is conveyed as the secondary make-up water 21 to the plant cooling tower 60. A pressured side-stream 8 is extracted from the pressured raw water stream 6 and supplies the invention. Side stream 8 is conveyed to a mechanical filtration system 10. A chlorinating chemical 34 is dispensed by means of a chemical pump dosing system 36 and a conveyance 30 into the side-stream 8 prior to entry to mechanical filter 10. Suspended solids are mechanically extracted from this water and a good quality filtrate 17 is directed into a membrane filtration system 12. Solids collected by the mechanical filtration system 10, are discharged as a waste stream 14 to the plant wastewater stream 46 for disposal at the plant discharge site 48. A side-stream 18 is extracted from the mechanical filtrate 17. The chlorinated, mechanical filtrate 18 provides feed-water to a fire protection water storage tank 67. Water from this tank provides the feed-water 71 to the fire protection system 68 of the plant.

The membrane filtration system 12 receives the filtrate stream 17 at a high rate of flow. The filtrate stream 17 is conducted across membrane surfaces of the membrane filtration system 12 in a high velocity, cross-flow mode to secure cleansing of the membrane filtration system 12. The filtrate 17 is applied in a single pass manner, affording it as a good quality reject water 16 profiting the power plant as a chlorinated, good quality primary make-up water 20 to the cooling tower 60. The cooling tower 60 is also delivered an unchlorinated secondary make-up water 21 which is provided from the raw water stream 6 as is needed to supplement the primary make-up water 20. A permeate stream 22 exits the membrane filtration system 12 as a very high quality, sterile, chlorinated product. Permeate stream 22 provides service as the chlorinated feed-water 24 to the potable water system 26 and as the chlorinated permeate stream 28 directed for de-chlorination and employ as the feed-water 29 into the plant demineralization system 38. Prior to entering the demineralization system 38, the chlorinated permeate 28 is dosed with a de-chlorinating chemical 142 by means of a chemical dosing pump system 144 and a conveyance 31. The resulting de-chlorinated demineralization feed-water 29 is directed into the demineralization system 38 of the plant. A side-stream 32 is extracted from the permeate stream 28 and provides high quality chlorinated feed to a plant service water storage tank 65. Chlorinated permeate from this storage tank is pressured by a service water pump 70 and delivered as plant service water 72 to the power plant 50.

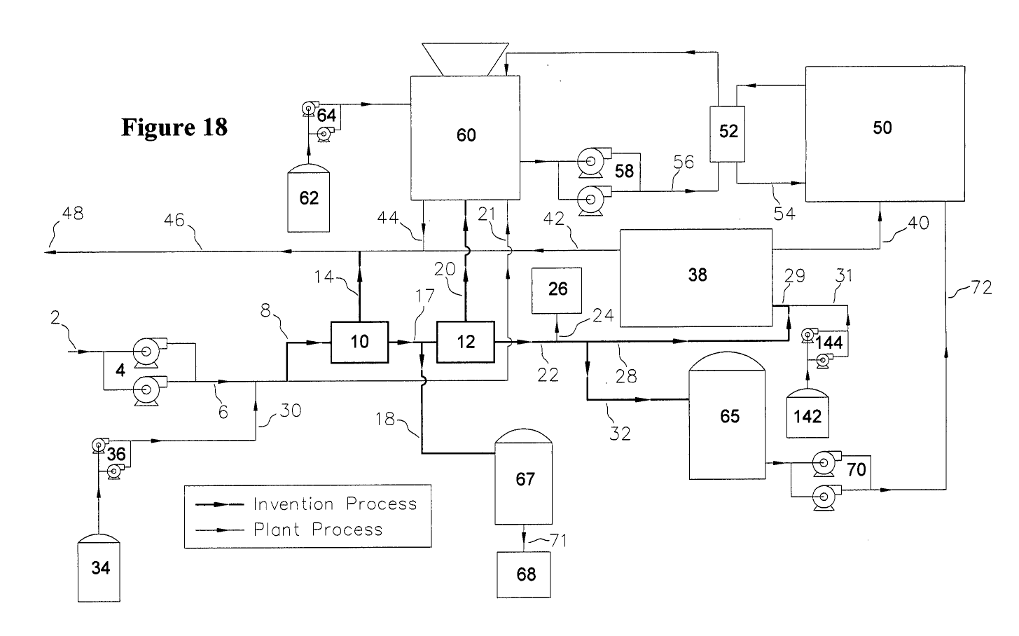

Description: FIG. 18

Direct to obtaining the effect of the invention, FIG. 18 illustrates an embodiment of the invention at a typical thermal power plant. This embodiment of the invention receives a pressured raw water stream and provides; chlorinated mechanical filtrate for plant fire protection system water, chlorinated membrane permeate for plant service water, chlorinated membrane reject water for primary cooling tower make-up water; chlorinated raw water for secondary cooling tower make-up water, chlorinated membrane permeate for potable water system feed-water and de-chlorinated membrane permeate for demineralization system feed-water.

FIG. 18 presents a process diagram of the invention and a typical process diagram of a thermal power plant water cycle. The line legend on FIG. 18 delineates the process flow and relevant system components of the invention with solid heavy lines with broken arrows and the thermal power plant process flow and relevant system components in solid thin lines. The reader should note; power plants typically configure pumps in a duplex format so as to facilitate reliability. This practice is presented in this figure. In deference to reducing reiteration, the reference in this document to a pump or pumping system should be assumed by the reader as indicative of a duplex configuration, unless otherwise stated.

The figure presents a generalized water cycle of a thermal power plant. The power plant is cooled by a cooling tower 60. A circulating cooling water stream 56 is pressured and driven by a circulating water pump 58. The circulating cooling water stream 56 provides cooling to a heated gas or fluid 54 originating from a power house 50. The cooling is facilitated by a circulating water contacted heat exchanger 52. The water chemistry of the circulating water 56 from the cooling tower 60 is maintained in three fashions; first by a consortium of chemicals 62 dispensed via a dosage controlled chemical pumping system 64, second, by discharge of cooling tower 60 water by means of a blow-down stream 44 to waste and third, by a fresh feed-water make-up 20 and 21. A demineralization system 38 provides demineralized water 40 to the power house 50 for various applications. A demineralization system reject wastewater stream 42 is combined with the cooling tower blow-down 44 and conveyed as a plant wastewater stream 46 for elimination at a plant discharge site 48.

There are five main dispensations of water at the power plant. The first is a chlorinated, high quality feed-water 28 for de-chlorination and feed 29 to the plant demineralization system 38. The second is a chlorinated, high quality plant service water 72 for wash down and general utility use. The third is chlorinated make-up water 20 and 21 for the cooling tower 60. The fourth is a chlorinated, good quality feed-water 71 for a power plant fire protection system 68. The fifth is a chlorinated, high quality feed-water 24 for a plant potable water system 26.

The invention relates to the water cycle process of the plant. The reader is directed toward the heavy solid lines with broken arrows of FIG. 18. These lines represent the process and components of the invention. In this embodiment of the invention, raw water is supplied to the invention from a source 2 after being pressured in a raw water feed pump 4. A pressured raw water stream 6 is conveyed as a secondary make-up water 21 to the plant cooling tower 60. A pressured side-stream 8 is extracted from the pressured raw water stream 6 and supplies the invention. A chlorinating chemical 34 is dispensed into the pressured raw water stream 6, prior to the extraction of the side-stream 8, by means of a chemical pump dosing system 36 and a conveyance 30. Side stream 8 is conveyed to a mechanical filtration system 10. Suspended solids are mechanically extracted from this water and a good quality filtrate 17 is directed into a membrane filtration system 12. Solids collected by the mechanical filtration system 10, are discharged as a waste stream 14 to the plant wastewater stream 46 for disposal at the plant discharge site 48. A side-stream 18 is extracted from the mechanical filtrate 17. The chlorinated, mechanical filtrate 18 provides feed-water to a fire protection water storage tank 67. Water from this tank provides the feed-water 71 to the fire protection system 68 of the plant.

The membrane filtration system 12 receives the filtrate stream 17 at a high rate of flow. The filtrate stream 17 is conducted across membrane surfaces of the membrane filtration system 12 in a high velocity, cross-flow mode to secure cleansing of the membrane filtration system 12. The filtrate 17 is applied in a single pass manner, affording it as a good quality reject water 16 profiting the power plant as a chlorinated, good quality primary make-up water 20 to the cooling tower 60. The cooling tower 60 is also delivered the secondary make-up water 21 which is provided from the chlorinated raw water stream 6 as is needed to supplement the primary make-up water 20.

A high quality chlorinated permeate stream 22 exits the membrane filtration system 12 as a very high quality, sterile, chlorinated product. Permeate stream 22 provides service as the feed-water 24 to the potable water system 26 and as the feed-water stream 28 to supply the demineralization system 38 at the plant. Prior to entering the demineralization system 38, the chlorinated permeate 28 is dosed with a de-chlorinating chemical 142 by means of a chemical dosing pump system 144 and a conveyance 31. The resulting de-chlorinated demineralization feed-water 29 is directed to the demineralization system 38 of the plant. A side-stream 32 is extracted from the permeate stream 28 and provides chlorinated high quality feed to a plant service water storage tank 65. Chlorinated permeate from this storage tank is pressured by a service water pump 70 and delivered as plant service water 72 to the power plant 50.

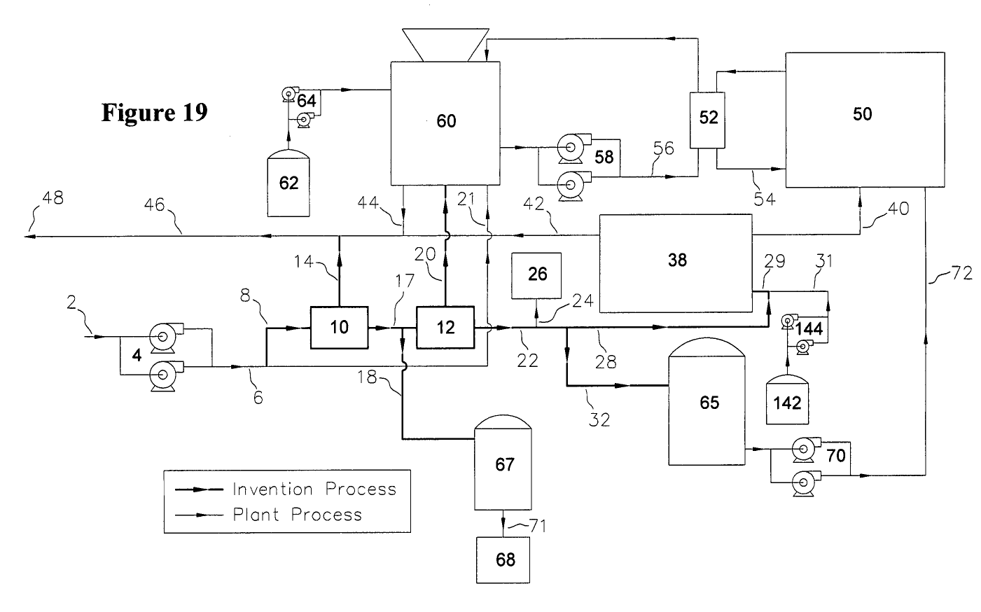

Description: FIG. 19

Direct to obtaining the effect of the invention, FIG. 19 illustrates an embodiment of the invention at a typical thermal power plant. This embodiment of the invention receives a pressured, chlorinated raw water stream and provides; chlorinated mechanical filtrate for plant fire protection system water, chlorinated membrane permeate for plant service water, chlorinated membrane reject water for primary cooling tower make-up water; chlorinated raw water for secondary cooling tower make-up water, chlorinated membrane permeate for potable water system feed-water and de-chlorinated membrane permeate for demineralization system feed-water.

FIG. 19 presents a process diagram of the invention and a typical process diagram of a thermal power plant water cycle. The line legend on FIG. 19 delineates the process flow and relevant system components of the invention with solid heavy lines with broken arrows and the thermal power plant process flow and relevant system components in solid thin lines. The reader should note; power plants typically configure pumps in a duplex format so as to facilitate reliability. This practice is presented in this figure. In deference to reducing reiteration, the reference in this document to a pump or pumping system should be assumed by the reader as indicative of a duplex configuration, unless otherwise stated.

The figure presents a generalized water cycle of a thermal power plant. The power plant is cooled by a cooling tower 60. A circulating cooling water stream 56 is pressured and driven by a circulating water pump 58. The circulating cooling water stream 56 provides cooling to a heated gas or fluid 54 originating from a power house 50. The cooling is facilitated by a circulating water contacted heat exchanger 52. The water chemistry of the circulating water 56 from the cooling tower 60 is maintained in three fashions; first by a consortium of chemicals 62 dispensed via a dosage controlled chemical pumping system 64, second, by discharge of cooling tower 60 water by means of a blow-down stream 44 to waste and third, by a fresh feed-water make-up 20 and 21. A demineralization system 38 provides demineralized water 40 to the power house 50 for various applications. A demineralization system reject wastewater stream 42 is combined with the cooling tower blow-down 44 and conveyed as a plant wastewater stream 46 for elimination at a plant discharge site 48.

There are five main dispensations of water at the power plant. The first is a chlorinated, high quality feed-water 28 for de-chlorination and feed 29 for the plant demineralizabon system 38. The second is a chlorinated, high quality plant service water 72 for wash down and general utility use. The third is chlorinated make-up water 20 and 21 for the cooling tower 60. The fourth is a chlorinated, good quality feed-water 71 for a power plant fire protection system 68. The fifth is a chlorinated, high quality feed-water 24 for a plant potable water system 26.

The invention relates to the water cycle process of the plant. The reader is directed toward the heavy solid lines with broken arrows of FIG. 19. These lines represent the process and components of the invention. In this embodiment of the invention, chlorinated raw water is supplied to the invention from a source 2 after being pressured in a raw water feed pump 4. A pressured raw water stream 6 is conveyed as a secondary make-up water 21 to the plant cooling tower 60. A pressured side-stream 8 is extracted from the pressured raw water stream 6 and supplies the invention. Side-stream 8 is conveyed to a mechanical filtration system 10. Suspended solids are mechanically extracted from this water and a good quality filtrate 17 is directed into a membrane filtration system 12. Solids collected by the mechanical filtration system 10, are discharged as a waste stream 14 to the plant wastewater stream 46 for disposal at the plant discharge site 48. A side-stream 18 is extracted from the mechanical filtrate 17. The chlorinated, mechanical filtrate 18 provides feed-water to a fire protection water storage tank 67. Water from this tank provides the feed-water 71 to the fire protection system 68 of the plant.

The membrane filtration system 12 receives the filtrate stream 17 at a high rate of flow. The filtrate stream 17 is conducted across membrane surfaces of the membrane filtration system 12 in a high velocity, cross-flow mode to secure cleansing of the membrane filtration system 12. The filtrate 17 is applied in a single pass manner, affording it as a good quality reject water 16 profiting the power plant as a chlorinated, good quality primary make-up water 20 to the cooling tower 60. The cooling tower 60 is also delivered a secondary make-up water 21 which is provided from the chlorinated raw water stream 6 as is needed to supplement the primary make-up water 20.

A high quality permeate stream 22 exits the membrane filtration system 12 as a very high quality, chlorinated product. Permeate stream 22 provides service as the chlorinated, high quality feed-water 24 to a potable water system 26 and as the chlorinated demineralization feed-water 28 directed towards a demineralization system 38 at the plant. Prior to entering the demineralization system 38, the chlorinated permeate 28 is dosed with a de-chlorinating chemical 142 by means of a chemical dosing pump system 144 and a conveyance 31. The resulting de-chlorinated demineralization feed-water 29 is directed to the demineralization system 38 of the plant. A side-stream 32 is extracted from the permeate stream 28 and provides a chlorinated, high quality feed to a plant service water storage tank 65. Chlorinated permeate from this storage tank is pressured by a service water pump 70 and delivered as plant service water 72 to the power plant 50.

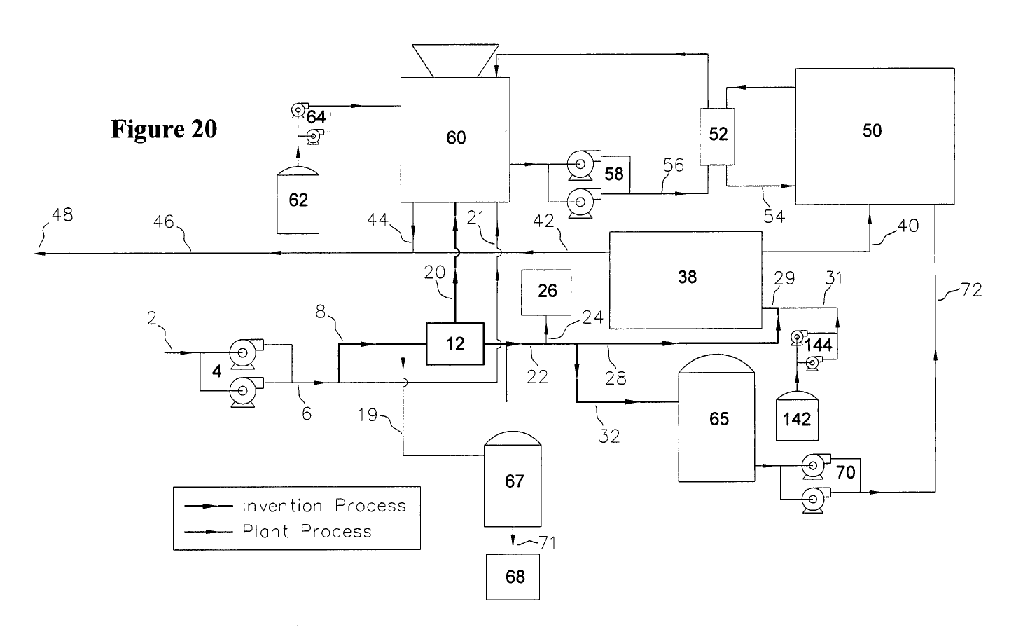

Description: FIG. 20

Direct to obtaining the effect of the invention, FIG. 20 illustrates an embodiment of the invention at a typical thermal power plant. This embodiment of the invention receives a pressured, chlorinated, good quality raw water stream and provides; chlorinated raw water for fire protection system water, chlorinated membrane reject water for prime cooling tower make-up water; chlorinated raw water for secondary cooling tower make-up water, chlorinated membrane permeate for plant service water and potable water system feed-water and de-chlorinated membrane permeate for demineralization system feed-water.

FIG. 20 presents a process diagram of the invention and a typical process diagram of a thermal power plant water cycle. The line legend on FIG. 20 delineates the process flow and relevant system components of the invention with solid heavy lines with broken arrows and the thermal power plant process flow and relevant system components in solid thin lines. The reader should note; power plants typically configure pumps in a duplex format so as to facilitate reliability. This practice is presented in this figure. In deference to reducing reiteration, the reference in this document to a pump or pumping system should be assumed by the reader as indicative of a duplex configuration, unless otherwise stated.

The figure presents a generalized water cycle of a thermal power plant. The power plant is cooled by a cooling tower 60. A circulating cooling water stream 56 is pressured and driven by a circulating water pump 58. The circulating cooling water stream 56 provides cooling to a heated gas or fluid 54 originating from a power house 50. The cooling is facilitated by a circulating water contacted heat exchanger 52. The water chemistry of the circulating water 56 from the cooling tower 60 is maintained in three fashions; first by a consortium of chemicals 62 dispensed via a dosage controlled chemical pumping system 64, second, by discharge of cooling tower 60 water by means of a blow-down stream 44 to waste and third, by a fresh feed-water make-up 20 and 21. A demineralization system 38 provides demineralized water 40 to the power house 50 for various applications. A demineralization system reject wastewater stream 42 is combined with the cooling tower blow-down 44 and conveyed as a plant wastewater stream 46 for elimination at a plant discharge site 48.

There are five main dispensations of water at the power plant. The first is a chlorinated, high quality feed-water 28 for de-chlorination and feed 29 for the plant demineralization system 38. The second is a chlorinated, high quality plant service water 72 for wash down and general utility use. The third is chlorinated make-up water 20 and 21 for the cooling tower 60. The fourth is a chlorinated, good quality feed-water 71 for a power plant fire protection system 68. The fifth is a chlorinated, high quality feed-water 24 for a plant potable water system 26.

The invention relates to the water cycle process of the plant. The reader is directed toward the heavy solid lines with broken arrows of FIG. 20. These lines represent the process and components of the invention. In this embodiment of the invention, chlorinated, good quality raw water is supplied to the invention from a source 2 after being pressured in a raw water feed pump 4. A pressured raw water stream 6 is conveyed as a secondary make-up water 21 to the plant cooling tower 60. A pressured side-stream 8 is extracted from the pressured raw water stream 6 and supplies the invention. A side-stream 19 is extracted from the side-stream 8 and provides chlorinated feed-water to a fire protection water storage tank 67. Water from this tank provides feed-water 71 to the fire protection system 68 of the plant.

Side-stream 8 is conveyed to a membrane filtration system 12. The membrane filtration system 12 receives the stream 8 at a high rate of flow. The stream 8 is conducted across membrane surfaces of the membrane filtration system 12 in a high velocity, cross-flow mode to secure cleansing of the membrane filtration system 12. The stream 8 is applied in a single pass manner, affording it as a good quality reject water 16 profiting the power plant as a chlorinated, good quality primary make-up water 20 to the cooling tower 60. The cooling tower 60 is also delivered a secondary make-up water 21 which is provided from the chlorinated raw water stream 6 as is needed to supplement the primary make-up water 20.

A high quality permeate stream 22 exits the membrane filtration system 12 as a very high quality, chlorinated product. Permeate stream 22 provides service as the chlorinated feed-water 24 to the potable water system 26 and as the chlorinated demineralization feed-water 28 directed towards the demineralization system 38 at the plant. Prior to entering the demineralization system 38, the chlorinated feed-water 28 is dosed with a de-chlorinating chemical 142 by means of a chemical dosing pump system 144 and a conveyance 31. The resulting de-chlorinated demineralization feed-water 29 is directed into the demineralization system 38 of the plant. A side-stream 32 is extracted from the permeate stream 28 and provides feed to a plant service water storage tank 65. Chlorinated permeate from this storage tank is pressured by a service water pump 70 and delivered as the plant service water 72 to the power plant 50.

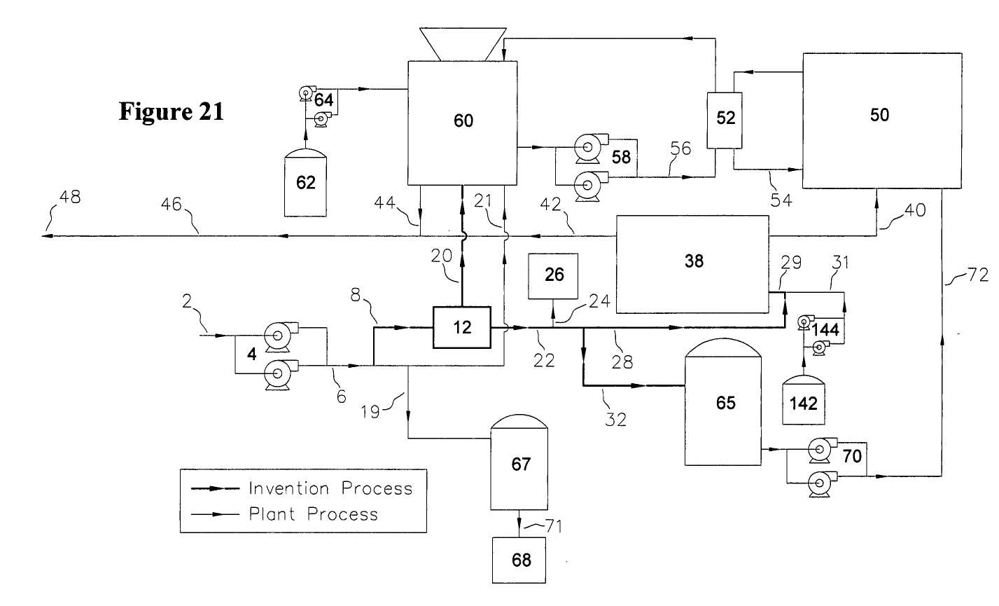

Description: FIG. 21

Direct to obtaining the effect of the invention, FIG. 21 illustrates an embodiment of the invention at a typical thermal power plant. This embodiment of the invention receives a pressured, chlorinated, good quality raw water stream and provides; chlorinated raw water for fire protection system water, chlorinated membrane reject water for prime cooling tower make-up water; chlorinated raw water for secondary cooling tower make-up water, chlorinated membrane permeate for plant service water and potable water system feed-water and de-chlorinated membrane permeate for demineralization system feed-water. The process delineated in FIG. 21 differs mechanically only slightly from that of FIG. 20.

FIG. 21 presents a process diagram of the invention and a typical process diagram of a thermal power plant water cycle. The line legend on FIG. 20 delineates the process flow and relevant system components of the invention with solid heavy lines with broken arrows and the thermal power plant process flow and relevant system components in solid thin lines. The reader should note; power plants typically configure pumps in a duplex format so as to facilitate reliability. This practice is presented in this figure. In deference to reducing reiteration, the reference in this document to a pump or pumping system should be assumed by the reader as indicative of a duplex configuration, unless otherwise stated.

The figure presents a generalized water cycle of a thermal power plant. The power plant is cooled by a cooling tower 60. A circulating cooling water stream 56 is pressured and driven by a circulating water pump 58. The circulating cooling water stream 56 provides cooling to a heated gas or fluid 54 originating from a power house 50. The cooling is facilitated by a circulating water contacted heat exchanger 52. The water chemistry of the circulating water 56 from the cooling tower 60 is maintained in three fashions; first by a consortium of chemicals 62 dispensed via a dosage controlled chemical pumping system 64, second, by discharge of cooling tower 60 water by means of a blow-down stream 44 to waste and third, by a fresh feed-water make-up 20 and 21. A demineralization system 38 provides demineralized water 40 to the power house 50 for various applications. A demineralization system reject wastewater stream 42 is combined with the cooling tower blow-down 44 and conveyed as a plant wastewater stream 46 for elimination at a plant discharge site 48.

There are five main dispensations of water at the power plant. The first is a chlorinated, high quality feed-water 28 for de-chlorination and feed 29 for the plant demineralization system 38. The second is a chlorinated, high quality plant service water 72 for wash down and general utility use. The third is chlorinated make-up water 20 and 21 for the cooling tower 60. The fourth is a chlorinated, good quality feed-water 71 for a power plant fire protection system 68. The fifth is a chlorinated, high quality feed-water 24 for a plant potable water system 26.

The invention relates to the water cycle process of the plant. The reader is directed toward the heavy solid lines with broken arrows of FIG. 20. These lines represent the process and components of the invention. In this embodiment of the invention, chlorinated, good quality raw water is supplied to the invention from a source 2 after being pressured in a raw water feed pump 4. A pressured raw water stream 6 is conveyed as a secondary make-up water 21 to the plant cooling tower 60. A pressured side-stream 8 is extracted from the pressured raw water stream 6 and supplies the invention. A side-stream 19 is extracted from the stream 6 and provides a chlorinated feed to the fire protection water storage tank 67. Water from this tank provides the feed-water 71 to the fire protection system 68 of the plant.

Side-stream 8 is conveyed to a membrane filtration system 12. The membrane filtration system 12 receives the stream 8 at a high rate of flow. The stream 8 is conducted across membrane surfaces of the membrane filtration system 12 in a high velocity, cross-flow mode to secure cleansing of the membrane filtration system 12. The side-stream 8 is applied in a single pass manner, affording it as a good quality reject water 16 profiting the power plant as a chlorinated, good quality primary make-up water 20 to the cooling tower 60. The cooling tower 60 is also delivered a secondary make-up water 21 which is provided from the chlorinated raw water stream 6 as is needed to supplement the primary make-up water 20.

A high quality permeate stream 22 exits the membrane filtration system 12 as a very high quality, chlorinated product. This permeate stream 22 provides service as the chlorinated feed-water 24 to the potable water system 26 and as the chlorinated demineralization feed-water 28 directed towards the demineralization system 38 at the plant. Prior to entering the demineralization system 38, the chlorinated feed-water 28 is dosed with a de-chlorinating chemical 142 by means of a chemical dosing pump system 144 and a conveyance 31. The resulting de-chlorinated demineralization feed-water 29 is directed into the demineralization system 38 of the plant. A side-stream 32 is extracted from the permeate stream 28 and provides feed to a plant service water storage tank 65. Chlorinated permeate from this storage tank is pressured by a service water pump 70 and delivered as the plant service water 72 to the power plant 50.

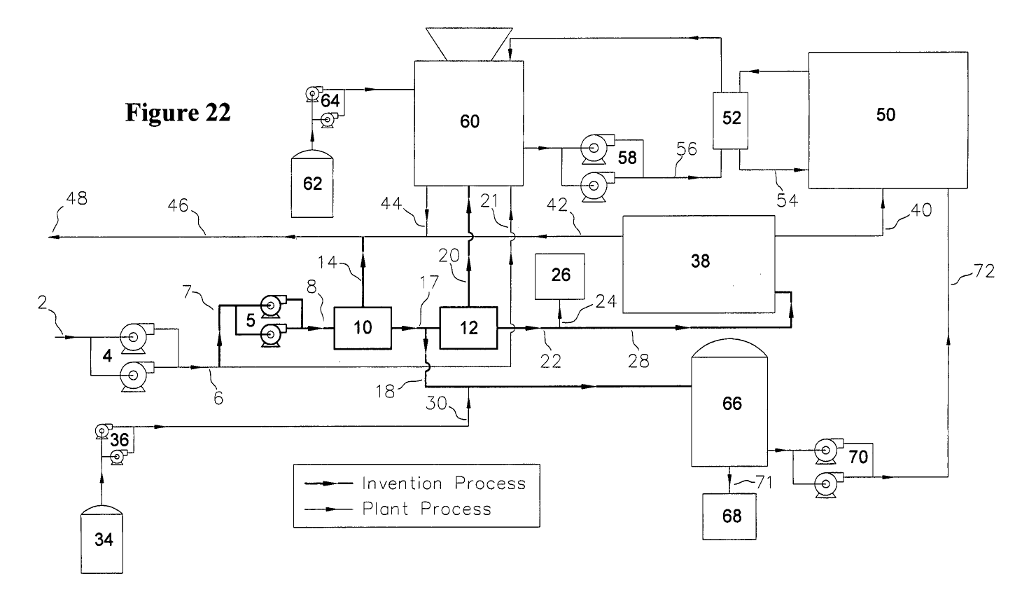

Description: FIG. 22

Direct to obtaining the effect of the invention, FIG. 22 illustrates an embodiment the invention receives an insufficiently pressured raw water stream and provides; chlorinated mechanical filtrate for plant service water, chlorinated mechanical filtrate for plant fire protection water, un-chlorinated membrane reject water for primary cooling tower make-up water, un-chlorinated raw water for secondary cooling tower make-up water and un-chlorinated membrane permeate as both demineralization feed-water and potable water system feed-water.

The line legend on FIG. 22 delineates the process flow and relevant system components of the invention with solid heavy lines with broken arrows and the thermal power plant process flow and relevant system components in solid thin lines. The reader should note; power plants typically configure pumps in a duplex format so as to facilitate reliability. This practice is presented in this figure. In deference to reducing reiteration, the reference in this document to a pump or pumping system should be assumed by the reader as indicative of a duplex configuration, unless otherwise stated.

The figure presents a generalized water cycle of a thermal power plant. The power plant is cooled by a cooling tower 60. A circulating cooling water stream 56 is pressured and driven by a circulating water pump 58. The circulating cooling water stream 56 provides cooling to a heated gas or fluid 54 originating from a power house 50. The cooling is facilitated by a circulating water contacted heat exchanger 52. The water chemistry of the circulating water 56 from the cooling tower 60 is maintained in three fashions; first by a consortium of chemicals 62 dispensed via a dosage controlled chemical pumping system 64, second, by discharge of cooling tower 60 water by means of a blow-down stream 44 to waste and third, by a fresh feed-water make-up 20 and 21. A demineralization system 38 provides demineralized water 40 to the power house 50 for various applications. A demineralization system reject wastewater stream 42 is combined with the cooling tower blow-down 44 and conveyed as a plant wastewater stream 46 for elimination at a plant discharge site 48.

There are five main dispensations of water at the power plant. The first is a high quality feed-water 28 for the plant demineralization system 38. The second is a chlorinated, good quality plant service water 72 for wash down and general utility use. The third is the make-up water 20 and 21 for the cooling tower 60. The fourth is a chlorinated, good quality feed-water 71 for a power plant fire protection system 68. The fifth is a high quality feed-water 24 for a plant potable water system 26.

In this embodiment a single storage tank 66 provides two of the five dispensations of water at the plant; the plant service water 72 and the fire protection system feed-water 71.

The invention relates to the water cycle process of the plant. The reader is directed toward the heavy solid lines with broken arrows of FIG. 22. These lines represent the process and components of the invention. In this embodiment of the invention, raw water is supplied to the invention from a source 2 after being pressured in a raw water feed pump 4. A pressured raw water stream 6 is conveyed as a secondary make-up water 21 to the plant cooling tower 60. A side-stream 7 is extracted from the pressured raw water stream 6 and directed toward the invention. The pressure available in stream 7 is insufficient for the invention. The stream 7 is directed into a booster pump 5 which provides a sufficiently pressured stream 8. Water stream 8 conveys water to a mechanical filtration system 10. Suspended solids are mechanically extracted from the water and a filtrate 17 is directed in two directions; the preponderance of the filtrate 17 is directed into a membrane filtration system 12, while the remainder of the filtrate 17 is discharged as a side-stream 18. Solids collected by the mechanical filtration system 10, are discharged as a waste stream 14 to the discharge stream 46 for disposal at the plant discharge site 48. A chlorinating chemical 34, such as sodium hypochlorite, is dispensed via a dosage controlled chemical pump 36, and delivered 30 into the filtrate side-stream 18. The chlorinated filtrate stream is then delivered to the storage tank 66. Chlorinated filtrate from this storage tank is pressured by a service water pump 70 and delivered as plant service water 72 to the power plant 50. Feed-water 71 to the plant fire protection system 68 is supplied from this tank.

The membrane filtration system 12 receives the filtrate stream 17 at a high rate of flow. The filtrate stream 17 is conducted across membrane surfaces of the membrane filtration system 12 in a high velocity, cross-flow mode to secure cleansing of the membrane filtration system 12. The filtrate 17 is applied in a single pass manner, affording it as a high quality reject water 16 profiting the power plant as a prime make-up water 20 to the cooling tower 60. The cooling tower 60 is delivered a secondary make-up water 21 which is provided from the water stream 6 as is needed to supplement the prime make-up water 20.

A permeate stream 22 exits the membrane filtration system 12 as a very high quality, sterile, chlorine free product. This permeate stream 22 supplies both a feed-water 24 to a potable water system 26 and a demineralization feed-water 28 to a demineralization system 38 at the plant.

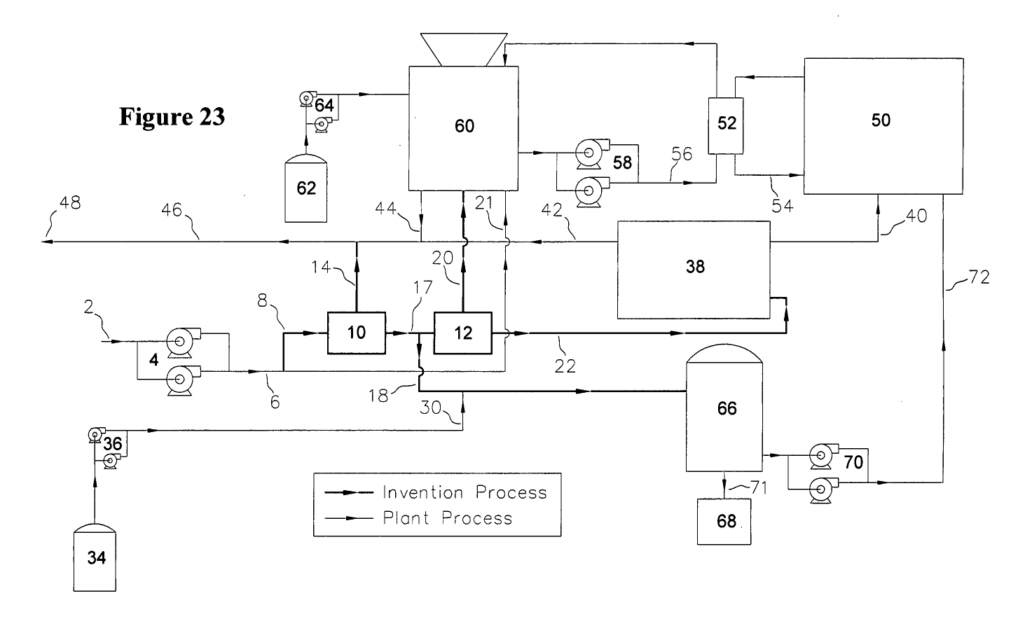

Description: FIG. 23

Direct to obtaining the effect of the invention, FIG. 23 illustrates embodiment of the invention at a typical thermal power plant. This embodiment of the invention receives a pressured raw water stream and provides; chlorinated mechanical filtrate for plant service water, chlorinated mechanical filtrate for plant fire protection water, un-chlorinated membrane reject water for primary cooling tower make-up water, un-chlorinated raw water for secondary cooling tower make-up water and un-chlorinated membrane permeate as demineralization feed-water.

The line legend on FIG. 23 delineates the process flow and relevant system components of the invention with solid heavy lines with broken arrows and the thermal power plant process flow and relevant system components in solid thin lines. The reader should note; power plants typically configure pumps in a duplex format so as to facilitate reliability. This practice is presented in this figure. In deference to reducing reiteration, the reference in this document to a pump or pumping system should be assumed by the reader as indicative of a duplex configuration, unless otherwise stated.

The figure presents a generalized water cycle of a thermal power plant. The power plant is cooled by a cooling tower 60. A circulating cooling water stream 56 is pressured and driven by a circulating water pump 58. The circulating cooling water stream 56 provides cooling to a heated gas or fluid 54 originating from a power house 50. The cooling is facilitated by a circulating water contacted heat exchanger 52. The water chemistry of the circulating water 56 from the cooling tower 60 is maintained in three fashions; first by a consortium of chemicals 62 dispensed via a dosage controlled chemical pumping system 64, second, by discharge of cooling tower 60 water by means of a blow-down stream 44 to waste and third, by a fresh feed-water make-up 20 and 21. A demineralization system 38 provides demineralized water 40 to the power house 50 for various applications. A demineralization system reject wastewater stream 42 is combined with the cooling tower blow-down 44 and conveyed as a plant wastewater stream 46 for elimination at a plant discharge site 48.

There are four main dispensations of water at the power plant. The first is a high quality feed-water 28 for the plant demineralization system 38. The second is a chlorinated, good quality plant service water 72 for wash down and general utility use. The third is the make-up water 20 and 21 for the cooling tower 60. The fourth is a chlorinated, good quality feed-water 71 for a power plant fire protection system 68.

In this, a single storage tank 66 provides two of the five dispensations of water at the plant; the plant service water 72 and the fire protection system feed-water 71.

The invention relates to the water cycle process of the plant. The reader is directed toward the heavy solid lines with broken arrows of FIG. 23. These lines represent the process and components of the invention. In this embodiment of the invention, raw water is supplied to the invention from a source 2 after being pressured in a raw water feed pump 4. A pressured raw water stream 6 is conveyed as a secondary make-up water 21 to the plant cooling tower 60. A pressured side-stream 8 is extracted from the pressured raw water stream 6 and supplies the invention. Side-stream 8 conveys water to a mechanical filtration system 10. Suspended solids are mechanically extracted from the water and a good quality filtrate 17 is conveyed in two directions; the preponderance of the filtrate 17 is directed into a membrane filtration system 12, while the remainder of the filtrate 17 is discharged as a side-stream 18. Solids collected by the mechanical filtration system 10, are discharged as a waste stream 14 to the plant waste discharge stream 46 for disposal at the plant discharge site 48. A chlorinating chemical 34, such as sodium hypochlorite, is dispensed via a dosage controlled chemical pump 36, and delivered 30 into the filtrate side-stream 18. The resulting chlorinated filtrate stream is conveyed to the storage tank 66 for eventual use as the plant fire protection water system feed-water 71 and the plant service water 72. Water from this tank is pressured through a plant service water pump system 70 and conveyed as the plant service water 72 serving the plant 50. The plant fire protection system 68 is provided feed-water 71 from the tank 66.

The membrane filtration system 12 receives the filtrate stream 17 at a high rate of flow. The filtrate stream 17 is conducted across membrane surfaces of the membrane filtration system 12 in a high velocity, cross-flow mode to secure cleansing of the membrane filtration system 12. The filtrate 17 is applied in a single pass manner, affording it as a good quality, mechanically filtered reject water 16 profiting the power plant as a good quality, primary make-up water 20 to the cooling tower 60. The cooling tower 60 is delivered a lower quality, secondary make-up water 21 which is provided from the raw water stream 6 as is needed to supplement the good quality primary make-up water 20.

A permeate stream 22 exits the membrane filtration system 12 as a very high quality, sterile, chlorine free product. This permeate stream 22 supplies the demineralization feed-water 28 to the demineralization system 38 at the plant.

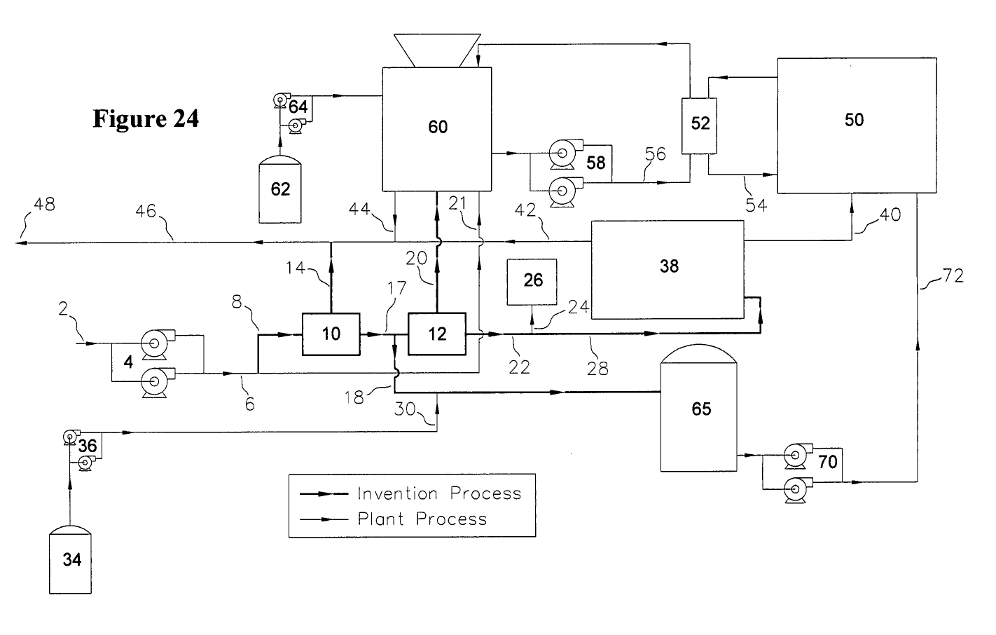

Description: FIG. 24

Direct to obtaining the effect of the invention, FIG. 24 illustrates an embodiment of the invention at a typical thermal power plant. This embodiment of the invention receives a pressured raw water stream and provides; chlorinated mechanical filtrate for plant service water, un-chlorinated membrane reject water for primary cooling tower make-up water, un-chlorinated raw water for secondary cooling tower make-up water and un-chlorinated membrane permeate as both demineralization feed-water and potable water system feed-water.

The line legend on FIG. 24 delineates the process flow and relevant system components of the invention with solid heavy lines with broken arrows and the thermal power plant process flow and relevant system components in solid thin lines. The reader should note; power plants typically configure pumps in a duplex format so as to facilitate reliability. This practice is presented in this figure. In deference to reducing reiteration, the reference in this document to a pump or pumping system should be assumed by the reader as indicative of a duplex configuration, unless otherwise stated.

The figure presents a generalized water cycle of a thermal power plant. The power plant is cooled by a cooling tower 60. A circulating cooling water stream 56 is pressured and driven by a circulating water pump 58. The circulating cooling water stream 56 provides cooling to a heated gas or fluid 54 originating from a power house 50. The cooling is facilitated by a circulating water contacted heat exchanger 52. The water chemistry of the circulating water 56 from the cooling tower 60 is maintained in three fashions; first by a consortium of chemicals 62 dispensed via a dosage controlled chemical pumping system 64, second, by discharge of cooling tower 60 water by means of a blow-down stream 44 to waste and third, by a fresh feed-water make-up 20 and 21. A demineralization system 38 provides demineralized water 40 to the power house 50 for various applications. A demineralization system reject wastewater stream 42 is combined with the cooling tower blow-down 44 and conveyed as a plant wastewater stream 46 for elimination at a plant discharge site 48.

There are four main dispensations of water at the power plant. The first is a high quality feed-water 28 for the plant demineralization system 38. The second is a chlorinated, good quality plant service water 72 for wash down and general utility use. The third is the make-up water 20 and 21 for the cooling tower 60. The fourth is a high quality feed-water 24 for a plant potable water system 26.

The invention relates to the water cycle process of the plant. The reader is directed toward the heavy solid lines with broken arrows of FIG. 24. These lines represent the process and components of the invention. In this, the preferred embodiment of the invention, raw water is supplied to the invention from a source 2 after being pressured in a raw water feed pump 4. A pressured raw water stream 6 is conveyed as a secondary make-up water 21 to the plant cooling tower 60. A pressured side-stream 8 is extracted from the pressured raw water stream 6 and supplies the invention. Side-stream 8 conveys water to a mechanical filtration system 10. Suspended solids are mechanically extracted from the water and a good quality filtrate 17 is conveyed in two directions; the preponderance of the filtrate 17 is directed into a membrane filtration system 12, while the remainder of the filtrate 17 is discharged as a side-stream 18. Solids collected by the mechanical filtration system 10, are discharged as a waste stream 14 to the plant waste discharge stream 46 for disposal at the plant discharge site 48. A chlorinating chemical 34, such as sodium hypochlorite, is dispensed via a dosage controlled chemical pump 36, and delivered 30 into the filtrate side-stream 18. The resulting chlorinated filtrate stream is conveyed to a storage tank 65 for eventual use as plant service water 72. Water from this tank is pressured through a plant service water pump system 70 and conveyed as the plant service water 72 serving the plant 50

The membrane filtration system 12 receives the filtrate stream 17 at a high rate of flow. The filtrate stream 17 is conducted across membrane surfaces of the membrane filtration system 12 in a high velocity, cross-flow mode to secure cleansing of the membrane filtration system 12. The filtrate 17 is applied in a single pass manner, affording it as a good quality, mechanically filtered reject water 16 profiting the power plant as a good quality, primary make-up water 20 to the cooling tower 60. The cooling tower 60 is delivered a lower quality, secondary make-up water 21 which is provided from the raw water stream 6 as is needed to supplement the good quality primary make-up water 20.

A permeate stream 22 exits the membrane filtration system 12 as a very high quality, sterile, chlorine free product. This permeate stream 22 supplies both the feed-water 24 to the potable water system 26 and the demineralization feed-water 28 to the demineralization system 38 at the plant.

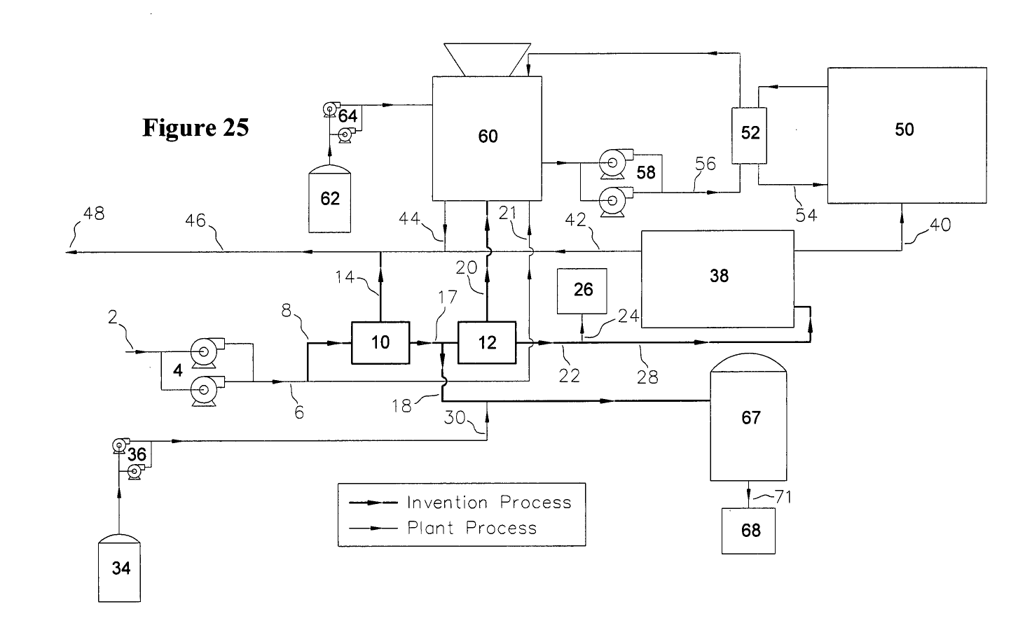

Description: FIG. 25

Direct to obtaining the effect of the invention, FIG. 25 illustrates an embodiment of the invention at a typical thermal power plant. This embodiment of the invention receives a pressured raw water stream and provides; chlorinated mechanical filtrate for plant fire protection water, un-chlorinated membrane reject water for primary cooling tower make-up water, un-chlorinated raw water for secondary cooling tower make-up water and un-chlorinated membrane permeate as both demineralization feed-water and potable water system feed-water.

The line legend on FIG. 25 delineates the process flow and relevant system components of the invention with solid heavy lines with broken arrows and the thermal power plant process flow and relevant system components in solid thin lines. The reader should note; power plants typically configure pumps in a duplex format so as to facilitate reliability. This practice is presented in this figure. In deference to reducing reiteration, the reference in this document to a pump or pumping system should be assumed by the reader as indicative of a duplex configuration, unless otherwise stated.

The figure presents a generalized water cycle of a thermal power plant. The power plant is cooled by a cooling tower 60. A circulating cooling water stream 56 is pressured and driven by a circulating water pump 58. The circulating cooling water stream 56 provides cooling to a heated gas or fluid 54 originating from a power house 50. The cooling is facilitated by a circulating water contacted heat exchanger 52. The water chemistry of the circulating water 56 from the cooling tower 60 is maintained in three fashions; first by a consortium of chemicals 62 dispensed via a dosage controlled chemical pumping system 64, second, by discharge of cooling tower 60 water by means of a blow-down stream 44 to waste and third, by a fresh feed-water make-up 20 and 21. A demineralization system 38 provides demineralized water 40 to the power house 50 for various applications. A demineralization system reject wastewater stream 42 is combined with the cooling tower blow-down 44 and conveyed as a plant wastewater stream 46 for elimination at a plant discharge site 48.

There are four main dispensations of water at the power plant. The first is a high quality feed-water 28 for the plant demineralization system 38. The second is the make-up water 20 and 21 for the cooling tower 60. The third is a chlorinated, good quality feed-water 71 for a power plant fire protection system 68. The fourth is a high quality feed-water 24 for a plant potable water system 26.

The invention relates to the water cycle process of the plant. The reader is directed toward the heavy solid lines with broken arrows of FIG. 25. These lines represent the process and components of the invention. In this, the preferred embodiment of the invention, raw water is supplied to the invention from a source 2 after being pressured in a raw water feed pump 4. A pressured raw water stream 6 is conveyed as a secondary make-up water 21 to the plant cooling tower 60. A pressured side-stream 8 is extracted from the pressured raw water stream 6 and supplies the invention. Side-stream 8 conveys water to a mechanical filtration system 10. Suspended solids are mechanically extracted from the water and a good quality filtrate 17 is conveyed in two directions; the preponderance of the filtrate 17 is directed into a membrane filtration system 12, while the remainder of the filtrate 17 is discharged as a side-stream 18. Solids collected by the mechanical filtration system 10, are discharged as a waste stream 14 to the plant waste discharge stream 46 for disposal at the plant discharge site 48. A chlorinating chemical 34, such as sodium hypochlorite, is dispensed via a dosage controlled chemical pump 36, and delivered 30 into the filtrate side-stream 18. The resulting chlorinated filtrate stream is conveyed to the storage tank 67 for eventual use as the plant fire protection water system feed-water 71. The plant fire protection system 68 is provided feed-water 71 from the tank 66.

The membrane filtration system 12 receives the filtrate stream 17 at a high rate of flow. The filtrate stream 17 is conducted across membrane surfaces of the membrane filtration system 12 in a high velocity, cross-flow mode to secure cleansing of the membrane filtration system 12. The filtrate 17 is applied in a single pass manner, affording it as a good quality, mechanically filtered reject water 16 profiting the power plant as a good quality, primary make-up water 20 to the cooling tower 60. The cooling tower 60 is delivered a lower quality, secondary make-up water 21 which is provided from the raw water stream 6 as is needed to supplement the good quality primary make-up water 20.

A permeate stream 22 exits the membrane filtration system 12 as a very high quality, sterile, chlorine free product. This permeate stream 22 supplies both the feed-water 24 to the potable water system 26 and the demineralization feed-water 28 to the demineralization system 38 at the plant.

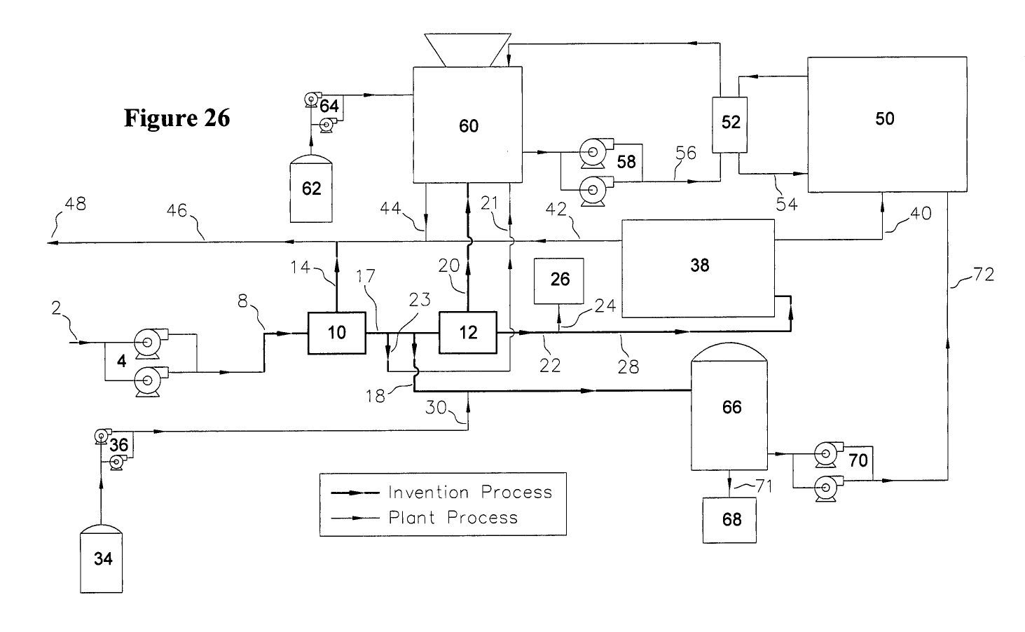

Description: FIG. 26

Direct to obtaining the effect of the invention, FIG. 26 illustrates an embodiment of the invention at a typical thermal power plant. This embodiment of the invention receives a pressured raw water stream and provides; chlorinated mechanical filtrate for plant service water, chlorinated mechanical filtrate for plant fire protection water, un-chlorinated membrane reject water for primary cooling tower make-up water, un-chlorinated mechanical filtrate for secondary cooling tower make-up water and un-chlorinated membrane permeate as both demineralization feed-water and potable water system feed-water.

The line legend on FIG. 26 delineates the process flow and relevant system components of the invention with solid heavy lines with broken arrows and the thermal power plant process flow and relevant system components in solid thin lines. The reader should note; power plants typically configure pumps in a duplex format so as to facilitate reliability. This practice is presented in this figure. In deference to reducing reiteration, the reference in this document to a pump or pumping system should be assumed by the reader as indicative of a duplex configuration, unless otherwise stated.

The figure presents a generalized water cycle of a thermal power plant. The power plant is cooled by a cooling tower 60. A circulating cooling water stream 56 is pressured and driven by a circulating water pump 58. The circulating cooling water stream 56 provides cooling to a heated gas or fluid 54 originating from a power house 50. The cooling is facilitated by a circulating water contacted heat exchanger 52. The water chemistry of the circulating water 56 from the cooling tower 60 is maintained in three fashions; first by a consortium of chemicals 62 dispensed via a dosage controlled chemical pumping system 64, second, by discharge of cooling tower 60 water by means of a blow-down stream 44 to waste and third, by a fresh feed-water make-up 20 and 21. A demineralization system 38 provides demineralized water 40 to the power house 50 for various applications. A demineralization system reject wastewater stream 42 is combined with the cooling tower blow-down 44 and conveyed as a plant wastewater stream 46 for elimination at a plant discharge site 48.

There are five main dispensations of water at the power plant. The first is a high quality feed-water 28 for the plant demineralization system 38. The second is a chlorinated, good quality plant service water 72 for wash down and general utility use. The third is good quality make-up water 20 and 21 for the cooling tower 60. The fourth is a chlorinated, good quality feed-water 71 for a power plant fire protection system 68. The fifth is a high quality feed-water 24 for a plant potable water system 26.

In this embodiment a single storage tank 66 provides two of the five dispensations of water at the plant; the plant service water 72 and the fire protection system feed-water 71.

The invention relates to the water cycle process of the plant. The reader is directed toward the heavy solid lines with broken arrows of FIG. 26. These lines represent the process and components of the invention. In this embodiment of the invention, raw water is supplied to the invention from a source 2 after being pressured in a raw water feed pump 4. A pressured raw water stream 8 supplies the invention. Water stream 8 conveys water to a mechanical filtration system 10. Suspended solids are mechanically extracted from the water and a good quality filtrate 17 is conveyed in three directions; into a membrane filtration system 12, as a side-stream 18 directed toward the storage tank 66 and as a side-stream 23 which supplies a secondary cooling tower make-up stream 21. Solids collected by the mechanical filtration system 10, are discharged as a waste stream 14 to the plant wastewater stream 46 for disposal at the plant discharge site 48. A chlorinating chemical 34, such as sodium hypochlorite, is dispensed via a dosage controlled chemical pump 36, and delivered 30 into the filtrate side-stream 18. This chlorinated filtrate stream is then delivered to the storage tank 66. Water from this tank is pressured and conveyed through a plant service water pump system 70 and conveyed as plant service water 72 serving the plant 50. Feed-water 71 is supplied by this tank for the plant fire protection system 68.

The membrane filtration system 12 receives the filtrate stream 17 at a high rate of flow. The filtrate stream 17 is conducted across membrane surfaces of the membrane filtration system 12 in a high velocity, cross-flow mode to secure cleansing of the membrane filtration system 12. The filtrate 17 is applied in a single pass manner, affording it as a good quality reject water 16 profiting the power plant as a good quality primary make-up water 20 to the cooling tower 60. The cooling tower 60 is also delivered the secondary make-up water stream 21 from the mechanical filtrate side-stream 23 as is needed to supplement the primary make-up water 20.

A permeate stream 22 exits the membrane filtration system 12 as a very high quality, sterile, chlorine free product. This permeate stream 22 supplies both the feed-water 24 to the potable water system 26 and the demineralization feed-water 28 to the demineralization system 38 at the plant.

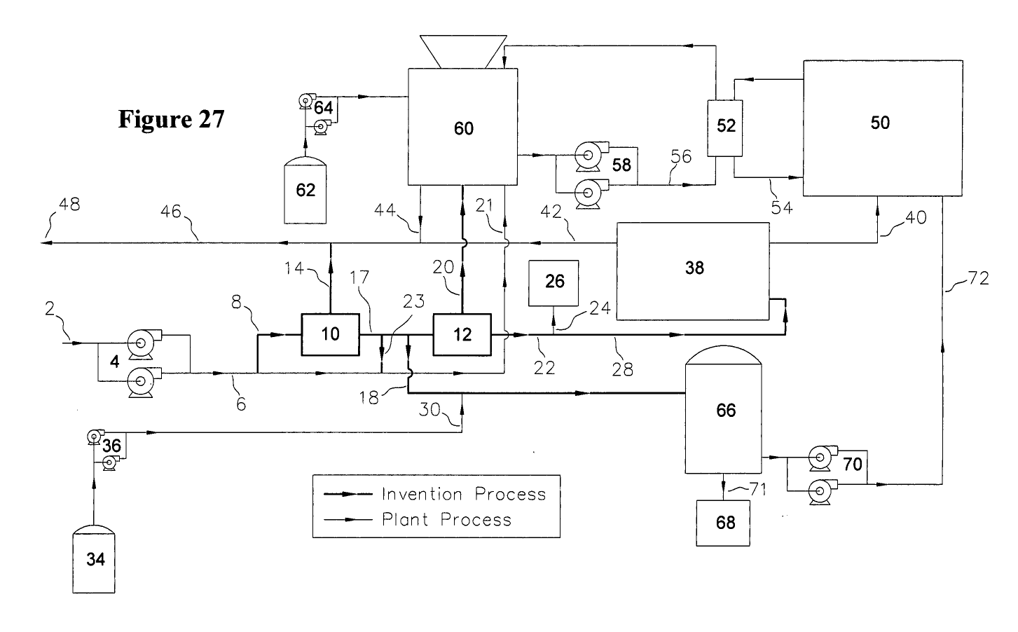

Description: FIG. 27

Direct to obtaining the effect of the invention, FIG. 27 illustrates an embodiment of the invention at a typical thermal power plant. This embodiment of the invention receives a pressured raw water stream and provides; chlorinated mechanical filtrate for plant service water, chlorinated mechanical filtrate for plant fire protection water, un-chlorinated membrane reject water for primary cooling tower make-up water, un-chlorinated mechanical filtrate for secondary cooling tower make-up water and un-chlorinated membrane permeate as both demineralization feed-water and potable water system feed-water.

The line legend on FIG. 27 delineates the process flow and relevant system components of the invention with solid heavy lines with broken arrows and the thermal power plant process flow and relevant system components in solid thin lines. The reader should note; power plants typically configure pumps in a duplex format so as to facilitate reliability. This practice is presented in this figure. In deference to reducing reiteration, the reference in this document to a pump or pumping system should be assumed by the reader as indicative of a duplex configuration, unless otherwise stated.

The figure presents a generalized water cycle of a thermal power plant. The power plant is cooled by a cooling tower 60. A circulating cooling water stream 56 is pressured and driven by a circulating water pump 58. The circulating cooling water stream 56 provides cooling to a heated gas or fluid 54 originating from a power house 50. The cooling is facilitated by a circulating water contacted heat exchanger 52. The water chemistry of the circulating water 56 from the cooling tower 60 is maintained in three fashions; first by a consortium of chemicals 62 dispensed via a dosage controlled chemical pumping system 64, second, by discharge of cooling tower 60 water by means of a blow-down stream 44 to waste and third, by a fresh feed-water make-up 20 and 21. A demineralization system 38 provides demineralized water 40 to the power house 50 for various applications. A demineralization system reject wastewater stream 42 is combined with the cooling tower blow-down 44 and conveyed as a plant wastewater stream 46 for elimination at a plant discharge site 48.

There are five main dispensations of water at the power plant. The first is a high quality feed-water 28 for the plant demineralization system 38. The second is a chlorinated, good quality plant service water 72 for wash down and general utility use. The third is the make-up water streams 20 and 21 for the cooling tower 60. The fourth is a chlorinated, good quality feed-water 71 for a power plant fire protection system 68. The fifth is a high quality feed-water 24 for a plant potable water system 26.

In this embodiment a single storage tank 66 provides two of the five dispensations of water at the plant; the plant service water 72 and the fire protection system feed-water 71.

The invention relates to the water cycle process of the plant. The reader is directed toward the heavy solid lines with broken arrows of FIG. 27. These lines represent the process and components of the invention. In this embodiment of the invention, raw water is supplied to the invention from a source 2 after being pressured in a raw water feed pump 4. A pressured raw water stream 6 is conveyed as a secondary make-up water 21 to the plant cooling tower 60. A pressured side-stream 8 is extracted from the pressured raw water stream 6 and supplies the invention. Side-stream 8 conveys water to a mechanical filtration system 10. Suspended solids are mechanically extracted from this water and a good quality filtrate 17 is conveyed in three directions; into a membrane filtration system 12, as a side-stream 18 directed towards the storage tank 66 and as a as side-stream 23 which blends with the raw water stream 6 to supply the secondary cooling tower make-up stream 21. Solids collected by the mechanical filtration system 10, are discharged as a waste stream 14 to the plant wastewater stream 46 for disposal at the plant discharge site 48. A chlorinating chemical 34, such as sodium hypochlorite, is dispensed via a dosage controlled chemical pump 36, and delivered 30 into the filtrate side-stream 18. This chlorinated filtrate stream is then delivered to the storage tank 66. Water from this tank is pressured and conveyed through a plant service water pump system 70 and conveyed as the plant service water 72 serving the plant 50. Feed-water 71 is supplied by this tank for the plant fire protection system 68.

The membrane filtration system 12 receives the filtrate stream 17 at a high rate of flow. The filtrate stream 17 is conducted across membrane surfaces of the membrane filtration system 12 in a high velocity, cross-flow mode to secure deansing of the membrane filtration system 12. The filtrate 17 is applied in a single pass manner, affording it as a good quality reject water 16 profiting the power plant as a good quality primary make-up water 20 to the cooling tower 60. The cooling tower 60 is also delivered the secondary make-up water stream 21 from a combination of mechanical filtrate side-stream 23 and raw water 6 as is needed to supplement the primary make-up water 20.

A high quality permeate stream 22 exits the membrane filtration system 12 as a very high quality, sterile, chlorine free product. This permeate stream 22 supplies both the feed-water 24 to the potable water system 26 and the demineralization feed-water 28 to the demineralization system 38 at the plant.

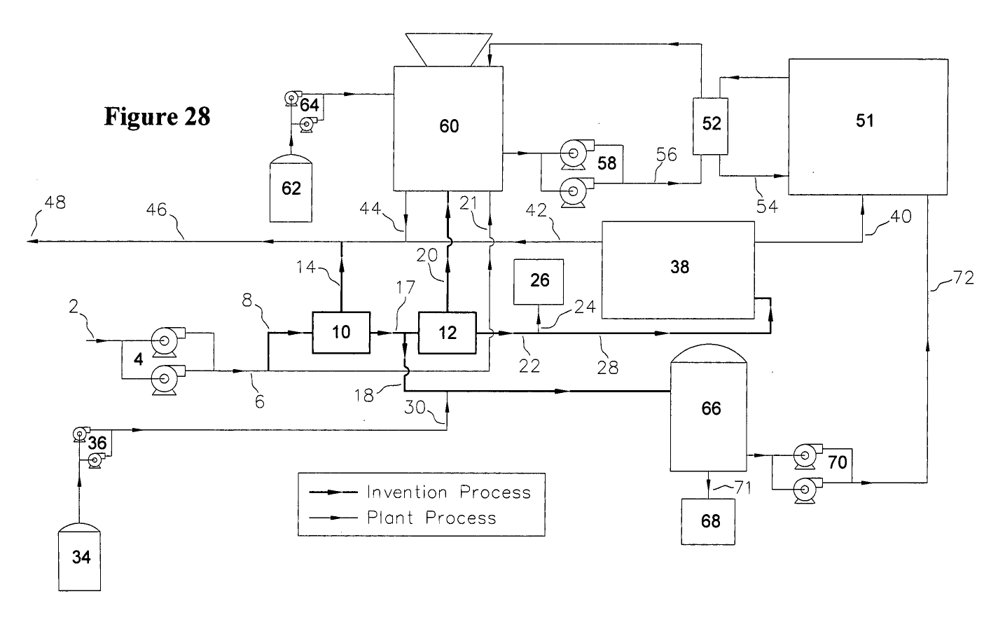

Description: FIG. 28

Direct to obtaining the effect of the invention, FIG. 28 illustrates an embodiment of the invention at an industrial plant. This of the invention receives a pressured raw water stream and provides; chlorinated mechanical filtrate for industrial plant service water, chlorinated mechanical filtrate for the industrial plant fire protection water, un-chlorinated membrane reject water for primary cooling tower make-up water, un-chlorinated raw water for secondary cooling tower make-up water and un-chlorinated membrane permeate as both feed-water for the industrial plant demineralization system and feed-water for the potable water system of the industrial plant.

The line legend on FIG. 28 delineates the process flow and relevant system components of the invention with solid heavy lines with broken arrows and the industrial plant process flow and relevant system components in solid thin lines. The reader should note; many industrial plants typically configure pumps in a duplex format so as to facilitate reliability. This practice is presented in this figure. In deference to reducing reiteration, the reference in this document to a pump or pumping system should be assumed by the reader as indicative of a duplex configuration, unless otherwise stated.

The figure presents a generalized water cycle of an industrial plant. The plant is cooled by a cooling tower 60. A circulating cooling water stream 56 is pressured and driven by a circulating water pump 58. The circulating cooling water stream 56 provides cooling to a heated gas or fluid 54 originating from the industrial plant 51. The cooling is facilitated by a circulating water contacted heat exchanger 52. The water chemistry of the circulating water 56 from the cooling tower 60 is maintained in three fashions; first by a consortium of chemicals 62 dispensed via a dosage controlled chemical pumping system 64, second, by discharge of cooling tower 60 water by means of a blow-down stream 44 to waste and third, by a fresh feed-water make-up 20 and 21. A demineralization system 38 provides demineralized water 40 to the industrial plant 51 for various applications. A demineralization system reject wastewater stream 42 is combined with the cooling tower blow-down 44 and conveyed as a mixed wastewater stream 46 for elimination at a plant discharge site 48.

There are five main dispensations of water at the industrial plant. The first is a high quality feed-water 28 for the industrial plant demineralization system 38. The second is a chlorinated, good quality industrial plant service water 72 for wash down and general utility use. The third is the make-up water 20 and 21 for the cooling tower 60. The fourth is a chlorinated, good quality feed-water 71 for a fire protection system 68. The fifth is a high quality feed-water 24 for a potable water system 26.

In this, the preferred embodiment, a single storage tank 66 provides two of the five dispensations of water at the industrial plant; the industrial plant service water 72 and the fire protection system feed-water 71.

The invention relates to the water cycle process of the industrial plant. The reader is directed toward the heavy solid lines with broken arrows of FIG. 2. These lines represent the process and components of the invention. In this, the preferred embodiment of the invention, raw water is supplied to the invention from a source 2 after being pressured in a raw water feed pump 4. A pressured raw water stream 6 is conveyed as a secondary make-up water 21 to the plant cooling tower 60. A pressured side-stream 8 is extracted from the pressured raw water stream 6 and supplies the invention. Side-stream 8 conveys water to a mechanical filtration system 10. Suspended solids are mechanically extracted from this water and a good quality filtrate 17 is conveyed in two directions; the preponderance of the filtrate 17 is directed into a membrane filtration system 12, while the remainder of the filtrate 17 is discharged as a side-stream 18. Solids collected by the mechanical filtration system 10, are discharged as a waste stream 14 to the plant wastewater stream 46 for disposal at the plant discharge site 48. A chlorinating chemical 34, such as sodium hypochlorite, is dispensed via a dosage controlled chemical pump 36, and delivered 30 into the filtrate side-stream 18. The resulting chlorinated filtrate stream is then delivered to the storage tank 66 for eventual use as the plant fire protection water system feed-water 71 and the plant service water 72. Water from this tank is pressured through a plant service water pump system 70 and conveyed as the plant service water 72 serving the industrial plant 51. The plant fire protection water system 68 is provided water 71 from tank 66.

The membrane filtration system 12 receives the good quality filtrate stream 17 at a high rate of flow. The filtrate stream 17 is conducted across membrane surfaces of the membrane filtration system 12 in a high velocity, cross-flow mode to secure cleansing of the membrane filtration system 12. The filtrate 17 is applied in a single pass manner, affording it as a good-quality reject water 16 profiting the industrial plant as a good quality primary make-up water 20 to the cooling tower 60. The cooling tower 60 is also delivered the secondary make-up water 21 which is provided from the water stream 6 as is needed to supplement the primary make-up water 20.

A permeate stream 22 exits the membrane filtration system 12 as a very high quality, sterile, chlorine free product. This permeate stream 22 supplies both the feed-water 24 to the potable water system 26 and the demineralization feed-water 28 to the demineralization system 38 at the industrial plant.

### CONCLUSION, RAMIFICATIONS, AND SCOPE

The reader will see that the invention provides a simple and reliable means to improve upon the chemically based clarifier processes of the prior art. The invention eliminates the disadvantages associated with the clarifier processes and purveys substantial advantages not offered by the prior art.
In contrast to the prior art, the Invention does not require the use of hazardous, corrosive and expensive chemicals. Thereby the invention provides an improved means to generate better quality water without the expense and liabilities associated with the employ of chemicals.
The invention eliminates the capital expense burden of the prior art associated with the chemical receiving and storage facilities and the mandatory environmental protective containment about these facilities.
The invention eliminates the disadvantages of the prior art associated with personnel and labor liabilities engendered by the transfer and handling of the essential but hazardous chemicals required of the prior art.
The invention does not bear the expense incurred by the prior art relating to safety training and certification of personnel to operate with the essential but hazardous chemicals required of the prior art.
The invention's substantial advantage of not employing the chemicals, which are essential to the prior art, affords the elimination of the capital and operating expenses associated with the specialized and costly equipment necessary to pump, control, measure and transport these very corrosive, difficult to handle chemicals.
The capital and operating expenses associated with tank heating, pipe heat tracing and/or thermal enclosure of those systems in contact with the thermally sensitive chemicals required of the prior art are eliminated.
The invention eliminates a the major disadvantages of the prior art wherein performance upsets and corresponding degradation of operational reliability occurs when the finely balanced chemical processes, inherent to the clarifiers of the prior art, are set askew as a consequence of variations in the feed-water constituents or operating temperatures.
The skilled and expensive labor necessary for successful operation of the prior art is eliminated. The majority of applications of the prior art employ surface water as a feed-water source. Surface water constituents and temperatures change daily as well as seasonally. Accordingly, and as a significant disadvantage of the prior art, is the necessity to employ operating personnel which are adequately trained in the science of water chemistry and available to diligently monitor the feed-water and operating characteristics. These personnel must be sufficiently educated and skilled to adjust chemical dosages, flow rates or other parameters as are necessary to minimize the magnitude or frequency of upsets resulting from feed-water or operating condition changes. This is a labor intensive, and expensive burden upon the prior art which is not shared by the invention.
In contrast to the prior art, the invention does not employ chemical balances and, in contrast to the prior art, is therefore not prone to upsets resulting from variations in feed-water constituents or operating temperatures.
The operating insensitivity of the invention eliminates the upset frequency and the resultant stigma of unreliability which plagues the prior art. Upsets with the prior art can take several days to be resolved. Closure of the plant, due to lack of quality water, may be necessary during this period. Such closure is the ultimate expense. The invention is unaffected by the variations which cause clarifier based process upsets and possible plant downtime. Accordingly, the invention purveys the advantage of truly reliable delivery of quality water to service the plant.
The invention finally provides a means to produce higher quality water than the prior art without the generation of sludge. Environmental concerns and the associated liabilities are primary ethical and financial concerns in modern industry. The generation, storage and ultimate disposal of the clarifier sludge are serious problems and represent major disadvantages to the prior art. These sludges are chemical and metal laced and generally dassified for disposal as hazardous waste. The handling and disposal of sludge has long been viewed as a normal operating expense and an unfortunate, but necessary, liability associated with industry. The invention eliminates the operating costs associated with storage, handling and disposal of the sludge.
Since there is no sludge generation, the invention eliminates the environmental liabilities engendered by the generation, storage, transport and disposal of clarifier sludge.
Since there is no sludge generation, the invention eliminates the capital expenses related to site work required for environmentally secure sludge storage as well as the costs for equipment necessary for storage, handling and transport of the sludge.
In contrast to the prior art, the invention does not require pumps or associated equipment. The clarifier processes of the prior art are open processes which require re-pressurization between the various process stages. Accordingly, the processes of the prior art demand 1a complicated consortium of valves filters, pumps, tanks, sumps, level controls, support pads and piping. Much of this equipment is dual configured to facilitate standby reliability. This practice serves to double the already high capital expense associated with the complex configurations necessitated by the prior art. In contrast, the invention is a closed system employing the make-up water line pressure to supply the operating pressure of the invention. This provides the invention with the important and cost effective advantage of eliminating the capital and operating expenses associated with pumps and related controls.
The closed nature of the invention further eliminates the requirements for receiving sumps or tanks as well as the level sensors and controls associated thereof. Accordingly, the invention is un-burdened by the capital expense associated with any sumps or receiving tanks or any related instrumentation or controls.
The invention is not burdened by the large physical size required of the prior art which in addition to high expense often presents difficulties with sufficient plant space. The chemical processes of the prior art employ agglomeration and settling. Both agglomeration and settling processes require time. Accordingly, the clarifiers of the prior art require large containment areas to produce both long chemical agglomeration times and sufficient quiescence to facilitate settling of the agglomerated solids. A common problem associated with the clarifier based processes of the prior art pertains to the physical size demands of the clarifier as well as to the size demands for the receiving sumps dictated by the open nature of the prior art. The invention generally requires less than 10% of the space required by the prior art. Such space can be very valuable at many plant sites.
The much smaller configuration of the invention also eases growth issues. Simple augmentation of the invention easily services higher water demands from the plant In contrast, augmentation of the prior art usually requires a bigger clarifier. This is a nearly impossible consideration for many sites because of confined space issues.
The invention generates a much higher water quality than that purveyed by the prior art. The chemical based clarifier technology of the prior art can only remove those suspended solids with an affinity toward the coagulating and flocculating chemicals of the prior art. The water quality produced is often sufficiently good for use as plant service water, fire protection water and, with further treatment, potable water. The high water quality demands of modern industry, especially as feed-water to demineralization systems, prefer water of a quality greater than that as provided by the prior art. In such a situation the plant has no choice but to accept the clarifier based treatment of the prior art, as the best available, and accordingly perform maintenance and cleaning as often as is required to facilitate successful operation of the demineralization system. The invention overcomes this disadvantage.
The invention does not require the use of polymers. In many applications of the prior art, cationic polymers must be employed in the clarifier to provide a water quality that is of a sufficient grade for use as feed to a demineralization system. The difficulty experienced under these operations is that the reverse osmosis membranes typically present in most demineralization systems, become damaged by any cationic polymer carryover from the clarifier. Therefore a delicate balancing act must be followed wherein there must be sufficient cationic polymer supplied to the clarifier to generate a feed-water of sufficient quality for the demineralization system but not so much as to imbue cationic polymer carry over into the demineralization system. In such situations, diligent monitoring of the clarifier and associated chemistry is essential to minimize the possibility of overdosing or mistakenly delivering improperly hydrated polymer into the clarifier. Inevitably mistakes or malfunctions occur and/or the feed-water varies in a manner which prompts the delivery of excess cationic polymer to the clarifier, resulting in carryover to the demineralization system and the consequential plugging of the reverse osmosis membranes. This problem does not exist with the invention.
The invention does not require the use of iron salts or other coagulants. A common difficulty associated with the clarifier based processes of the prior art occur where iron salts, such as ferric chloride or ferric sulfate, are used as a chemical coagulant. It is necessary that sufficient iron salts are employed to provide a water quality that is of adequate grade for feed to a demineralization system. This is a delicate balance. Insufficient iron salt dosing will result in poor water quality. Excess iron salts will carryover from the clarifier and result in plugging and fouling of the reverse osmosis membranes in the demineralization system. In such situations, diligent monitoring of the clarifier and associated chemistry is essential to minimize the possibility of over or under dosing iron salts into the clarifier. Inevitably, mistakes or malfunctions occur and/or variations of the feed-water constituents may result in the delivery of excess or insufficient iron salts, resulting plugging of the reverse osmosis membranes or inadequate water quality delivery from the clarifier. This problem does not exist with the invention.
The invention purveys a further advantage that is not available from the prior art. The invention employs feed-water directly from the raw make-up water line. The invention withdraws this water from the make-up water line at a rate substantially in excess of the cumulative needs of the plant service water, the plant fire protection water, the potable water system (if present) and the demineralization system needs. This excess water is applied for high volume cleansing flow across the membrane constituents of the invention. This cross-flowing water has been mechanically filtered prior to contact with the membrane filters. Accordingly, the majority of the suspended solids mass has been removed and, even with the small addition of solids cleansed from the membranes in the single high velocity pass, the resulting reject water product is of a much higher quality than the raw make-up water from which it was sourced. This product is directed as the primary make-up feed to the cooling tower. The raw make-up water, which in the prior art serves as the primary water source to the cooling tower, operates only in a secondary fashion. The raw make-up water being strictly employed by the invention to fulfill the cooling tower water volumetric requirements not sufficiently met by the membrane reject water product. The invention thereby providing an overall water quality supplied to the cooling tower substantially improved over the untreated cooling tower feed-water corresponding to the prior art. An advantage affording improved operating performance of the cooling tower, a reduction of the required cooling tower treatment chemicals, and a reduction of the expenses and labor associated with cleaning and maintenance of the cooling tower and any associated circulating water contacted cooling apparatus.

While the foregoing discussions specify the many advantages inherent to the invention these do not constitute the full scope of advantages. There are many advantages beyond those defined herein. In a similar manner, the preferred and additional embodiments described in the foregoing, are certainly not the only embodiment possible. In addition to the many possible combinations of the foregoing embodiments, other embodiments are possible. Some, though certainly not all, examples of other embodiments and advantages are as follows:

Applications wherein water consuming appliances, other than cooling towers can be certainly construed.

Applications wherein the water consuming appliances are not present but rather wherein the membrane reject water goes directly to discharge can certainly also be construed.

The design and size of the demineralization system can be reduced as a result of the higher quality feed-water to the demineralization system. With cleaner feed-water, a higher flux through the membranes is possible thereby reducing the required reverse osmosis system size. A further ramification is that the reject to permeate ratios of the reverse osmosis membranes of the demineralization systems can be reduced because of the higher quality feed-water provided by the invention. This has the decided advantage of saving water and reducing waste discharge.

The provision of higher quality feed-water to the cooling towers can provide a benefit of reducing the amount of required cooling tower blow-down. This capability has the decided advantage of saving water and reducing waste discharge; presenting advantages from both an economic as well as an environmental standpoint.

The ability to generate higher quality water imbues the invention with a potential for employing water sources which would otherwise be not usable with the prior art. This could provide the ability to locate plants at sites which would otherwise be inconceivable with the prior art; thereby providing economic and environmental benefits not otherwise possible.

Clearly, the scope, ramifications and potential of the invention are well beyond the discussions of this document and therefore the true scope and delineation of the invention must be established by the appended claims and their legal equivalents, rather than the examples provided herein

1. A process for providing water products for an industrial plant comprised of a pressured filtration system, an inlet conveyance from a pressured source, an outlet conveyance for a high quality water product, an outlet conveyance for a waste products stream and an outlet conveyance for a medium quality water product, wherein water from said pressured source enters said pressured filtration system by means of said inlet conveyance. Wherein said filtration system provides a high quality water product to said outlet conveyance for said high quality water product, wherein said filtration system provides a medium quality water product to said outlet conveyance for said medium quality water product and wherein said filtration system provides a waste products stream to said outlet conveyance for waste products.

2. The process of claim 1 wherein said medium quality water product is directed from said first medium quality water product outlet conveyance to provide a water source for a plant service water system.

3. The process of claim 1 wherein said medium quality water product is directed from said medium quality water product outlet conveyance to provide a water source for a plant fire protection water system.

4. The process of claim 1 wherein said medium quality water product is directed from said medium quality water product outlet conveyance to provide a make-up water source for a plant cooling tower system.

5. The process of claim 1 wherein said high quality water product from said high quality water product outlet conveyance is directed to provide a water source for a plant demineralization system.

6. The process of claim 1 wherein said high quality water product from said high quality water product outlet conveyance is directed to provide a water source for a plant potable water system.

7. The process of claim 1 wherein the said industrial plant is a thermal power plant.

8. The process of claim 1 wherein a pressurization pump is provided to boost the pressure at said inlet conveyance.

9. A process for providing water products for an industrial plant comprised of a multi-stage filtration system, an inlet conveyance from a pressured source, an outlet conveyance of a first medium quality water product, an outlet conveyance of a high quality water product, an outlet conveyance for a waste products stream and an outlet conveyance of a second medium quality water product, wherein said multistage pressured filtration system receives pressured water from said inlet conveyance and provides a medium quality filtrate to said first medium quality water product outlet conveyance. Wherein waste products from said multistage filtration system provides waste products to said waste product outlet conveyance, wherein said multistage filtration system provides a high quality water product to said conveyance for the high quality water product and wherein the multistage filtration system provides a reject water stream to said outlet conveyance for the second medium quality water product.

10. The process of claim 9 wherein said first medium quality water product is directed from said first medium quality water product outlet conveyance to provide a water source for a plant service water system.

11. The process of claim 9 wherein said first medium quality water product is directed from said first medium quality water product outlet conveyance to provide a water source for a plant fire protection water system.

12. The process of claim 9 wherein said first medium quality water product is directed from said first medium quality water product outlet conveyance to provide a make-up water source for a plant cooling tower system.

13. The process of claim 9 wherein said second medium quality water product is directed from said second medium quality water product outlet conveyance to provide a water source for a plant service water system.

14. The process of claim 9 wherein said second medium quality water product is directed from said second quality water product outlet conveyance to provide a water source for a plant fire protection water system.

15. The process of claim 9 wherein said second medium quality water product is directed from said second medium quality water product outlet conveyance to provide a make-up water source for a plant cooling tower system.

16. The process of claim 9 wherein said high quality water product from said high quality water product outlet conveyance is directed to provide a water source for a plant demineralization system.

17. The process of claim 9 wherein said high quality water from said high quality water product outlet conveyance is directed to provide a water source for a plant potable water system.

18. The process of claim 9 wherein the said industrial plant is a thermal power plant.

19. The process of claim 9 wherein a pressurization pump is provided to boost the pressure at said inlet conveyance.

20. A process for providing water products for an industrial plant comprised of an inlet conveyance from a pressured water source, a pressured multistage filtration system comprised of a mechanical filtration stage and a single pass, cross-flow, membrane filtration stage, a mechanical filtrate outlet conveyance, an outlet conveyance for a filtration system back-flush waste product, a membrane permeate outlet conveyance and a membrane reject outlet conveyance. Wherein said mechanical filtration stage receives pressured water from said inlet conveyance and provides filtrate to said mechanical filtrate outlet conveyance and as a feed-water to said membrane filtration stage, wherein permeate from said membrane filtration stage provides permeate for said membrane permeate outlet conveyance and wherein reject water from said membrane filtration stage provides reject water to said membrane reject outlet conveyance.

21. The process of claim 20 wherein said mechanical filtrate is directed from said mechanical filtrate outlet conveyance to provide a water source for a plant service water system.

22. The process of claim 20 wherein said mechanical filtrate is directed from said mechanical filtrate outlet conveyance to provide a water source for a plant fire protection water system.

23. The process of claim 20 wherein said mechanical filtrate is directed from said mechanical filtrate outlet conveyance to provide a make-up water source for a plant cooling tower system.

24. The process of claim 20 wherein said reject water from said membrane filtration stage is directed from said reject outlet conveyance to provide a water source for a plant service water system.

25. The process of claim 20 wherein said reject water from said membrane filtration stage is directed from said reject outlet conveyance to provide a water source for a plant fire protection water system.

26. The process of claim 20 wherein said reject water from said membrane filtration stage is directed from said reject outlet conveyance to provide a make-up water source for a plant cooling tower system.

27. The process of claim 20 wherein said permeate from said membrane filtration stage membrane is directed from said permeate outlet conveyance to provide a water source for a plant demineralization system.

28. The process of claim 20 wherein said permeate from said membrane filtration stage is directed from said permeate outlet conveyance to provide a water source for a plant potable water system.

29. The process of claim 20 wherein the said industrial plant is a thermal power plant

30. The process of claim 20 wherein a pressurization pump is provided to boost the pressure at said inlet conveyance.
